(19) United States
(12) Patent Application Publication
(10) Pub. No.: US 2002/0065876 A1
(43) Pub. Date: May 30, 2002

(54) Method and process for the virtualization of system databases and stored information

(76) Inventors: Andrew Chien, La Jolla, CA (US); Brad Calder, San Diego, CA (US); Steve Pujia, San Diego, CA (US)

Correspondence Address: KNOBBE MARTENS OLSON & BEAR LLP, 620 NEWPORT CENTER DRIVE, SIXTEENTH FLOOR, NEWPORT BEACH, CA, 92660, US

(21) Appl. No.: 09/727,295

(22) Filed: Nov. 29, 2000

(51) Int. Cl. G06F 15/16

(52) U.S. Cl. 709/203; 709/218

(57) ABSTRACT

A system for securing an application for execution in a computer. In one embodiment, a preprocessor module modifies an application binary such that the application invokes an interception module in response to invoking certain system calls. The interception module prevents the application from adversely affecting the operating of a computer that is executing the application. Furthermore, the interception module protects the contents of the application from improper access by a user of the computer. For example, the interception module transparently encrypts all files that are used by the application such that a user of the computer cannot improperly access these files.

### RELATED APPLICATIONS

This application relates to the following co-owned and co-pending U.S. patent applications, which are each incorporated by reference herein in their entirety: U.S. patent application Ser. No. ______, “METHOD AND PROCESS FOR SECURING AN APPLICATION PROGRAM TO EXECUTE IN A REMOTE ENVIRONMENT”, filed Nov. 29, 2000; U.S. patent application Ser. No. ______, “METHOD AND PROCESS FOR THE REWRITING OF BINARIES TO INCEPT SYSTEM CALLS IN A SECURE EXECUTION ENVIRONMENT”, filed Nov. 29, 2000; U.S. patent application Ser. No. ______, “METHOD AND PROCESS FOR VIRTUALIZING FILE SYSTEM INTERFACES”, filed Nov. 29, 2000; U.S. patent application Ser. No. ______, “METHOD AND PROCESS FOR VIRTUALIZING NETWORK INTERFACES”, filed Nov. 29, 2000; U.S. patent application Ser. No. ______, “METHOD AND PROCESS FOR VIRTUALIZING USER INTERFACES”, filed Nov. 29, 2000; U.S. patent application Ser. No. ______, “SYSTEM AND METHOD FOR SECURING AN APPLICATION ON A COMPUTER”, filed Nov. 29, 2000, and U.S. patent application Ser. No. ______, “SYSTEM AND METHOD FOR COMMUNICATING AND CONTROLLING THE BEHAVIOR OF AN APPLICATION EXECUTING ON A COMPUTER”, filed Nov. 29, 2000.

### FIELD OF THE INVENTION

The invention relates to distributed computing, and more particularly, relates to secure peer-to-peer Internet or enterprise distributed computing. The invention also relates to the secure execution of an application on a client computer.

Description of the Related Technology

Distributed computing systems offer a wide variety of resources that can be harnessed and collected so as to work toward a common goal. Until recently, distributed computing has been performed predominantly on secure networks, wherein each of the computers in the network are owned by a single entity, such as a business. However, recently some individuals have attempted to implement distributed computing systems across the Internet, which includes millions of heterogeneous and non-secure computers. An example of the is the GIMPS project that utilizes various computers that are provided by homeowners, businesses, and universities to search for new Mersenne primes (primes of the form 2^{P}-1).

Although utilizing the Internet for distributed computing has met with limited success for certain projects, lack of security on the Internet makes it difficult to utilize the Internet for other types of projects. For example, many projects are of a confidential nature. Thus, project owners may be reluctant to utilize the computers of non-trusted individuals for these types of projects.

Another problem with distributing computing on the Internet is that for similar security concerns described above, many consumers, e.g., individuals, businesses, universities, are unwilling to allow third party software to be run on their machines. By allowing a distributed process to execute on the consumer's machine, the task may, among other things: (i) cause a system malfunction; (ii) improperly access confidential information; or (iii) otherwise adversely affect the performance of their computer.

Thus, there is a need for a distributed computing system that will allow a project to be executed securely across the Internet using non-secure trusted machines. The system should protect the contents of the project from improper tampering at the user machine. Furthermore, the system should protect the non-secure machine from improper tampering by the project.

### SUMMARY OF THE INVENTION

One aspect of the invention comprises a server computer, a network; and a client computer operably connected to the server computer via the network, wherein the client computer receives from the server computer an application, wherein the client computer executes the application subsequent to receiving the application, and wherein the client computer includes an interception module for intercepting a request for computer specific information that is made by the application.

Another aspect of the invention comprises modifying the binary of the application such that a request from the application for machine or user information is intercepted transparently to the application, and providing fake machine or user information.

Yet another aspect of the invention comprises intercepting a request from the application to open a key in a system database, determining whether the requested key is in the virtual database, if the key is not in the virtual database, storing fake information in the virtual database, and if the key is in the virtual database, returning a handle to the virtual key.

Yet another aspect of the invention comprises intercepting a request from the application to open a key in a system database, determining whether the requested key is in a virtual database, if the key is not in the virtual database, accessing the key in the system database, and if the key is in the virtual database, returning a handle to the virtual key.

Yet another aspect of the invention comprises intercepting requests to open a first key in a system database, and returning a handle that references a second key in a virtual database.

Yet another aspect of the invention comprises means for intercepting requests to open a key in a system database, means for opening a virtual key in a virtual database, and means for returning a handle to the virtual key.

Yet another aspect of the invention comprises means for intercepting requests to open a first key in a system database, and means for returning a handle that references a second key in a virtual database.

Yet another aspect of the invention comprises an interception module for intercepting requests to open a key in a system database, wherein the interception module opens a virtual key in a virtual database, and wherein the interception module returns a handle to the virtual key.

Yet another aspect of the invention comprises intercepting requests to open a key in a system database, opening a virtual key in a virtual database, and returning a handle to the virtual key.

### BRIEF DESCRIPTION OF THE DRAWINGS

These and other features will now be described in detail with reference to the drawings of preferred embodiments of the invention, which are intended to illustrate, and not limit, the scope of the invention.

FIG. 1 is a system level flowchart of an application package and its secure interaction, through a network, where it interacts with a client computer.

FIG. 2 is an illustration of a preprocessor module for processing a project (“application package”) for execution in a non-secure environment.

FIG. 3 is a block diagram illustrating relationships of computer system components, through a traditional system interface.

FIG. 4 is a block diagram illustrating the relationships of computer system components after the system interface of FIG. 3 has been virtualized.

FIG. 5 is a high level flowchart illustrating a process for securing an application package for execution in a non-secure environment.

FIG. 6 is a high level flowchart illustrating a process for preprocessing the application package.

FIG. 7 is a flowchart showing a process of scanning an application in the application package for improper sequences and inserting the interception module into binaries in the application package.

FIG. 8 is a flowchart that illustrates a process of modifying and adding environmental information and files to the application package along with the directory structure.

FIG. 9 is a flowchart that illustrates a process of starting execution and initializing the application at a client computer.

FIG. 10 is a flowchart that illustrates a process of determining which routines to intercept.

FIG. 11 is a flowchart that illustrates a process of intercepting all routines that are identified by a virtualization list.

FIG. 12 is a flowchart illustrating a process of initializing a virtual system database.

FIG. 13 is a flowchart illustrating examples of intercepted calls that are virtualized in FIG. 11.

FIG. 14 is a flowchart illustrating a process of virtualizing a file system request that was invoked by the application.

FIG. 15 is a flowchart illustrating a process for handling exceptions occurring in response to the execution of the application.

FIG. 16 is a flowchart illustrating a process of intercepting a load library request that was invoked by the application.

FIG. 17 is a flowchart illustrating a process of scanning system commands for improper sequences.

FIG. 18 is a flowchart map that outlines virtualized network requests that are intercepted by an interception module.

FIG. 19 is a flowchart illustrating a process of intercepting an “accept” system routine that was invoked by the application.

FIG. 20 is a flowchart illustrating a process of intercepting a “send” system routine that was invoked by the application.

FIG. 21 is a flowchart illustrating a process of intercepting a “send to” system routine that was invoked by the application.

FIG. 22 is a flowchart illustrating a process of intercepting a “receive” system routine that was invoked by the application.

FIG. 23 is a flowchart illustrating a process of intercepting a “receive from” system routine that was invoked by the application.

FIG. 24 is a flowchart illustrating a process of intercepting a “close” system routine that was invoked by the application.

FIG. 25 is a flowchart illustrating a process of intercepting a “shutdown” system routine that was invoked by the application.

FIG. 26 is a flowchart illustrating a process of intercepting a “select” system routine that was invoked by the application.

FIG. 27 is a flowchart illustrating a process of intercepting a “socket” system routine that was invoked by the application.

FIG. 28 is a flowchart illustrating a process of intercepting a “bind” system routine that was invoked by the application.

FIG. 29 is a flowchart illustrating a process of intercepting a “connect” system routine that was invoked by the application.

FIG. 30 is a flowchart illustrating a process of intercepting a “listen” system routine that was invoked by the application.

FIG. 31 is a flowchart illustrating a process of intercepting a “query” network system routine that was invoked by the application.

FIG. 32 is a flowchart illustrating a process of intercepting an “update” network system routine that was invoked by the application.

FIG. 33 is a flowchart that illustrates a process for intercepting a request to modify page permissions that was invoked by the application.

FIG. 34 is a flowchart that illustrates a process of intercepting graphical interface routines that are invoked by the application.

FIG. 35 is a flowchart map that illustrates certain database routines that may be virtualized with respect to a system database.

FIG. 36 is a flowchart that illustrates a process for opening a key in a virtual database.

FIG. 37 is a flowchart that illustrates a process for closing a virtual database key.

FIG. 38 is a flowchart that illustrates “read” and “write” steps for a virtualized file system.

FIG. 39 is a flowchart that illustrates a process for reading and decrypting a file buffer when intercepting a read request.

FIG. 40 is a flowchart that illustrates a process of encrypting and writing to a file buffer in response to intercepting a write request.

FIG. 41 is a flowchart that illustrates a process of intercepting a request to map a file to memory.

FIG. 42 is a second embodiment of a process of mapping a file to memory.

FIG. 43 is a flowchart that illustrates a process for un-mapping a file from memory.

FIG. 44 is a flowchart that illustrates of a process for intercepting a system request that returns a filename.

FIG. 45 is a flowchart of a process for encrypting a file name that is used by the application program.

FIG. 46 is a tree diagram that illustrates a file structure of a traditional system layout.

FIG. 47 is a tree diagram that illustrates a file structure of a traditional system layout after virtualization.

FIG. 48 is an illustration of a socket table that is used by the interception modules to manage communications to and from the application.

FIG. 49 is a flowchart illustrating a process for handling events that are received by a virtual machine communication thread.

FIG. 50 is a flowchart illustrating a process for handling application manager events.

FIG. 51 is a flowchart illustrating a process for handling application events.

### DETAILED DESCRIPTION OF THE INVENTION

The following detailed description is directed to specific embodiments of the invention. However, the invention can be embodied in a multitude of different ways as defined and covered by the claims. In this description, reference is made to the drawings wherein like parts are designated with the like numerals throughout.

One embodiment of the invention enables an application package to be executed safely, securely, and transparently on a remote machine, called a client. Before execution, the application package is modified using a preprocessing module which, among other things, modifies the binaries of applications in the application package such that an interception module is loaded when the binary is executed. After being processed, the application package is transferred in an encrypted form from a server to the client. After execution, the results of the application package are transferred back to a device on a network 130 in an encrypted form or stored locally on the machine in a similar encrypted format.

The interception module includes predefined lists of allowable actions and various processing modules that will intercept and interpret each system command that attempts execution.

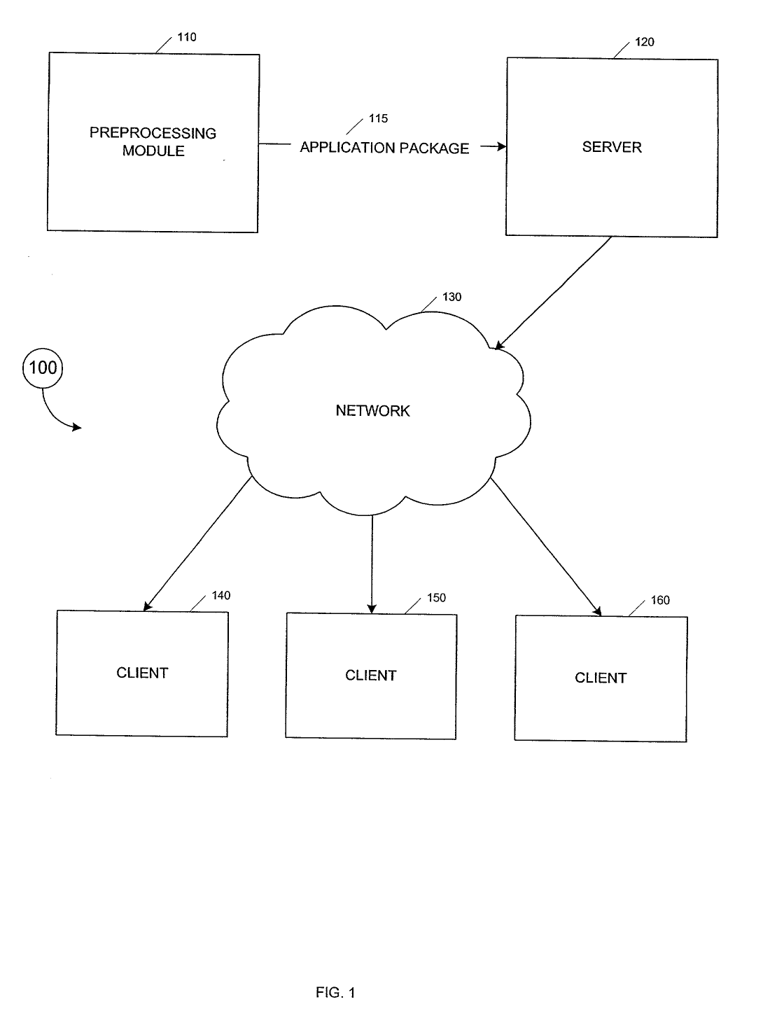

Referring initially to FIG. 1, an exemplary system includes at least one server that transmits application packages to the member computers and receives the results back for processing. One embodiment of the communications medium comprises a number of client computers 140 simultaneously connected via the network 130. In this system, each client computer 140 periodically receives an application package 115 that is maintained by the server computer 120.

The application package 115 may include, among other things as will be described further below, an application binary (also called application program) and an interception module. The interception module intercepts system calls that are made by the application program. The interception module acts as a “virtual layer” between the operating system and the application. This is advantageous for several reasons, a few of which are listed immediately below. First, this prevents interruption to other tasks that may be executing on the client computer. Second, this can be used to prevent the application program from accessing certain files and directories on the client machine. Third, this can be used to prevent the application program from consuming excess resource on the client machine. Fourth, the application can read, write, and modify files that are stored on the client in an encrypted format and having encrypted file names without requiring the application to be rewritten and recompiled to be aware of this encryption.

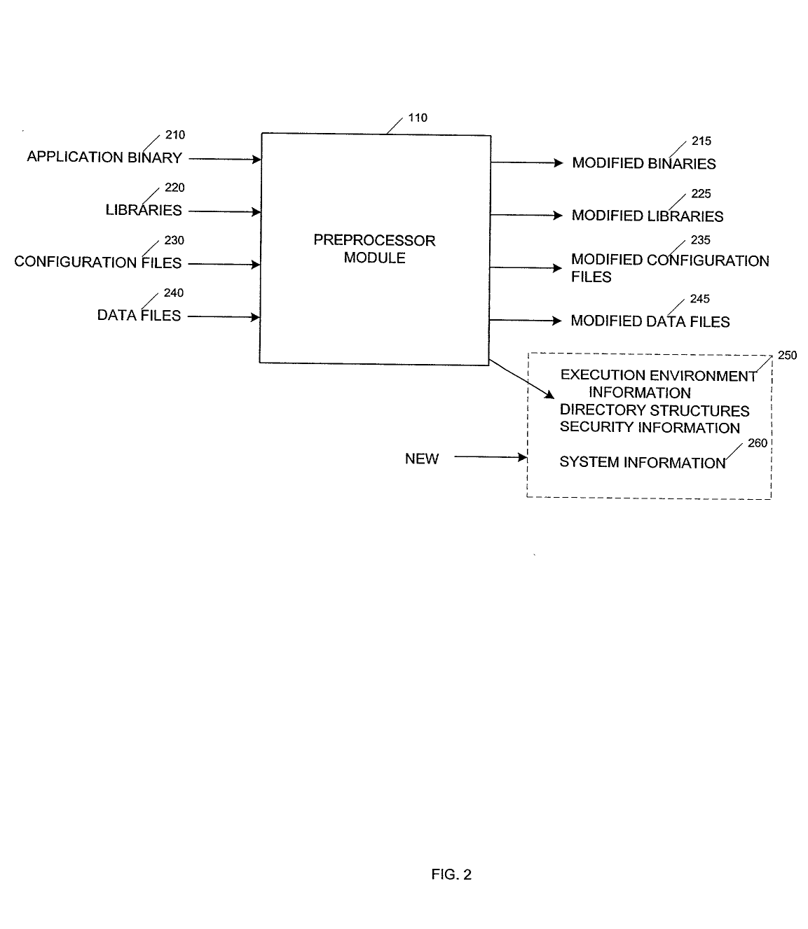

FIG. 1 is an exemplary overview of such a distributed computing system showing its interactions over the network 130. The distributed computing system includes a preprocessing module 110, further described in FIG. 2, that prepares a software package for execution on any number of client computers 140. The application package 115 is a modified software application that is adapted to each client computer 140.

The application package 115 is electronically transferred from a server 120, which can be an independently networked computer, across the network 130, and into any number of client computers 140. The server 120 may act as the master control center for all of the data processing, data transmissions, security information, and results processing. The network 130 can include any type of electronically connected group of computers including, but not limited to, the following networks: Internet, Intranet, Local Area Networks (LAN) or Wide Area Networks (WAN). In addition, the connectivity to the network may be, for example, remote modem, Ethernet (IEEE 802.3), Token Ring (IEEE 802.5), Fiber Distributed Datalink Interface (FDDI) or Asynchronous Transfer Mode (ATM). Note that computing devices may be desktop, server, portable, hand-held, set-top, or any other desired type of configuration. As used herein, an Internet includes network variations such as public internet, a private internet, a secure internet, a private network, a public network, a value-added network, an intranet, and the like.

As is shown in FIG. 1, the system includes three client computers 140, 150, 160. It is noted that the other numbers of client computers can be used, e.g., 1, 1000, 100,000,000 computers, or more. For the convenience of description, the following description will describe the processes that occur on the client computer 140. Similar processes can occur on the client computers 150 and 160. The client computer 140 should have access to any of the above described network protocols, by which it can communicate with the server 120 unless the application package is intended to run on an individual system. The application package 115 is modified such that it communicates with an interception module, thereby preventing (i) a user of the client computer from 140 accessing the contents of the application package 115 and/or (ii) the application from improperly modifying or accessing data on the client computer.

In one embodiment, as will be discussed more fully below, the application package 115 is allowed to communicate with a predetermined list of network connections. All connection requests by the application package 115 are intercepted in a virtual layer, using the interception module, and only IP addresses on a pre-approved list are allowed. In addition, communication may be intercepted and directed to a proxy instead of a general network broadcast.

FIG. 2 illustrates aspects of the application package that are modified by the preprocessor module 110. The preprocessor module 110 may reside within the memory of a server 120, a dedicated preprocessing computer, or, in selected embodiments, on the client computer itself.

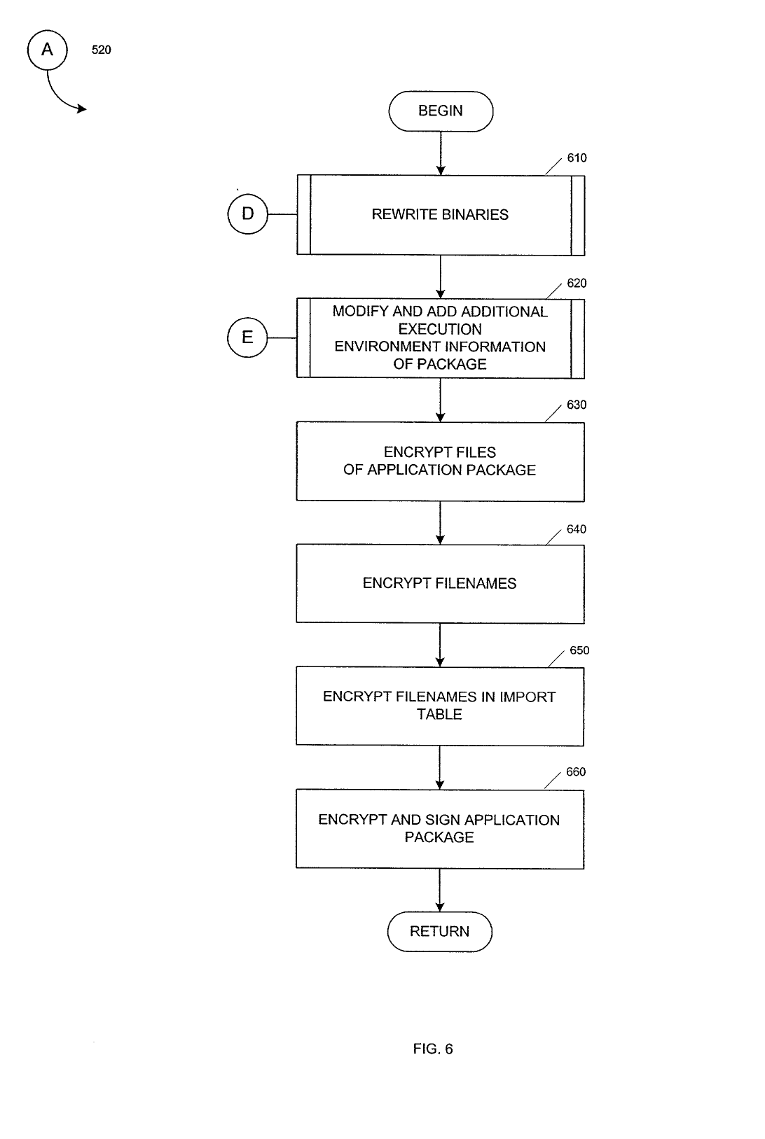

The application package 115 can include, among other things: an application binary 210, libraries 220, configuration files 230, and data files 240. The application binary data 210, the libraries 220, the configuration files 230, and the data files 240, are each processed by the preprocessor module 110 whereby they are either encrypted and/or otherwise modified. The outputs of the preprocessor module 110 are modified binaries 215, modified libraries 225, modified configuration files 235, and modified data files 245, respectively. The output files include information that contains specific details about the type of system that the application package 115 is to be run on. Some of the information is appended to the files and some of the information may be completely reformatted to run on a specified operating system. The preprocessor module 110 may also generate execution environment information 250, reformat directory structures of the application package, and generate new system information 260. A process of modifying the application package 115 is set forth below with respect to FIG. 6.

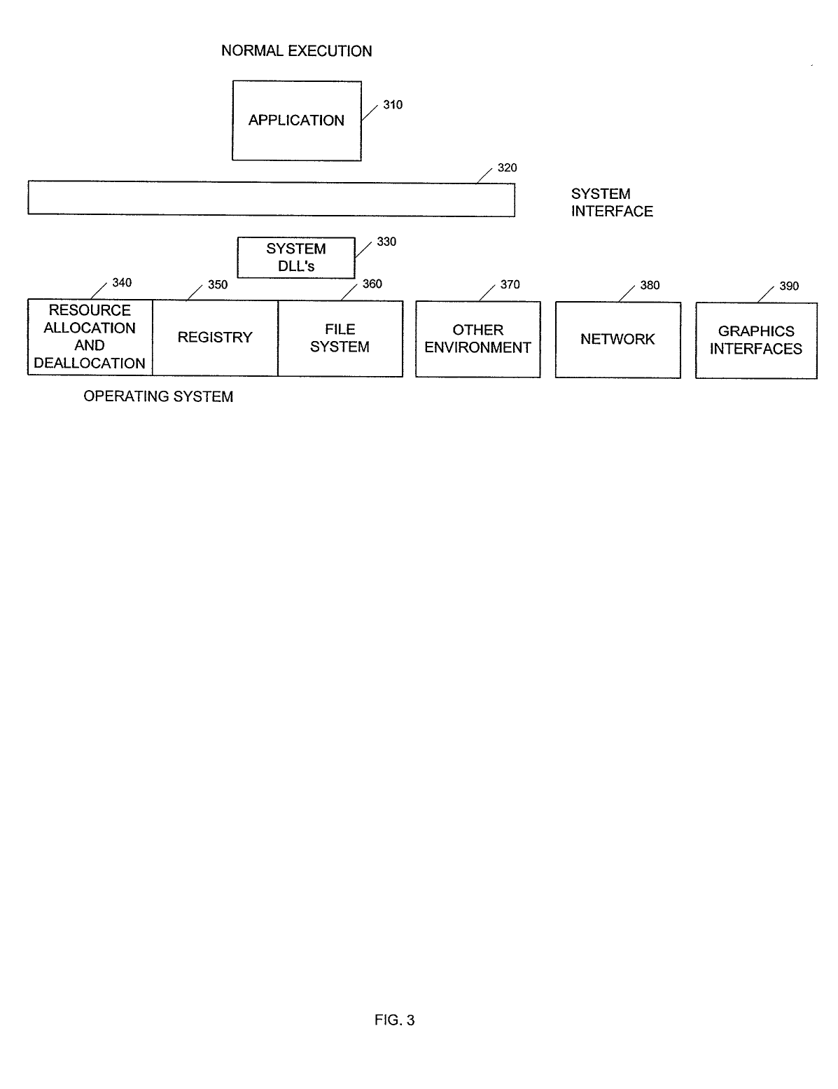

FIG. 3 is a block diagram illustrating a standard architecture for executing an application 310 in a client computer 140. In this architecture, an application 310 typically calls a system interface 320 via system DLL's 330 to access system resources, such as: resource allocation and deallocation 340, a registry 350, a file system 360, other environment information 370, a network 380, and graphics 390. System DLL's 330 are libraries of executable functions or data that are used by a Microsoft Windows application providing an abstract interface to the operating system. Typically, a DLL 330 provides one or more particular functions for a program and these functions are accessed by creating a dynamic link to the functions when the library is loaded by an application 310.

The operating system executing on the client computer can be: UNIX, LINUX, Disk Operating System (DOS), OS/2, Palm OS, VxWorks, Windows 3.X, Windows 95, Windows 98, and Windows NT, Windows 2000, Windows ME, Windows CE, Mac OS, and the like.

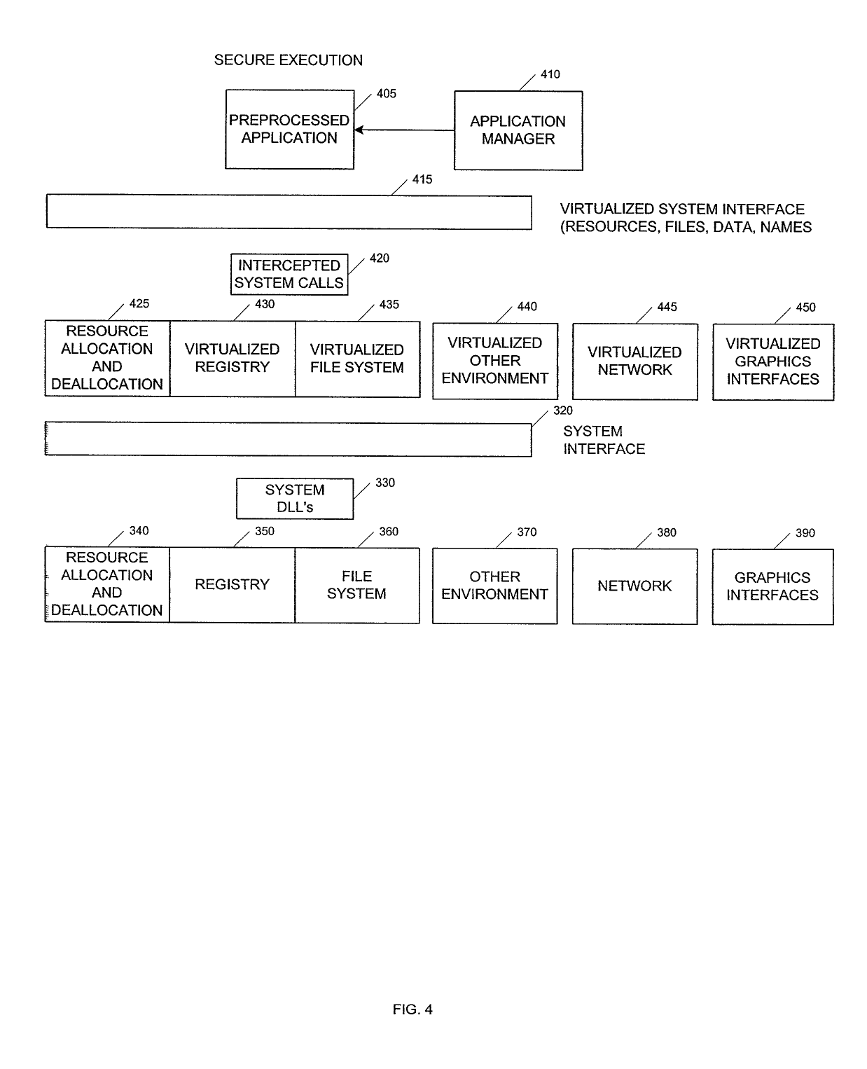

FIG. 4 is a block diagram illustrating a virtualized execution environment of an application 405 (wherein the application 405 may be part of the application package 115 discussed in FIG. 1 for example) which was sent from the server 120 after being processed by the preprocessor module 110.

In one embodiment, system resources are controlled by using the virtual layer 415 to intercept part or all of the application programming interface (API) routines that utilize these resources.

Part or all of the system calls made by the application 405 are intercepted by an interception module which is part of the virtual layer 415. As will be discussed more fully below, the interception module allows the application 405 to access approved files on the client computer 140, without altering the system settings, while simultaneously protecting the contents of the application package 115 from user access.

The interception module provides virtual allocation and de-allocation routines 425, a virtualized registry 430, a virtualized files system 435, a virtual other environment 440, a virtualized network 445, and a virtualized graphics interfaces 450. By intercepting these interfaces, the interception modules can prevent a user of the client computer 140 from accessing the contents of the application package 115 and/or the application from improperly modifying or accessing data from the client computer.

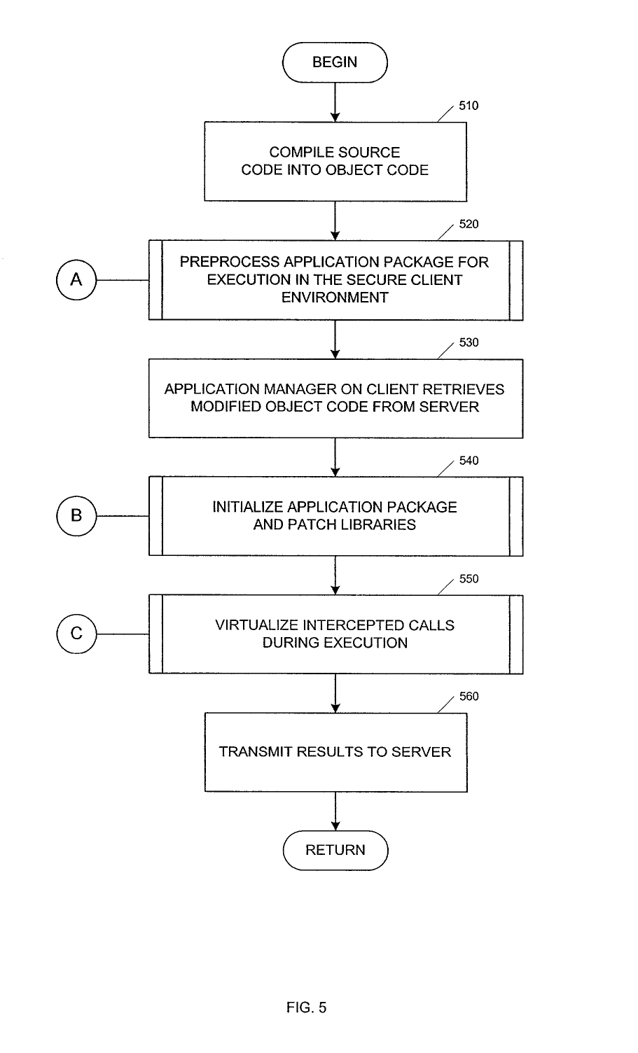

FIG. 5 is a flowchart showing a process for creating an application package and transferring the application package 115 to the client computer 140. Depending on the embodiment, selected steps may be added or removed, and the ordering of the steps changed. Starting at a state 510, source code for the application package 115 is compiled into object code. The step may be accomplished using any conventional compiler.

Moving to step 520, the application package 115 is processed through the preprocessor module 110 where it becomes encrypted and is prepared for transmission, across an approved network connection, to a participating client computer 140. Furthermore at the step 520, the import table of each binary in the application package 115 is modified such that the interception module is loaded when a binary in the application package starts to execute. One embodiment of the method for processing the application package is shown in further detail below with respect to FIG. 6.

Moving forward to step 530, the application manager 410 downloads the application package (including object code) and stores it in an encrypted format. In one embodiment of the invention, the application manager 410 determines periods of low activity on the client computer 140, and initiates the transmission during one of the low periods.

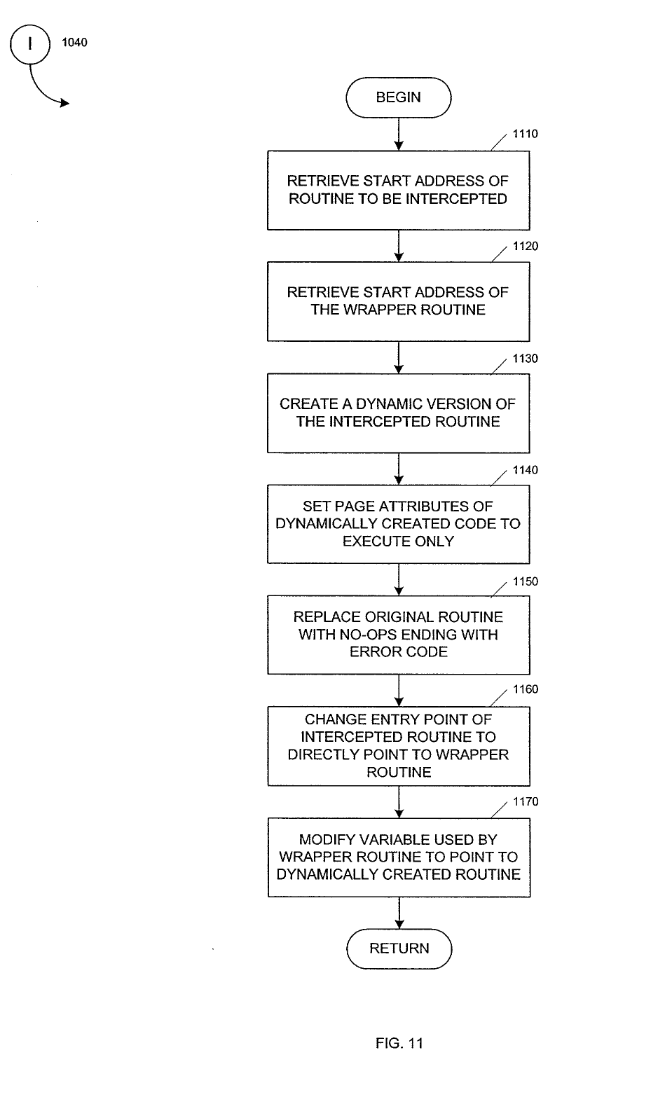

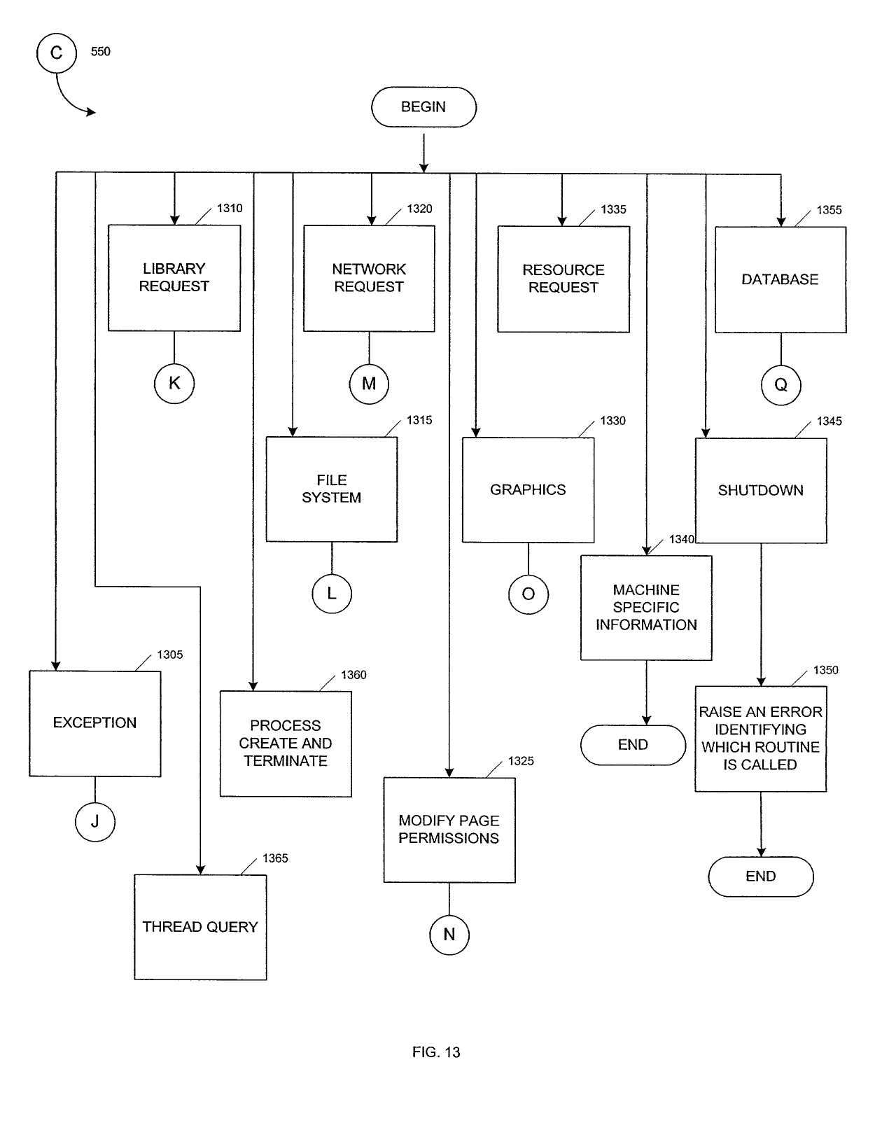

Proceeding to step 540, the application 405 (FIG. 4) is initialized and the libraries in the application package 115 are patched. One exemplary process of initializing the application package and patching the libraries is set forth below with respect to FIG. 11. Continuing to step 550, the intercepted system calls 420 are processed. The process of processing system calls during execution is described below with respect to FIG. 13. However, in general and among other things, the interception module intercepts each system call and prevents the application from improperly modifying or accessing data that is stored by the client computer, and prevents the client computer from improperly modifying or accessing data of the application. Next, in step 560, the results of the application package 115 are transmitted to the server 120.

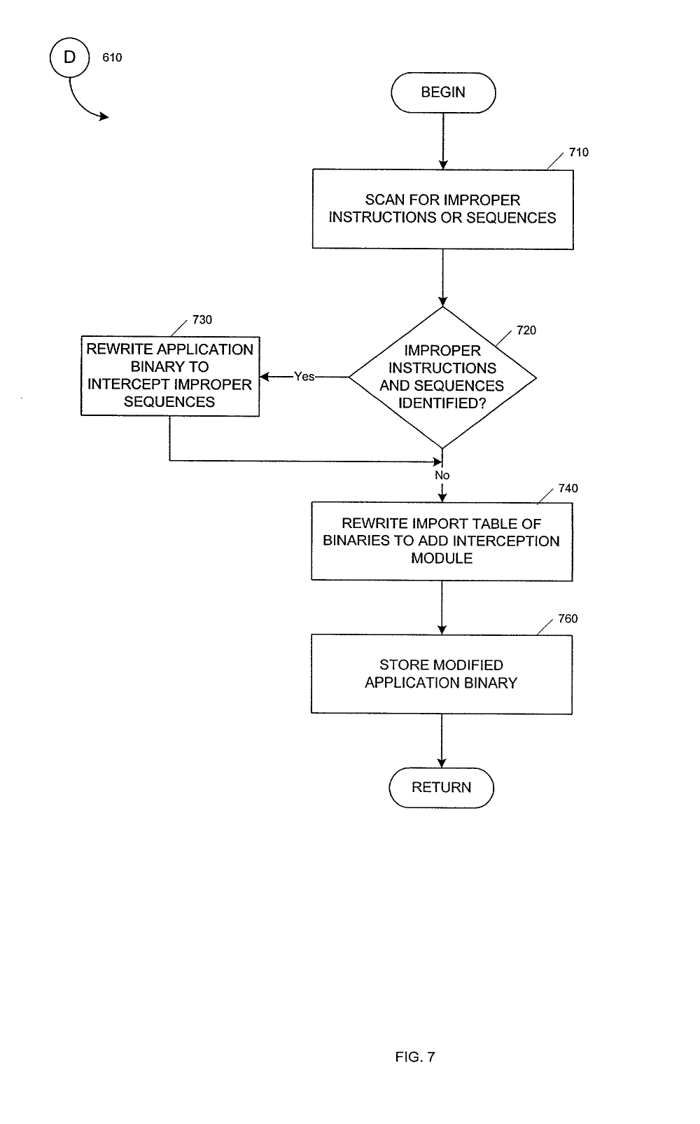

FIG. 6 is a flowchart illustrating a process for creating an application package 115. FIG. 6 shows in further detail the steps that occur in step 520 of FIG. 5. Depending on the embodiment, selected steps may be added and others may be removed and the ordering of the steps may be rearranged. Starting at a step 610, the binaries are rewritten to remove improper sequences, and the interception model is added to the application binaries. One exemplary process of rewriting the binaries is described below with respect to FIG. 7.

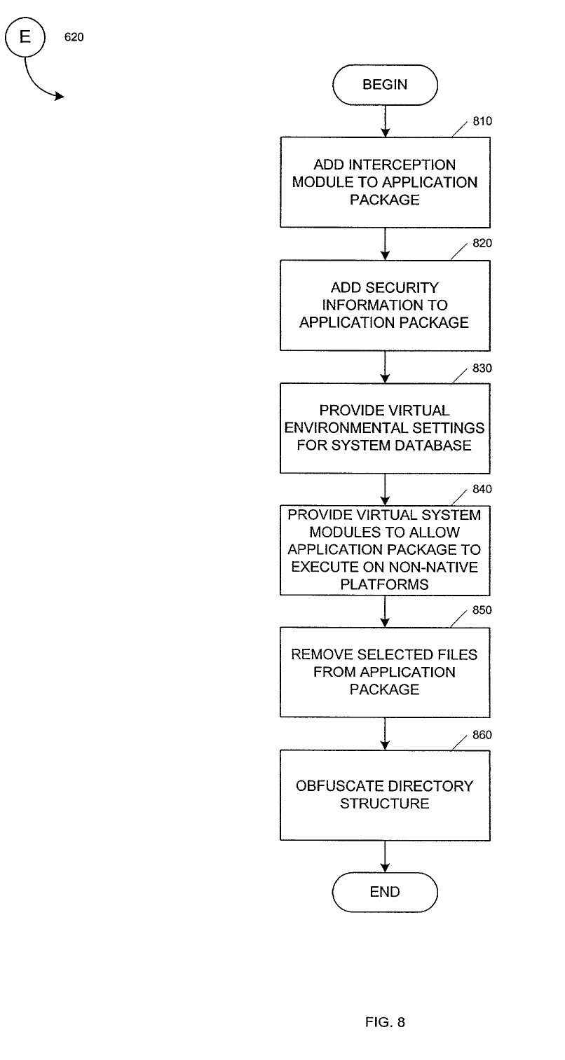

Moving to step 620, the application package 115 is appended with information that relates directly to the execution environment on each individual client computer 140. An exemplary process of this is described below with respect to FIG. 8. After the binary re-writing is complete and all of the modifications are made, the preprocessor module 110 moves to a step 630 wherein the application package 115 is encrypted. In one embodiment of step 630, only data files are encrypted. In another embodiment, all data files and DLLs are encrypted, but not the main executables. Continuing to step 640, all of the file names of the files in the application package 115 are encrypted. Additionally, the file names listed in the import tables that refer to the encrypted files (step 640) may be encrypted in step 650. Proceeding to the step 660, the encrypted application package is electronically signed and then transmitted across the network 130 to the client computer 140.

FIG. 7 is a flowchart that describes in more detail the process of rewriting the binaries, as is accomplished in FIG. 6 step 610. Starting a step 710, the application 405 is scanned for improper instructions or sequences, e.g., commands that cause the operating system to trap to the operating system. In one embodiment, improper function or sequences are defined by a predefined list. Next, at a decision step 720, it is determined whether there any improper sequences have been identified. If an improper instruction or sequence is identified, the system moves to a step 730 wherein either (i) the improper sequences are replaced with an exception, alternatively, are rewritten to invoke a routine in the interception module.

For example, when a program runs under the Windows operating system, it accesses the operating system via the Windows API, which is a collection of DLL's. In one embodiment, all access to the operating system is required to go through one of these API routines. These API routines trap the operating system using an interrupt instruction “INT 2Eh”. No binary stored in the application package should be allowed to invoke this interrupt. Only the Win32 API calls are allowed to access the operating system because these are the routines intercepted by the interception module. Prior to the execution of the application 405, all binary files are scanned for INT 2Eh instructions, and flagged as violating this criteria if any violations are found. The application 405 should not have these instructions, but if it does, the application 405 is patched to not directly call the interrupt. Instead, the violations call a corresponding routine, from the virtual layer 415, and intercept that call from the operating system. Alternatively, the application 405 may be rewritten so it does not call the interrupt.

Continuing from step 730 or from step 720 if there are no improper sequences, the system moves to a step 740, wherein the import table of binaries is rewritten to reference the interception module.

In one embodiment, each executable binary contains an import table listing all of the dynamically linked library's (DLLs) that are used by an application 405. Each DLL in return may load additional dynamic libraries needed to execute routines in said DLL. When a program starts executing, the operating system loads the DLLs in the order they are listed in the import table, and then executes a DllMain() routine from each DLL loaded. At the step 740, the preprocessor module 110 inserts a DLL for the interception module into the import table such that interception module DLL is invoked prior to the other DLL's. As will be discussed in further detail below, since the interception module is loaded and run first, the interception module can patch and intercept all of the DLL calls before any of the application package's code (including DllMain() routines) are executed. Next, at step 760, the modified application binaries are stored to be included in the application package.

FIG. 8 is a flowchart that shows in further detail the modification and addition of execution environment information that is performed in step 620 of FIG. 6. Depending on the embodiment, selected steps may be added, others may be removed, and the ordering of the steps may be rearranged. Starting at a step 810, the interception module is added to the application package 115. In one embodiment of the invention, this step includes copying the interception module from a first location, e.g., a directory, to a second location that includes all of the files of the application package.

Moving to step 820, security information is added to the application package 115. The security relates to protecting both the client computer 140, as well as the contents of the application 115. The security information can include encryption keys and signatures to decode the encrypted application package files, and to communicate with the server. In one embodiment, the client computer 140 might need to have its data and resources protected from being accessed by the application 115. The client computer 140 may contain sensitive information and system data, and the application 405 the security information defines, among other things, which directories may be accessed by the application package 115.

Continuing forward, step 830 provides the environment settings for virtual databases. Default values for many of the standard system information may be included in the default environment and system virtual database. Moving to step 840, virtual system modules are incorporated into the application package 115 to allow for the application 405 to execute and communicate on any non-native platforms. For example, if the application package is going to run under Linux and the application is modified to execute in conjunction with a Windows 2000 environment, system libraries are added to the application package that translate Windows 2000 system calls to Linux system calls.

Any files that are not needed or are not providing any further value are removed from the application package 115 in step 850. Proceeding to step 860, the directory structure of the files in the application package is obfuscated. In one embodiment of the invention, obfuscating the file structure includes moving all of the files of the application package into a single directory.

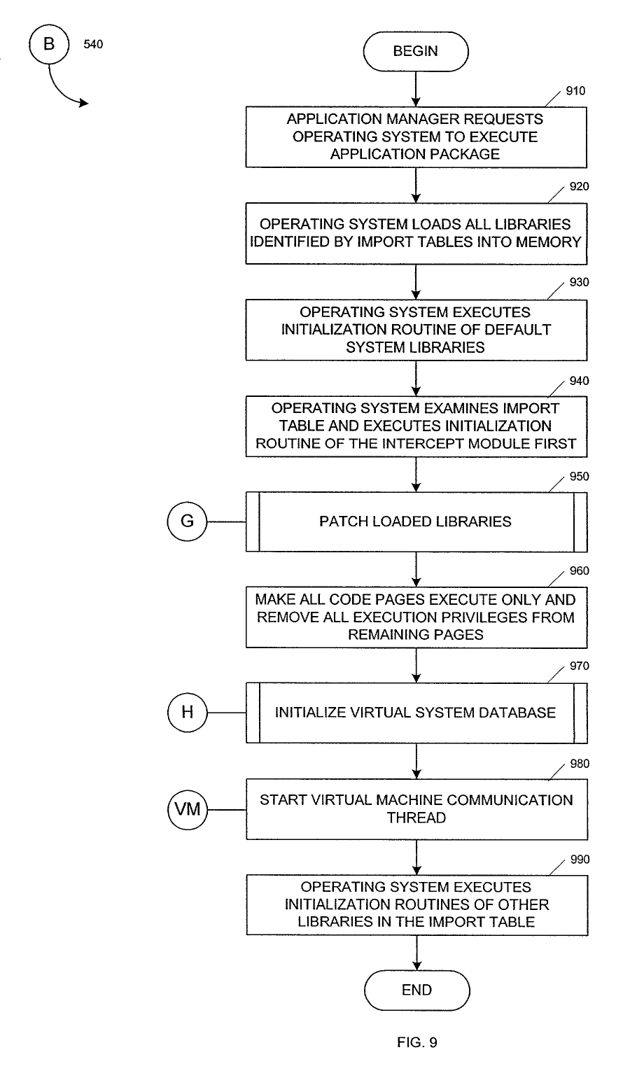

FIG. 9 is a flowchart showing a process of initializing the application and the patching of the loaded libraries as is performed in step 540 of FIG. 5. Depending on the embodiment, selected steps may be added, others may be removed, and the ordering of the steps may be rearranged.

The process begins at step 910 where the application manager 410 requests the operating system to execute the application package 115. Continuing to step 920, the operating system loads all of the libraries that are defined by the import tables of the application into memory. Moving to step 930, the operating system executes the initialization routines that are associated with the default system libraries. Proceeding to step 940, the operating system examines the import table and executes the initialization routine of the first DLL in the import table, i.e., the DLL for the interception module.

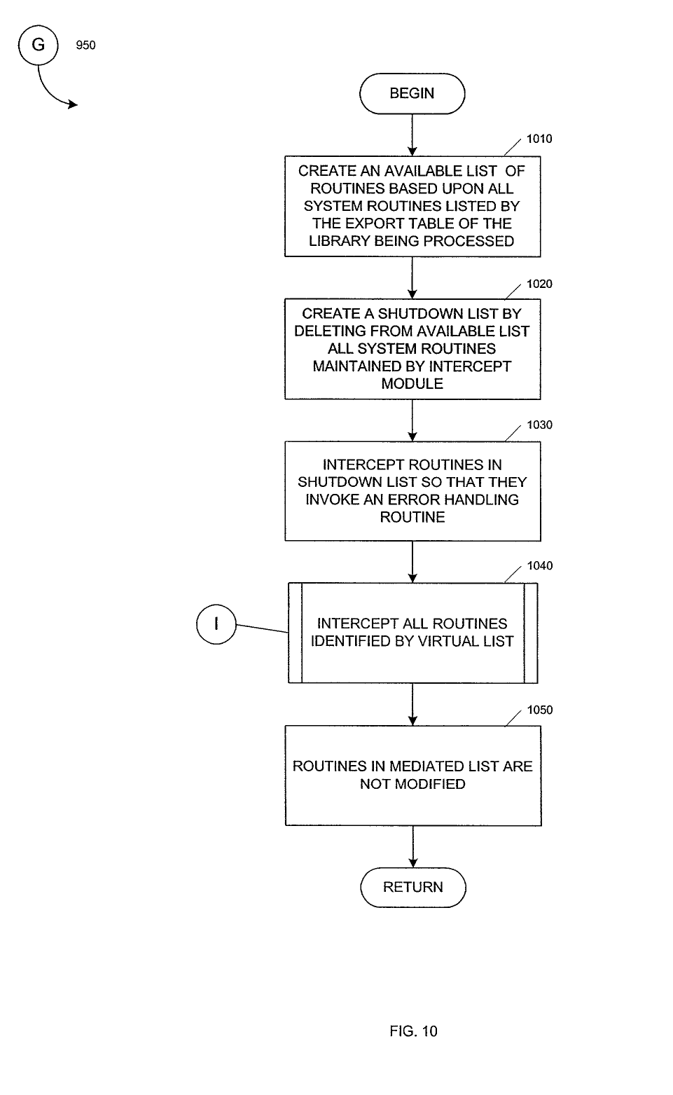

Continuing to step 950, the loaded libraries are patched. The patching of the loaded libraries in step 950 is described further below with respect to FIG. 10. However, in summary, all DLL routines that are to be intercepted are redirected to a wrapper routine to intercept them. The interception module DLL performs its API patching for every DLL that has been loaded.

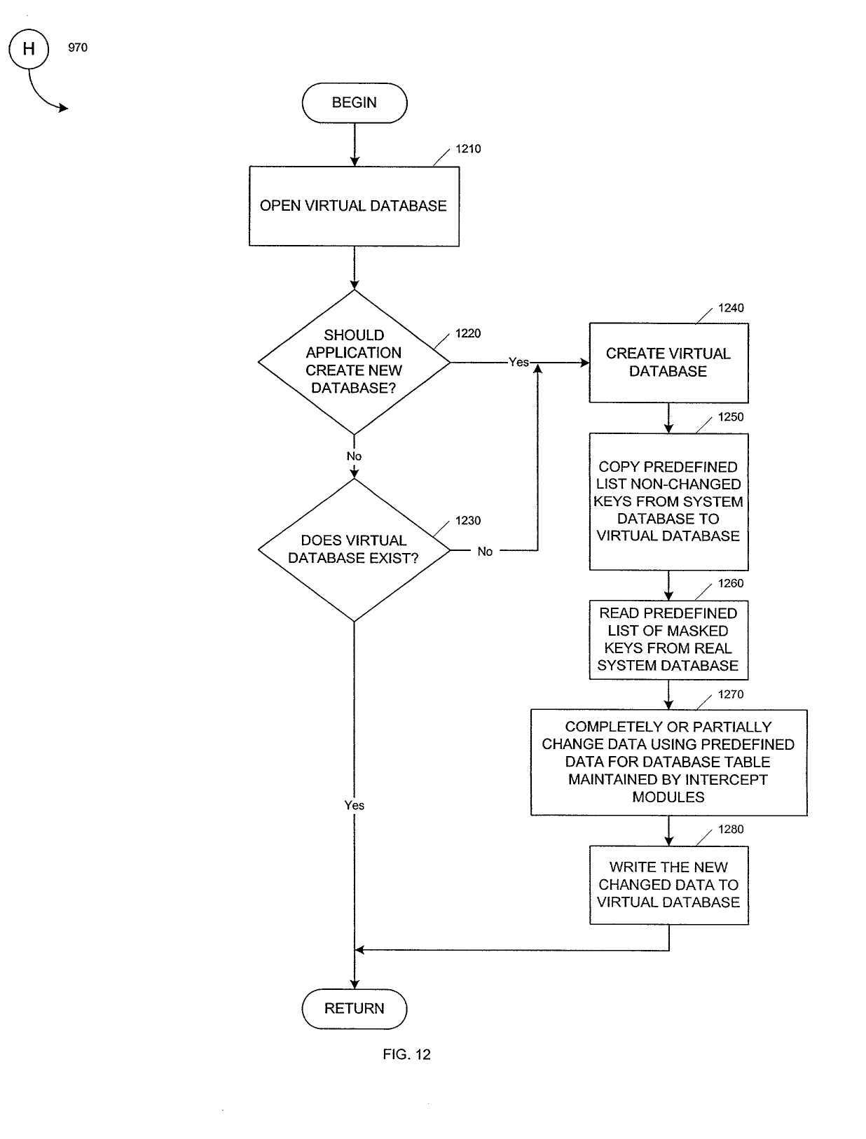

Next, at step 960, all of the code pages of the loaded libraries are set to “execute only” and execution privileges for other types of pages are removed. Continuing to a step 970, the virtual system database is initialized. The virtual system database initialization process is further explained hereafter with reference to FIG. 12. Continuing to a step 980, a virtual machine (VM) communication thread is created. The VM communication thread is used to provide a communications conduit between the application to the application manager 410 and to control the operation of application. The VM communication thread tells the application manager 410 when a process is created and when it is finished executing to provide process control. The VM communication thread is also used to communicate execution progress back to application manager 410. It also communicates errors to the application manager 410. In addition, the application manager 410 can tell the VM communication thread to pause all threads in application, and to resume execution of all paused threads in the application. The application manager 410 may also tell the VM thread to checkpoint the application.

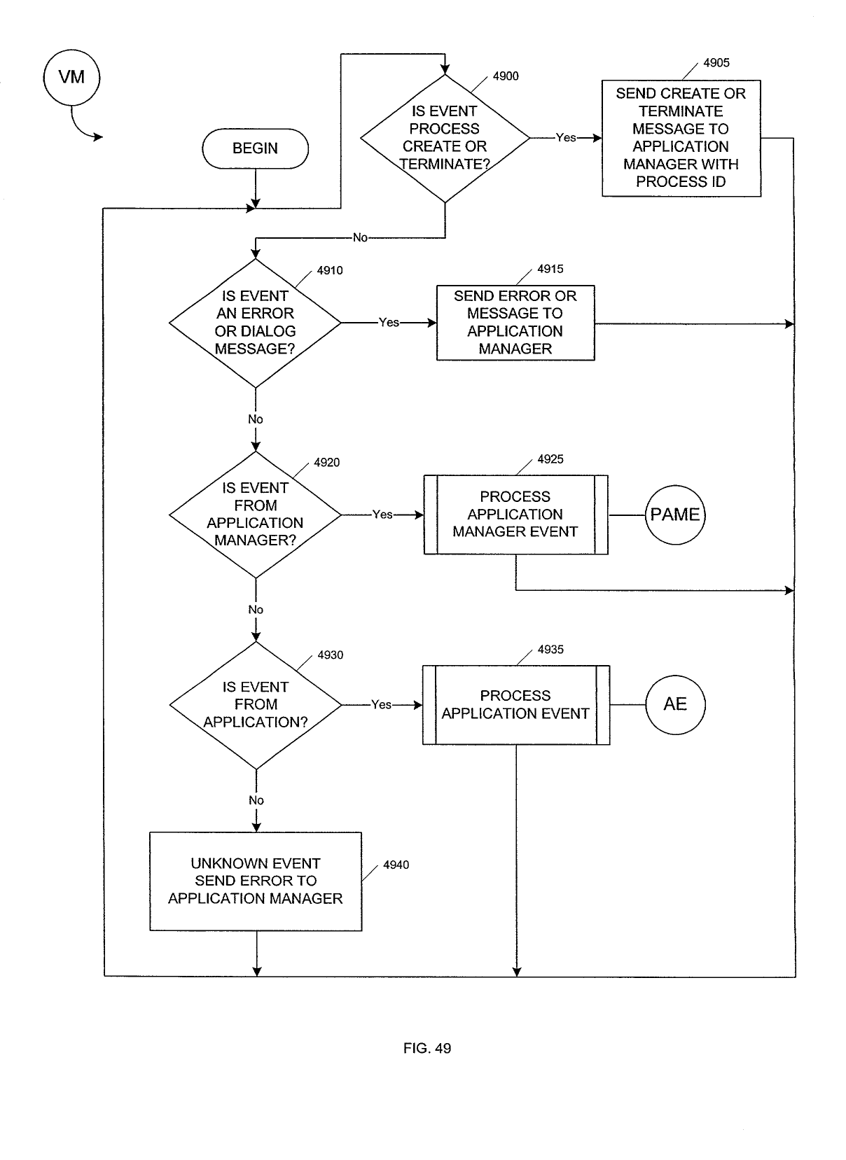

For one embodiment, there is at least one VM communication thread running in the process space of every separate process in the application package. The VM communication thread is described in further detail below with respect to FIG. 49. Continuing to the step 990, the operating system executes the initialization routines of the other libraries in the import table.

FIG. 10 is a flowchart that shows the patching of the loaded libraries in more detail, as is performed in step 950 of FIG. 9. The process shown in FIG. 10 is performed for each library identified by the import table of the application package and any library which is needed by those libraries, and so on. Depending on the embodiment, selected steps may be omitted, others added, and the ordering of the steps may be rearranged.

Starting at step 1010, the interception module creates an available list of routines. The available list is based upon all system routines that are listed by the export table of the library being processed. Alternatively, the available list may instead be included statically in the application package. Moving to step 1020, a shut down list is created by removing all of the routines that are maintained by the interception module, e.g., as is defined by a predefined mediated and virtualization list. Continuing to step 1030, the routines that appear in the shut down list are intercepted as to invoke an error handling routine in the interception module. Next, at a step 1040, the routines that are identified by the virtualization list are intercepted. The interception process is described in further detail hereinafter with reference to FIG. 11. Moving to the step 1050, routines that are identified by a mediated list are not modified and operate without interference from the interception module.

FIG. 11 is a flowchart that shows a process for intercepting a routine identified that is listed in the virtual list. FIG. 11 shows in further detail the acts that occur in step 1040 of FIG. 10. Depending on the embodiment, selected steps may be omitted, others added, and the ordering of the steps may be rearranged.

Starting at step 1110, the intercept process retrieves the start address of the routine to be intercepted. Moving to step 1120, the start address of a corresponding wrapper routine in the interception module is retrieved. In one embodiment, a static wrapper routine is provided in the interception module DLL for all DLL routines that are to have their behavior modified.

Progressing to step 1130, the process creates a dynamic version of the intercepted routine. In one embodiment, when performing the patching, for those routines that are classified as being virtualized, a dynamic wrapper routine is generated for every virtualized routine that is DLL loaded by an application 405. The code for each dynamic wrapper routine is generated dynamically, i.e., on-the-fly, for each virtualized routine. In one embodiment, the dynamic wrapper routine includes the first few instructions of the intercepted routine that will be replaced (state 1160) by jump instructions to the static wrapper.

For those routines that are routines classified as mediated or shutdown (discussed above with respect to FIG. 10), the entry point (first few instructions) of each API routine intercepted are copied and replaced with a direct jump to a dynamically created wrapper. For mediated routines, the dynamic wrapper executes the copied instructions from the original API routine, and then jumps directly back to the original API routine. For those routines that are to be shutdown, the shutdown dynamic wrappers call a shutdown routine, which then in turn invokes an error routine. In another embodiment, the mediated routines are completely left alone.

In another embodiment of the invention, for additional security, instead of only copying the first few instructions of routine to be intercepted, the dynamic wrapper routine stores all of the instructions of the intercepted routine. This embodiment advantageously prevents an application from jumping to a selected location wherein a programmer expects the library to be loaded and thereby potentially sidestepping the static and dynamic wrappers that are provided by the interception module. In this embodiment, as shown in step 1150, the instructions in the intercepted routine are replaced with a no-ops operations, ending in an error code.

In step 1140, the page attributes of the dynamically created version of the intercepted routine are set to “execute only.” Continuing to step 1160, the entry point of the intercepted routine is directed to jump to the static wrapper routine. In the final step 1170, the static wrapper routine is modified to invoke the dynamically created wrapper routine. Depending on the type of command that is to be intercepted, the static wrapper may execute virtualization code before and/or after invoking the dynamic wrapper routine. In one embodiment, the call from the static wrapper to the dynamic wrapper jumps through a piece of global data memory that includes a pointer to a function. The variable is patched at run-time with the address of the dynamically generated routine.

FIG. 12 is a flowchart that further shows the process of initializing a virtual system database as it first appeared in FIG. 9, step 970. Depending on the embodiment, selected steps may be removed others added, and the ordering of the steps may be rearranged.

Starting at step 1210 and the opening of the virtual database on a client computer 140. Moving to step 1220, the process determines whether the interception module should create a new database or, alternatively, use an existing virtual database. Continuing to step 1230, if the interception module does not create a new database, the process determines whether the virtual database already exists.

Step 1240 is initiated by one of two processes (1), if the answer to the decision step 1220 is “yes,” requesting the virtual database be created or (2), if the answer to the decision step 1230 is “no,” the virtual database does not exist. At the step 1240, and as is further explained in substeps 1250-1280, the virtual database is created. Moving to step 1250, a pre-defined list of non-changed keys from a system database, e.g., a registry database, are copied to the virtual database. Proceeding to step 1260, a predefined list of masked keys are read from the system database into the virtual database.

Next, in step 1270, the data is completely or partially changed using a predefined database table that is maintained by the interception module. Moving to step 1280, the new changed data is written to the virtual database where it can be accessed by an application 405.

In one embodiment, the client computer 140 may contain sensitive data stored in the system databases. Whether or not such data is actually stored there, it will be appreciated that this data should not be open to access by the application package 115. The interception module in the virtual layer 415 intercepts all system calls 420, database access functions, and redirects them to the virtual database. In creating the virtual database, specific keys are copied from the system database into the virtual database that do not contain information that is sensitive to the client computer 140. In addition, a few fields, e.g., machine name, user name, etc., in the virtual database are filled with pre-defined constants. These keys are potentially needed by the application 405 to run, but they contain client specific data. Therefore, default values are provided to create these keys in the virtual database in order to avoid exposing sensitive system data to the application 405.

All API calls that go to the operating system to update or read from the registry are intercepted and instead the keys are looked up or updated in the encrypted virtual database. When an application package 115 is run for the first time, or each time it starts to run, it copies specific information from the existing system registry to the virtual database. These keys contain generic information that most programs need to execute. This information can be copied at the start of execution or gradually during execution as the fields are accessed for the first time.

FIG. 13 is a flowchart map that shows the steps of intercepting calls during execution as is performed in step 550 of FIG. 5. This flowchart identifies certain calls or types of system calls that may be virtualized. For example, at step 1320, a suite of network request routines are virtualized by the interception module in response to the application 405 invoking the routines.

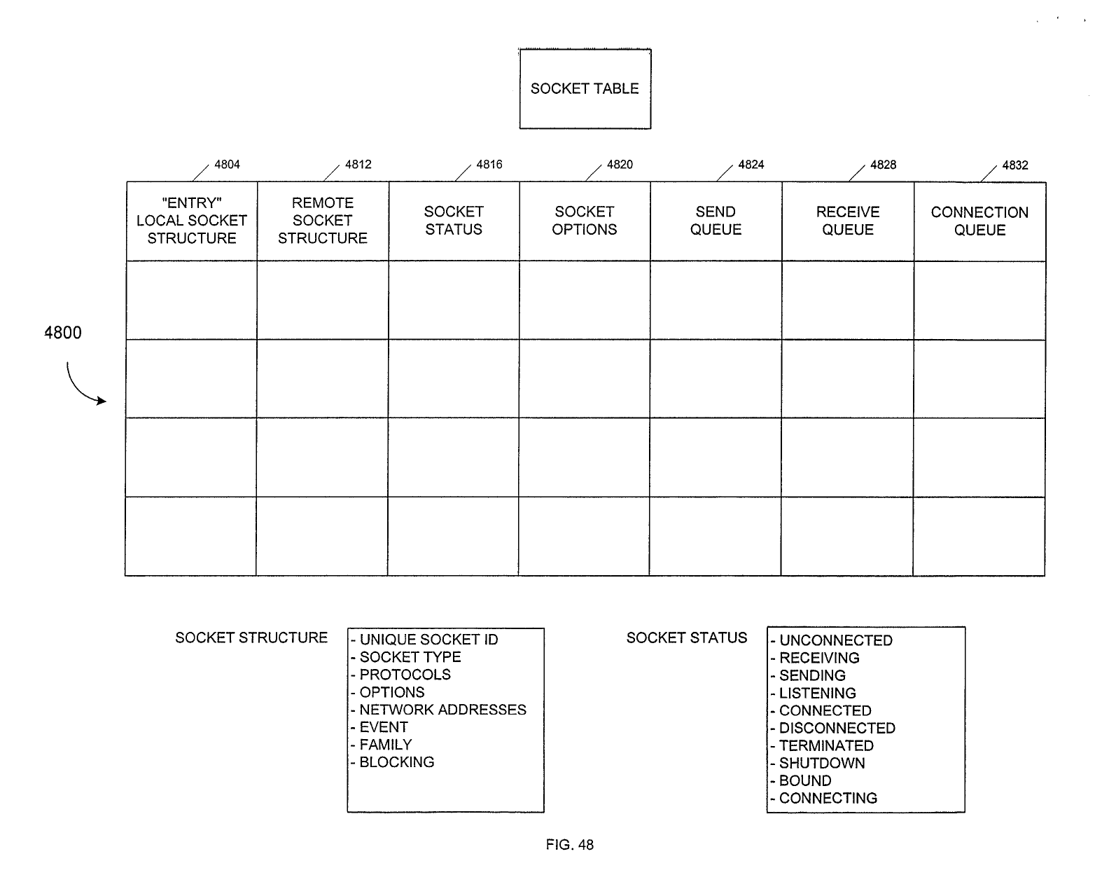

In one embodiment, a proxy device is used to manage all communications that originate from the application 405. The interception module uses a socket table 4800 (FIG. 48) to manage communications with the proxy device. A process of using proxy devices is described in further detail in U.S. patent application Ser. No. 09/632,435, titled “SYSTEM AND METHOD OF PROXYING COMMUNICATIONS OVER A COMPLEX NETWORK ENVIRONMENT”, which is incorporated by reference in its entirety.

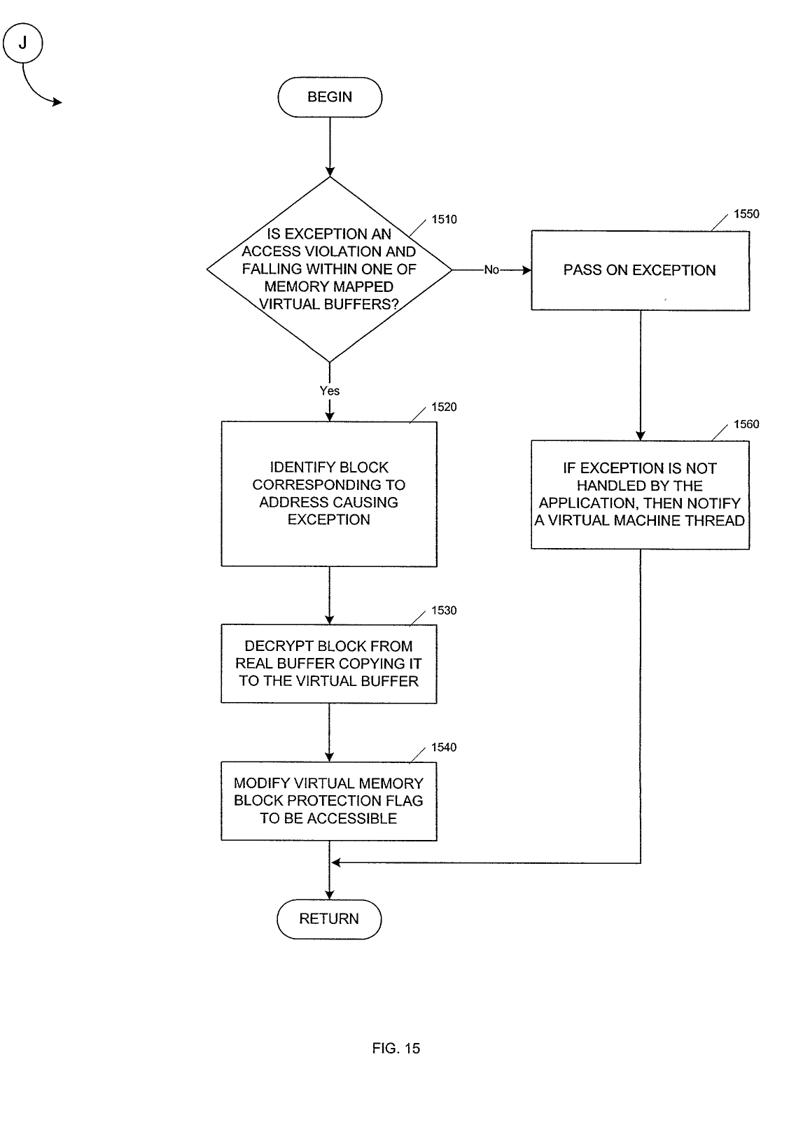

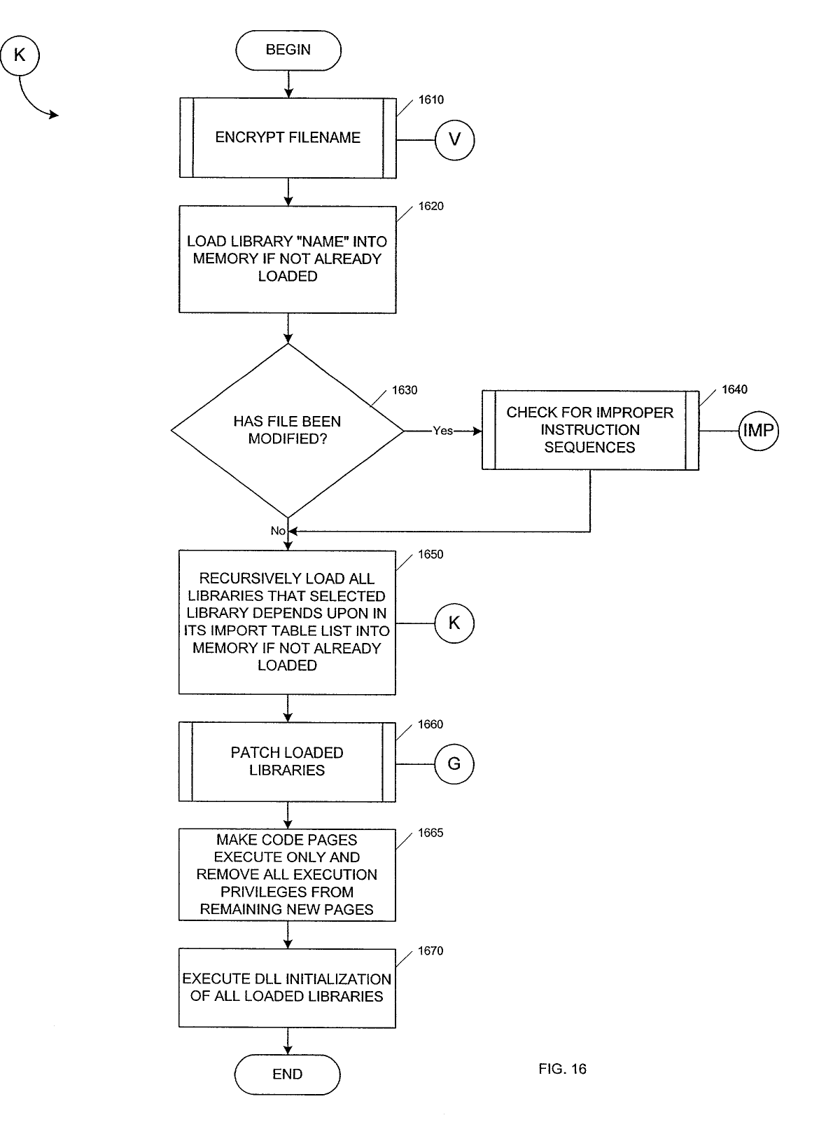

At step 1305, any exceptions that are caused by the application 405 are examined by the interception module. The exception handling process is further described below with respect to FIG. 15. At step 1310, a load library feature routine is intercepted, described hereafter with reference to FIG. 16.

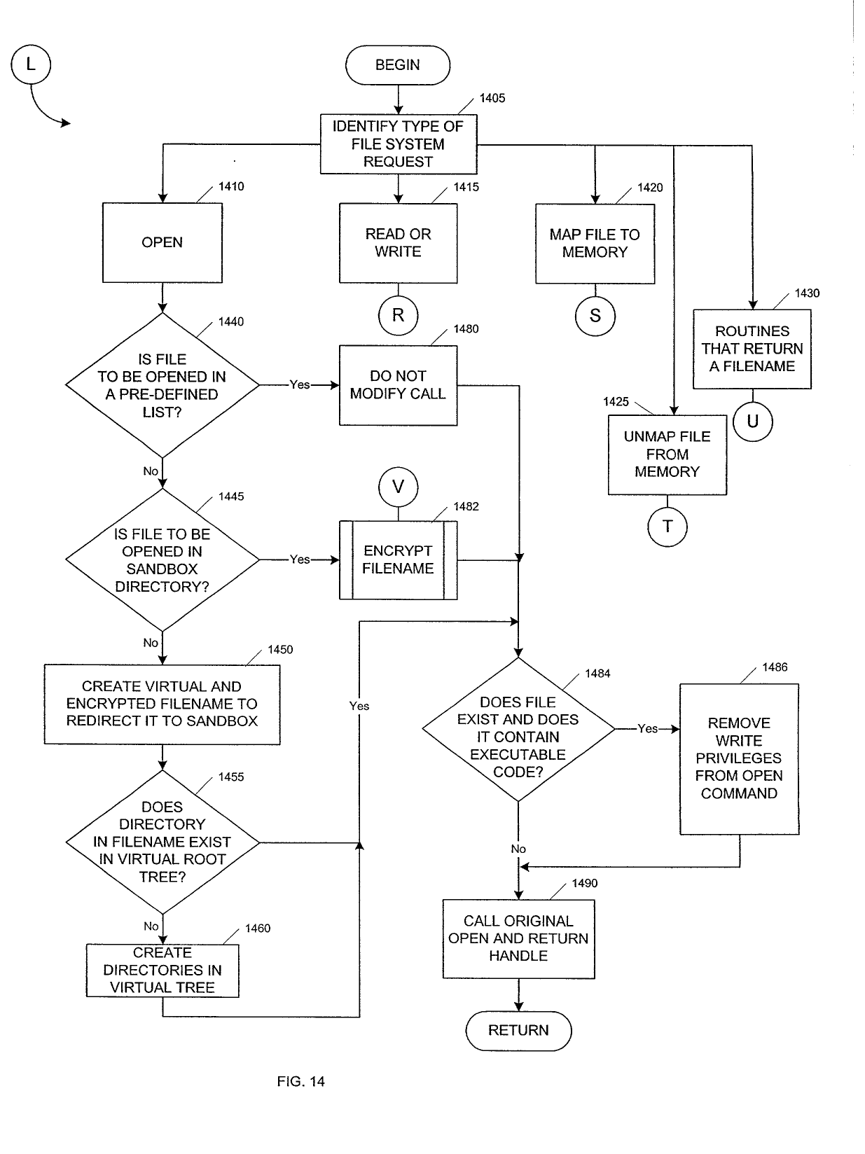

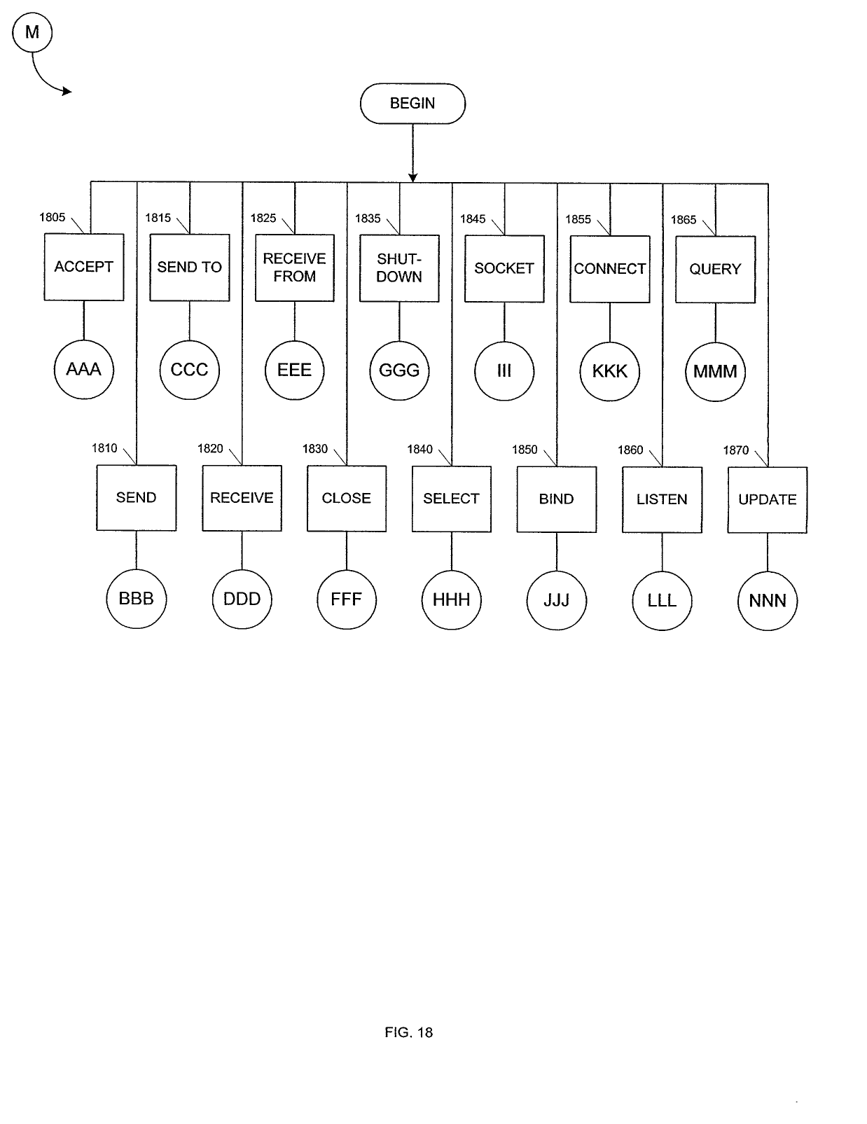

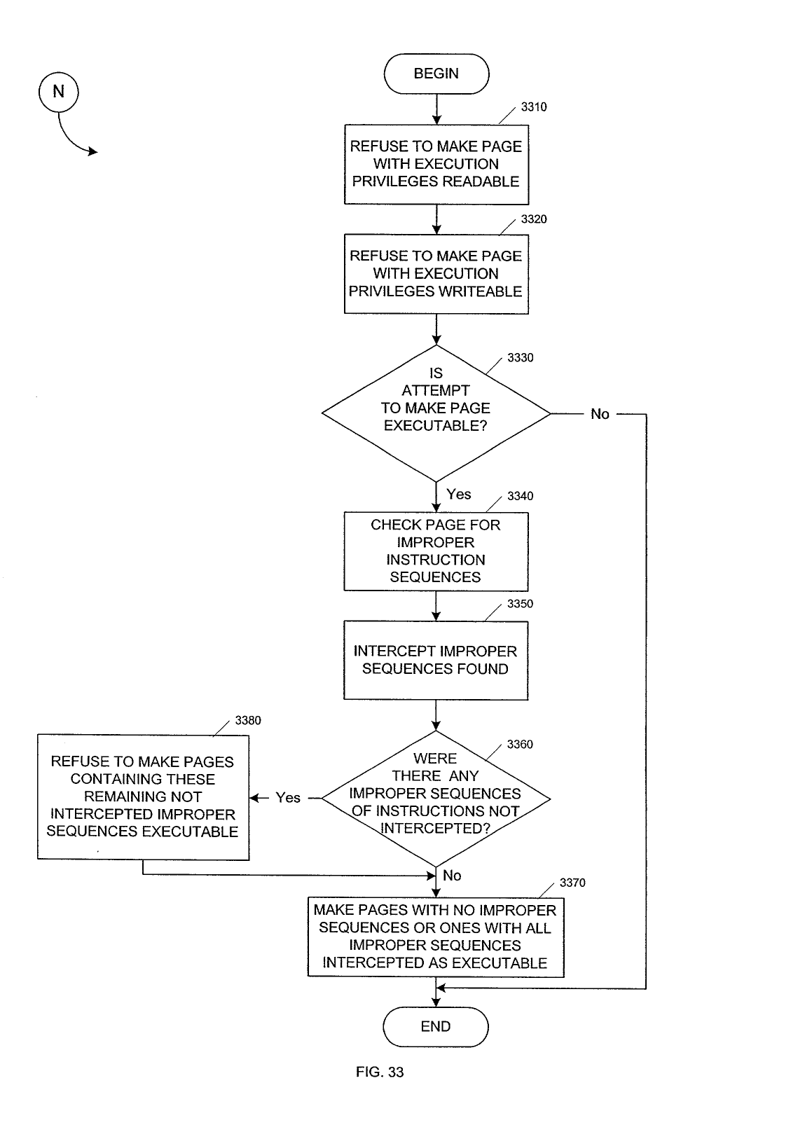

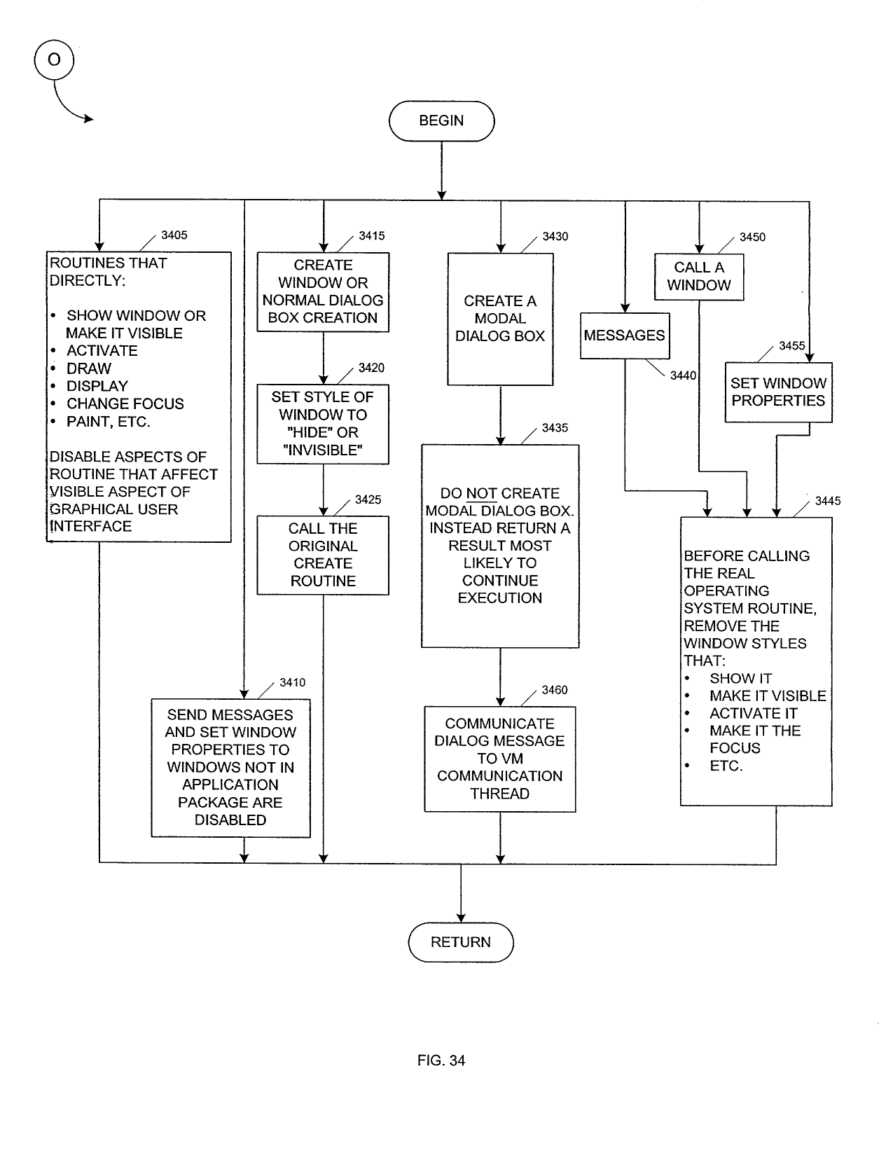

At step 1315, the interception module intercepts all of the file system requests by the application 405. This step is described hereafter with reference to FIG. 14. In step 1320, network requests are shown to lead to another flowchart map that has many embodied network commands, further described hereafter with reference to FIG. 18. At step 1325, the interception module intercepts page permission modifications routines, further explained hereafter with reference to FIG. 33. In step 1330, the graphical user interfaces and modal dialog boxes requests are intercepted. These actions are further described hereafter with reference to FIG. 34.

At step 1335, resource requests are virtualized. The types of resources that can be controlled include, but are not limited to, library usage, memory usage, number of processes and threads created, network bandwidth used, kernel handles allocated, and disk usage. For example, to control memory usage, the memory allocation routines are intercepted and granting allocation can be predicated on the amount of paging currently being done on the client computer 140, the amount of virtual memory currently being consumed, or other heuristics. If the resource allocation attempt fails, then an error is raised by the virtual layer 415 and communicated back to the application manager 410 via the VM communication thread.

If unacceptable amounts of resources are being used, the application 405 may terminate or it may communicate this behavior back to the application manager 410 using the communication thread. The application manager 405 may then send a command that forces the application 405 to terminate.

At step 1340, requests for machine specific information, such as environment variables, are intercepted and return predefined information as is defined by, depending on the embodiment, the application manager 410, the interception module, or the server 120. At step 1345, those routines that are classified as being shutdown cause an error to be raised. At step 1350, an error is raised to the VM communication thread, which sends the error to the application manager 410, and eventually back to the server.

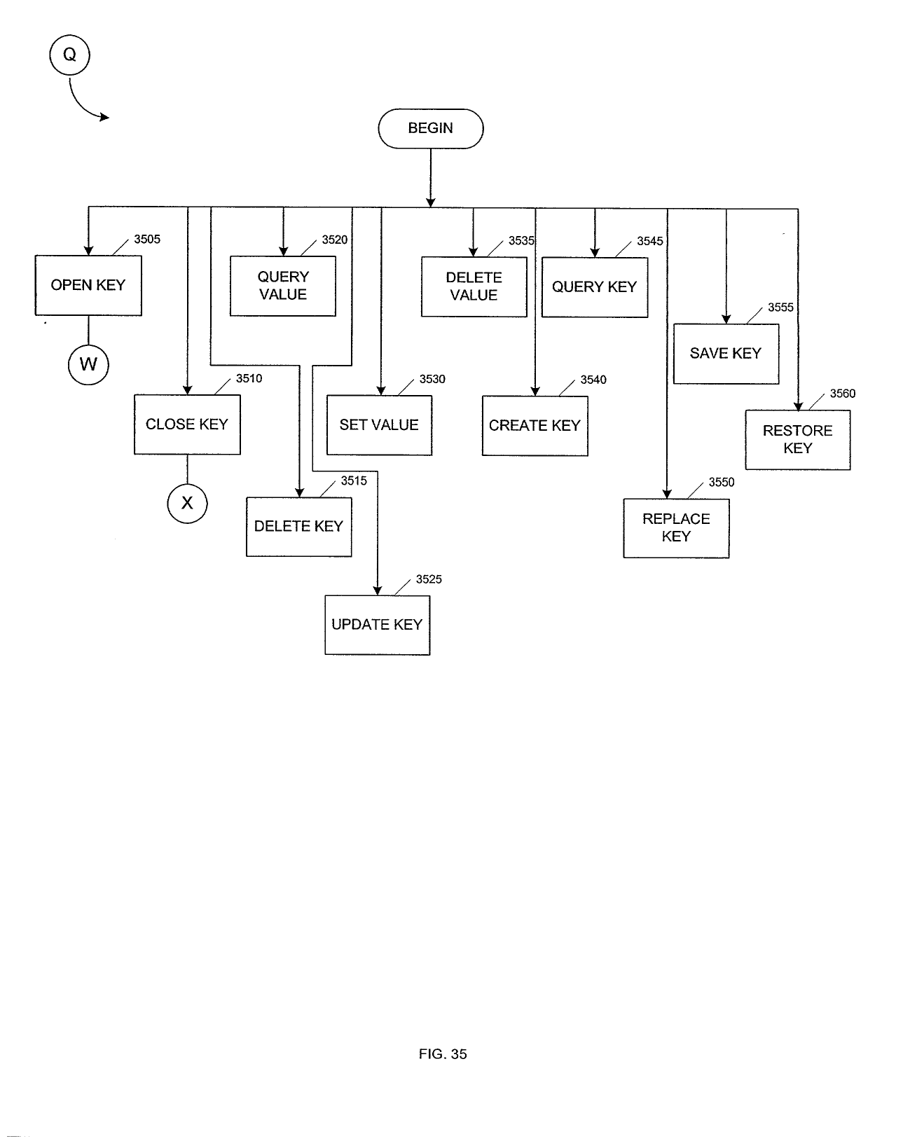

In step 1355, the virtual layer intercepts calls to a system database. One process of intercepting the database is described below with respect to FIG. 35.

At step 1365, the virtual layer intercepts thread query requests. In one embodiment of the invention, to preserve transparency of all aspects of the virtualization of the interfaces to the application 405, the existence of the virtual machine (VM) threads in the application 405 are hidden from the application 405. In response to queries for all threads in the application space, the interception module removes from the thread list the thread identifiers of any VM threads.

At step 1360, requests for process creation and termination are intercepted. When a process is created, the process ID is communicated back to the application manager 410 by sending an event to the VM communication thread. Similarly, when a process is terminated, before exiting, it notifies the application manager 410 that the process is about to exit by sending an exit process event via the VM communication thread along with the process ID that is terminating.

FIG. 14 is a flowchart that shows steps regarding the virtualized file system, as is performed in step 1315 of FIG. 13. Depending on the type of the file system routine that is being intercepted, the process flow proceeds to either: a step 1410 for “open or create file” routines; a step 1415 for a read or write routine; a step 1420 for a map file to memory routine; a step 1425 for an unmap file from memory routine; and a step 1430 for routines that return a filename. Most of these steps are described further in subsequent Figures, but they are identified here for a high level system overview. It is noted that only selected types of file system routines are shown as being intercepted, the interception module can be used in conjunction with any type of file system routine. Depending on the embodiment, steps can be added or removed and they may also appear in a different order.

In response to the invocation of an open/create routine, the modified routine calls the interception module at the state 1410. An open routine can be used to create a new file or to open an existing file. Continuing to a step 1440, the system determines whether the requested file is in a predefined list of approved files. In one embodiment of the invention, the approved file list includes the names of files that do not have confidential information, or for some other reason, the filename of the file should not be encrypted by the interception module.

If the answer to the inquiry is “yes,” the process moves to step 1480 and the process proceeds without modifying the call. From step 1480, the process moves to a decision step 1484 wherein it is determined whether the file exits and whether it contains executable code. If the file does exist and it does contain executable code the process proceeds to a step 1486 wherein write privileges are removed from the parameters that will be used to open the file (step 1490).

Referring again to decision step 1484, if the file does not exist or the file does not contain executable code, or, alternatively, from step 1486, the process flow proceeds to step 1490 where the original system request, with the unmodified and modified parameters, if any, and the file name to open the file is executed and the handle is returned. Referring again to step 1440, if the answer to the decision step is “no,” then the process moves to decision step 1445 and determines whether the filename points to a directory in the sandbox directory. In one embodiment of the invention, the sandbox directory is a certain directory that was specified by the user of the client computer 140 when the client installed the application manager 410. In another embodiment of the invention, the sandbox directory is a certain directory that is specified and provided to the preprocessor module 110. The sandbox directory contains all of the files for the application packages 115.

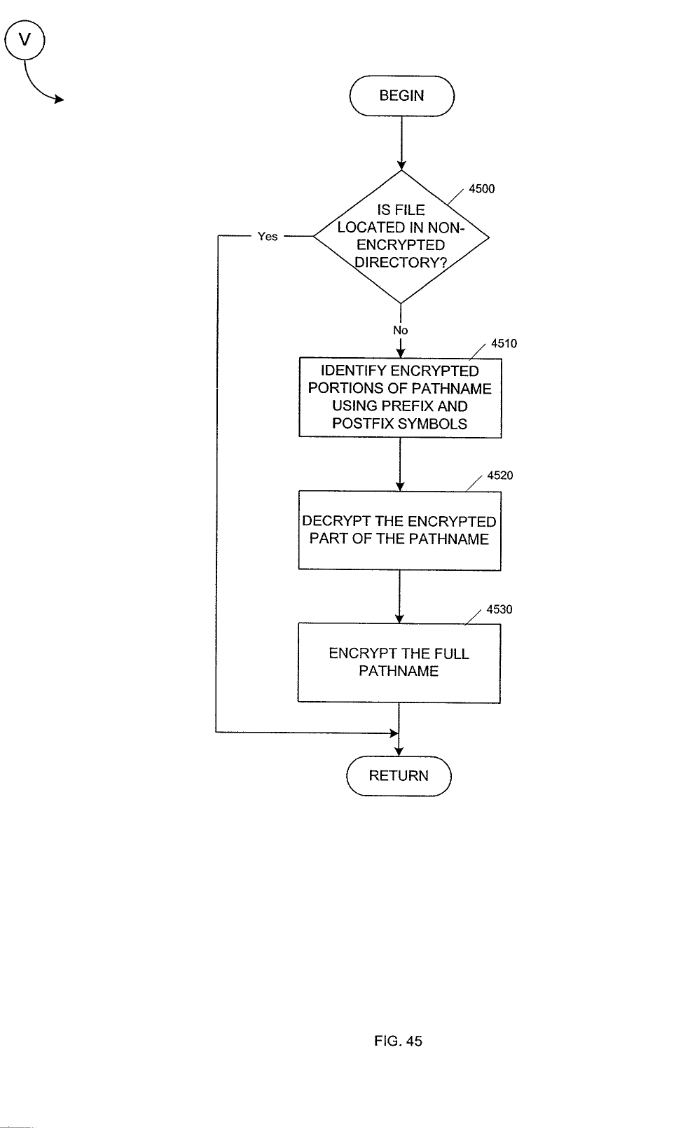

If the answer to this inquiry is “yes,” then the process moves to step 1482 and the file name flows through the encryption process. The file name encryption process is explained further hereafter with reference to FIG. 45. From step 1482, the process moves to steps 1484-1490 (discussed above) where a system request to open the file using an encrypted filename and in the sandbox directory is sent to the file system 360. Upon receiving a handle from the file system 360, the interception module returns this handle to the application 405.

Referring again to step 1445, if the file is not already identified to be opened in the sandbox directory then the process moves to a state 1450, wherein a virtual file name is created and encrypted and, as will be discussed below, redirected to the sandbox directory.

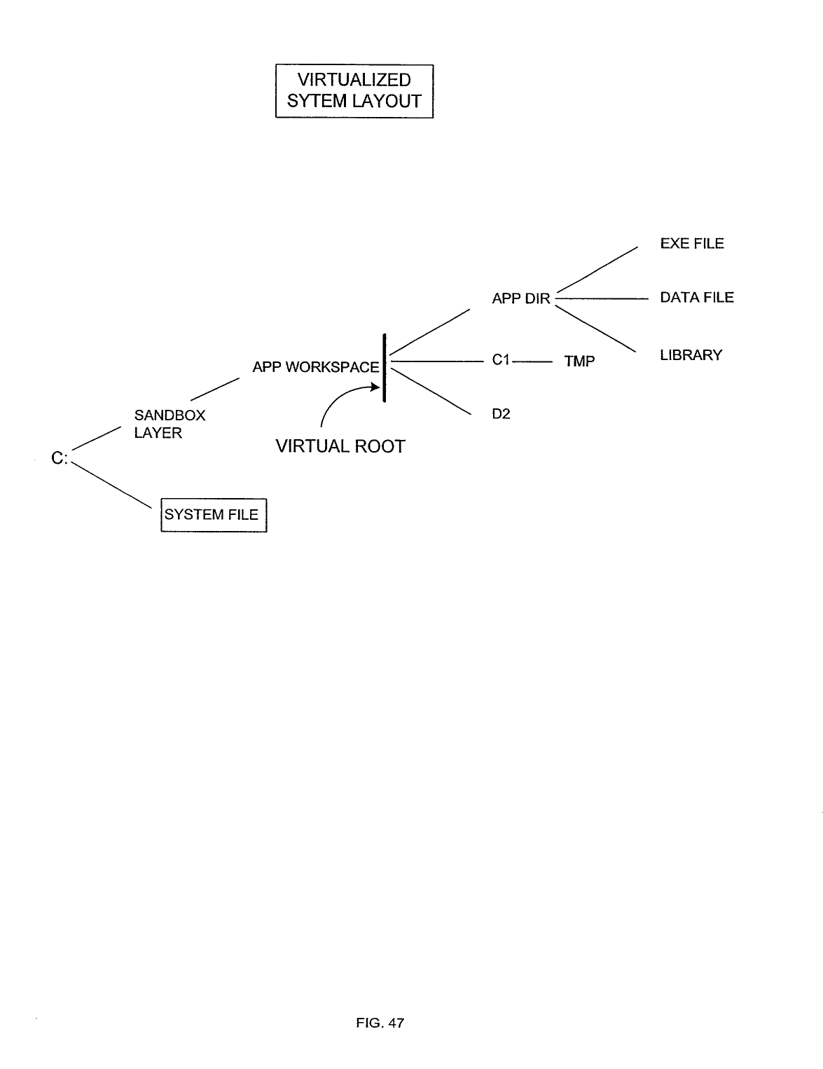

The interception module then moves to step 1455 and determines whether the directory in the file name already exists in the sandbox directory (“the virtual root tree” shown in FIG. 47). If the directory name exists, the process moves to steps 1484-1490 (discussed above) and calls the file system 360 requesting it to open the file in the sandbox directory using the encrypted filename. If the answer to the inquiry in step 1455 is “no,” the process moves to 1460, wherein the application 405 creates the directory in the sandbox directory and processes the original system request to open the file. Next, in steps 1484-1490, the open request for a file in the newly created directory is executed and the handle is returned.

In one embodiment, files can be stored remotely on separate machines, other than a client computer 140. For these files, all low level file manipulation APIs are passed through the interception module in the virtual layer 415. Instead of calling the local operating system kernel to perform the file operation, the operation is communicated over the network 130 to another computer or the server 120. The network 130 transfers the data and any handles back to the client computer 140 which is subsequently returned to the application 405 as an available resource.

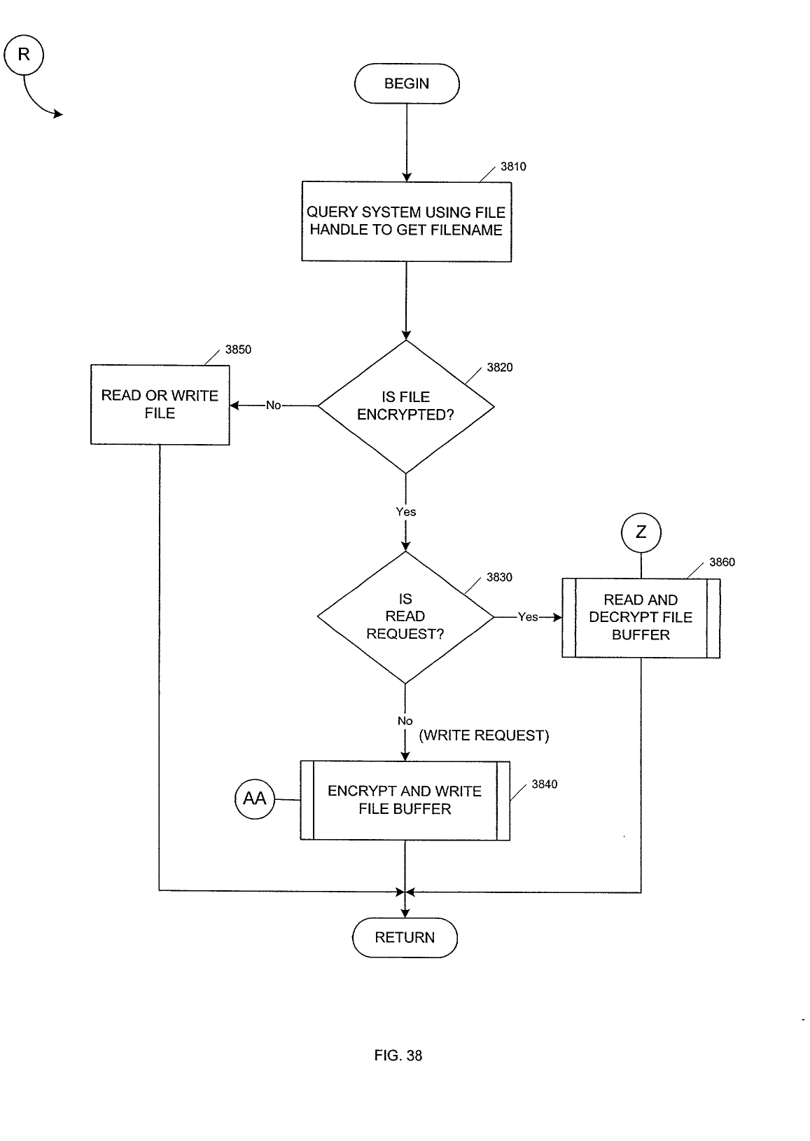

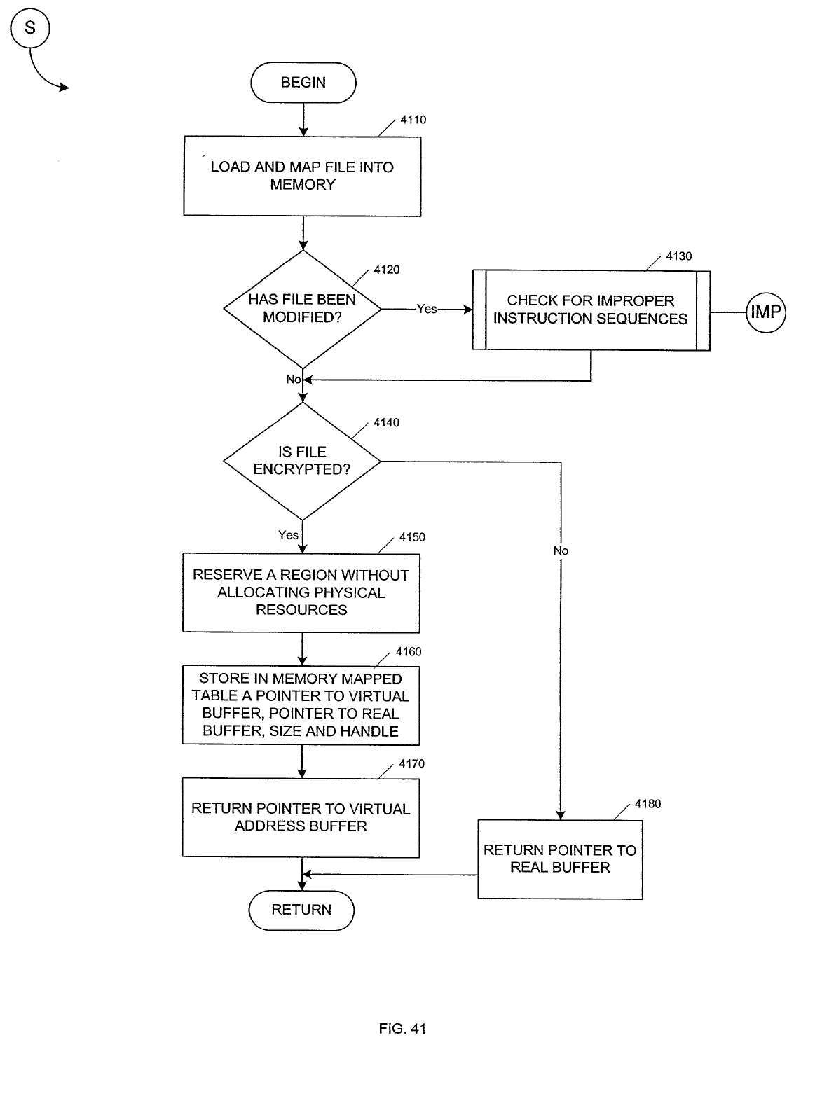

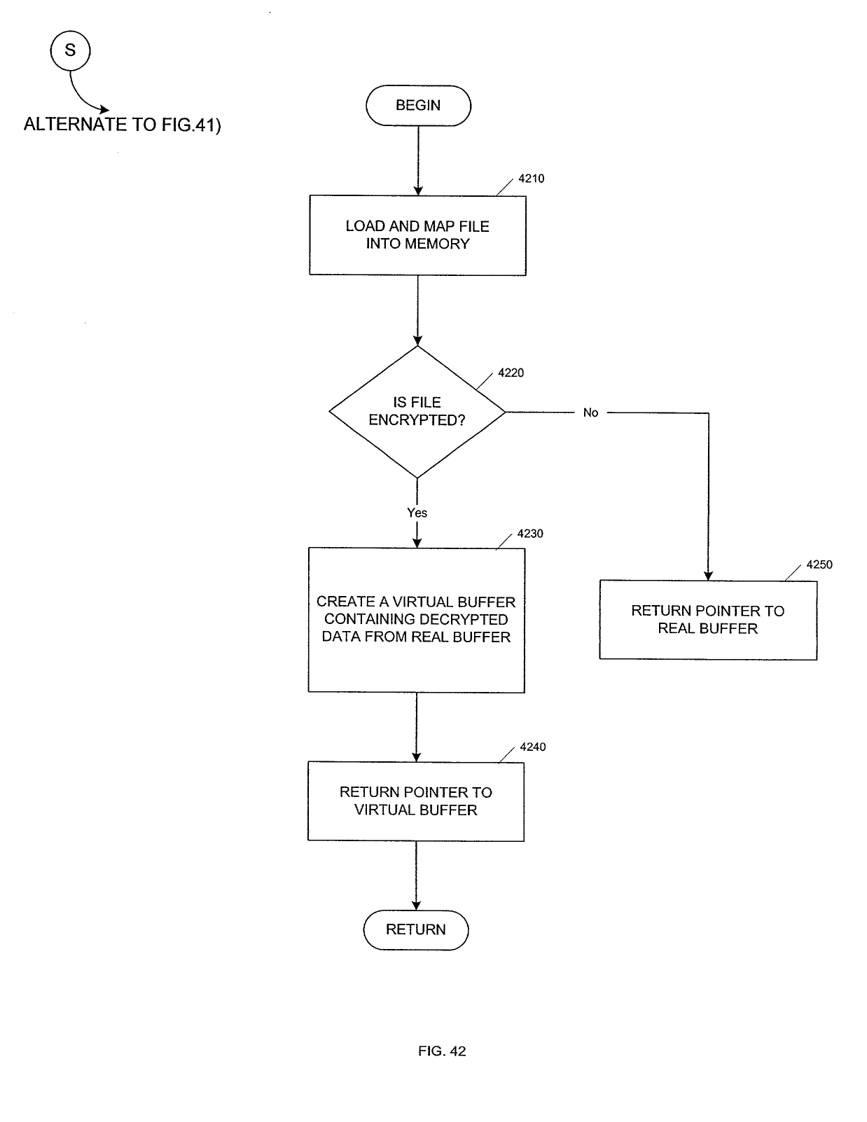

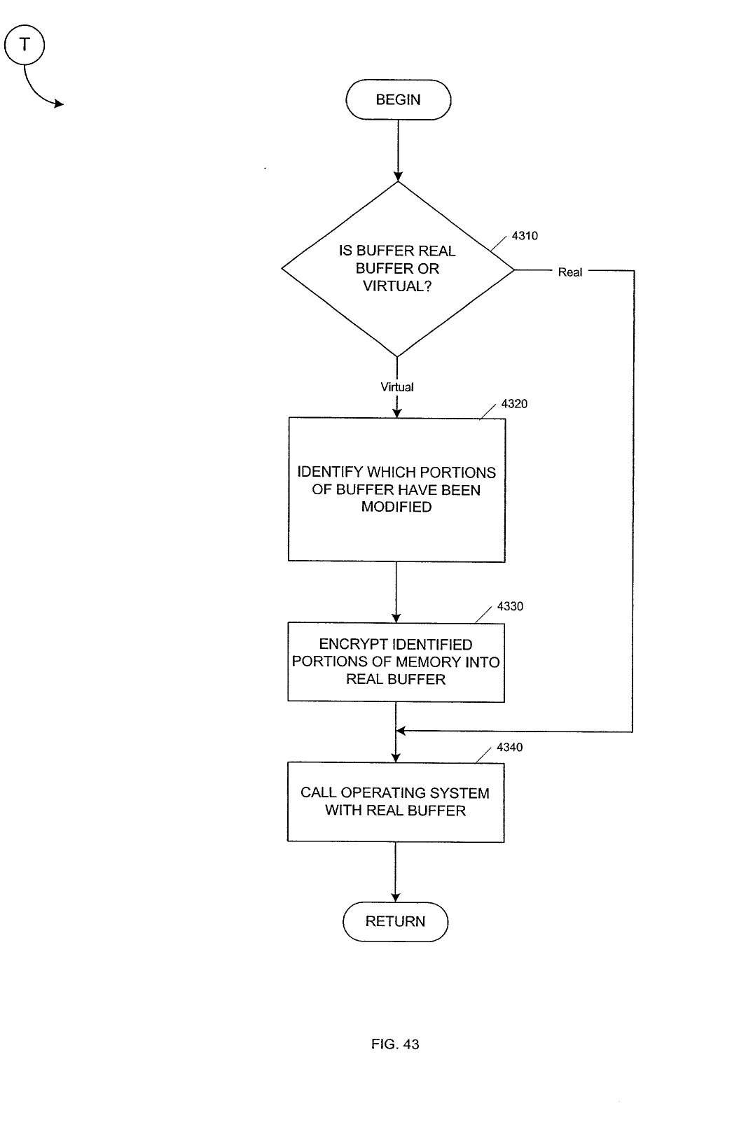

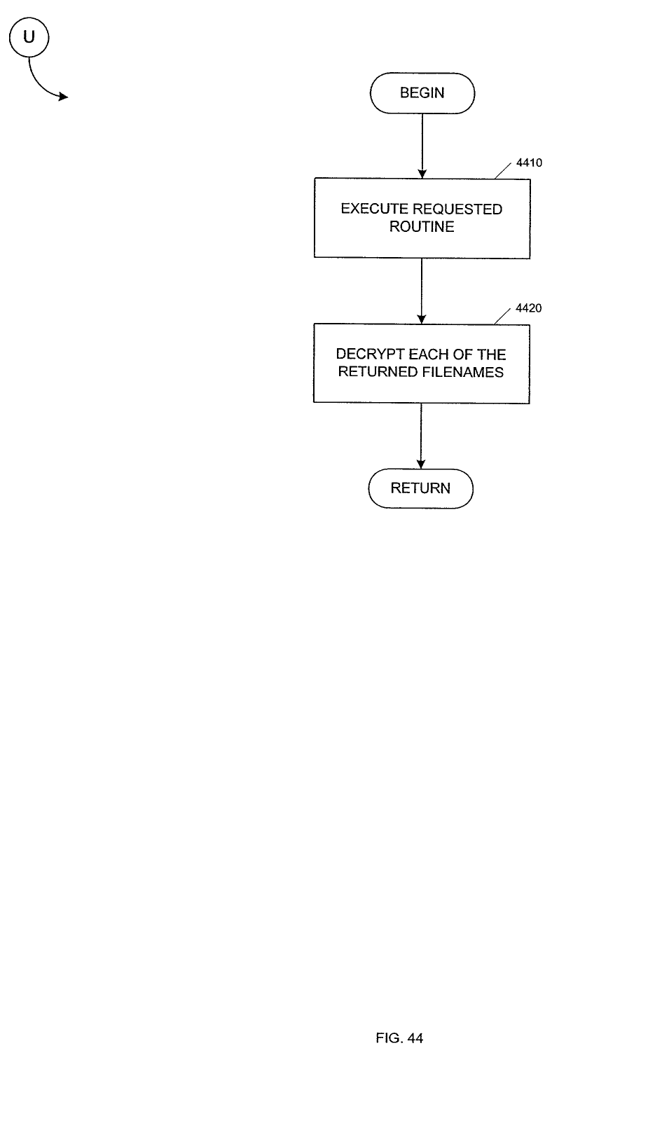

Referring again to steps 1415, 1420, 1425, and 1430, these blocks are described in further detail below. A process of intercepting file system read or write commands (step 1415) are described below with respect to FIGS. 38. Exemplary processes of intercepting request to map a file to memory (step 1420) are described below with respect to FIGS. 41 and 42. A process of unmapping a file to memory (step 1425) is described below with respect to FIG. 43. A process of intercepting a routine that returns a filename (step 1430) is described below with respect to FIG. 44.

FIG. 15 is a flowchart that illustrates a process of handling an exception that is caused by the application 405. FIG. 15 shows in further detail the steps that occur in step 1305 of FIG. 13. Depending on the embodiment, selected steps may be removed, others added, and their order rearranged.

In addition to handling general exceptions, the interception module uses an exception handler to assist in virtualizing the map file to memory routine. Thus, in this regard, before the following steps are performed, the application has requested to map a file to memory. Instead of actually mapping the file to memory, the interception module returns a virtual buffer that does not have access privileges by the application 405. In response to accessing the virtual buffer, an exception is generated. The process of intercepting the map file to memory routine is described below with respect to FIG. 42.

Starting at a decision step 1510, it is determined whether an access violation is present, and whether or not it falls within one of the memory mapped virtual buffers. If the exception is not an access violation or the address does not fall within any of the virtual buffers, the process moves to step 1550 where the interception module passes on the exception. In step 1560, if the exception is not resolved by an error handling routine, the exception is passed to the virtual machine communication thread. The VM thread then communicates the error back to the application manager 410. Referring again to step 1510, if the exception is seen as an access violation and falling within one of the virtual buffers, the process moves on to step 1520. In step 1520, the corresponding block of information that caused the exception is identified. Moving to step 1530, the block causing the exception is decrypted and is copied to the virtual buffer that is being used by the application 405. In the final step 1540, the virtual buffer is granted access privileges to the contents of the virtual buffer.

FIG. 16 is a flowchart for intercepting a load library routine that was invoked by the application 405. FIG. 45 shows in further detail the steps that occur in step 1610 of FIG. 16.

Starting at a step 1610, the file name of the load library file is encrypted for those libraries that are provided as part of the application package 415. It is to be appreciated that this step is not performed for those files that are local/native to the client computer 104. One process for encrypting a filename is described below with respect to FIG. 45. Proceeding to step 1620, the process loads the load library file that is passed as part of the load library routine into memory if it has not already been loaded.

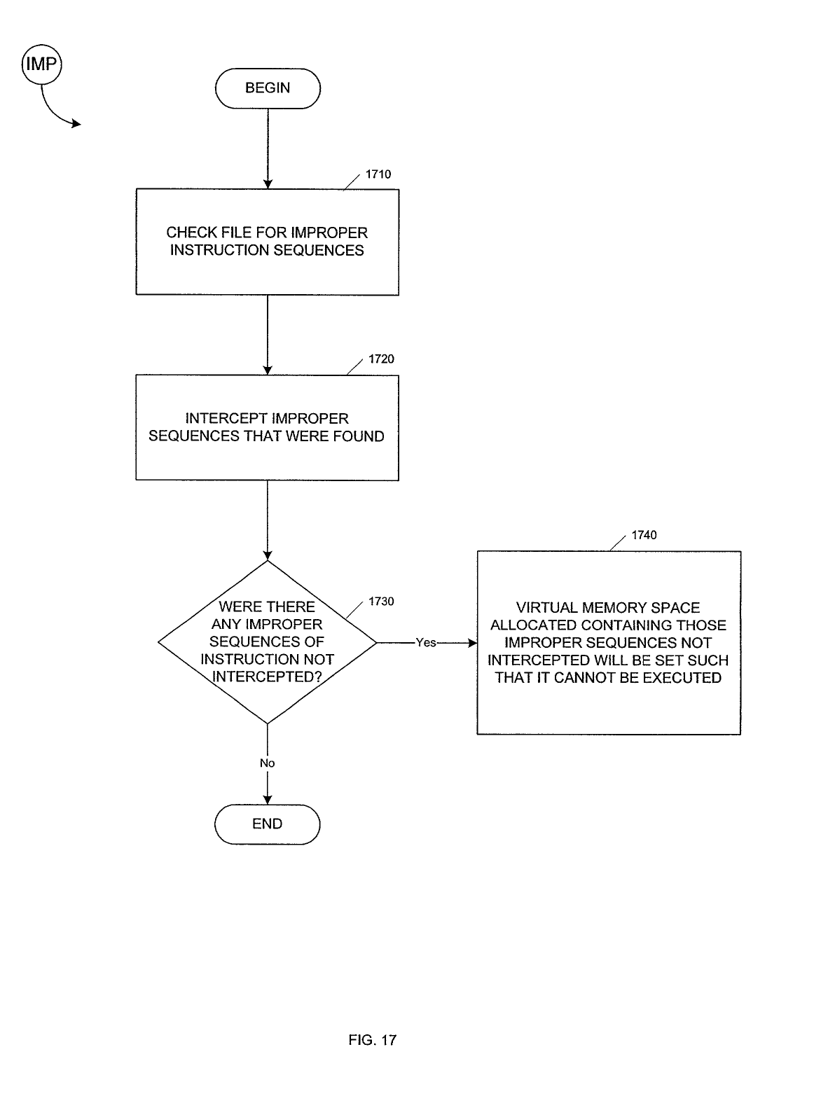

Continuing to a decision step 1630, the interception module determines whether the file that is subject of the load library request has been modified. For convenience of description, this file is hereinafter called the “load library file.” If the process determines that the load library file has been modified, the load library file is checked for improper sequences (step 1640). A process of checking for improper sequences is described further hereafter with reference to FIG. 17. Next, from the step 1640, or, alternatively, if the file has not been modified (step 1630) then the process moves to step 1650 wherein the import table of the load library file is scanned and all of the libraries in the import table are loaded into memory, if they are not already. The steps shown of FIG. 16 then are then recursively performed for each of these libraries.

Continuing to a step 1660, the loaded libraries are patched. The process of patching loaded libraries was previously discussed with reference to FIG. 10. Proceeding to a step 1665, all code pages of the loaded library are made execute only and execution privileges are removed from the remainder of loaded library pages. Moving to a step 1670, all of the DLL's corresponding to the loaded libraries are initialized by executing their respective DllMain() routines.

FIG. 17 is a flowchart of a process for handling improper sequences that are found in the application 405 during preprocessing, or, alternatively, with respect to any new files or dynamically generated code. Depending on the embodiment, additional steps may be added, others removed, and the ordering of the steps may be rearranged.

Starting at step 1710, the process checks each file and identifies improper instruction sequences. Moving to step 1720, the improper sequences are re-written to be intercepted. Continuing to step 1730, the process determines whether there are any improper sequences of instructions are not intercepted. Proceeding to step 1740, if the sequences are not intercepted then the virtual memory space containing those improper sequences are set to a “non-executable” status.

Improper sequences can occur when the application 405 attempts to directly execute an interrupt call on the operating system kernel of a client computer 140. The interception module can either classify the sequences as potentially harmful and make them non-executable, or the binaries can be rewritten to replace the interrupt with a call to the virtual layer 415.

FIG. 18 is flowchart that maps potential network requests that can be virtualized on a client computer 140. This diagram provides some exemplary samples of virtualized network requests that may be used as a form of communication between both the installed application package 115 and the server computer 120, as well as different application packages 115 on separate client computers 140, to support peer-to-peer computing. The virtualized network requests that are referenced in the Figure are “accept” 1805, “send” 1810, “send to” 1815, “receive” 1820, “receive from” 1825, “close” 1830, “shut down” 1835, “select” 1840, “socket” 1845, “bind” 1850, “connect” 1855, “listen” 1860, “query” 1865, “update” 1870. It is noted that other network types of routines may be virtualized.

Referring briefly to FIG. 48, in one embodiment the proxy and the interception module are implemented to run in two separate processes. In this embodiment, they communicate via the Windows inter-process communication mechanism, memory-mapped files. In this embodiment, the socket table 4800 is a memory mapped file shared between the interception module and the proxy device.

In another embodiment, the proxy and the interception module are threads within the same process. In this embodiment, the threads communicate through well-defined API procedure calls and shared memory. In this embodiment, the socket table 4800 can be a shared structure between the two threads.

As an illustrative example, the socket table 4800 can include various fields for storing: a local socket structure 4804, a remote socket structure 4812, a socket status 4816, socket options 4820, a send queue 4824, receive queue 4828, and a connection queue 4832. Each of these fields are discussed in further detail below.

The local socket structure 4804 contains socket information about the local virtual socket. For example, the socket information can include: (i) a unique socket identifier which is determined by the interception module, (ii) the socket type (UDP or TCP), (iii) the protocols, and (iv) network addresses (which include the IP address, family (IP), and port).

The remote socket structure 4812 can include socket information about the remote virtual socket (the remote virtual socket is the socket that the virtual local socket is connected to) and can contain the same type of information discussed above.

The socket status field 4816 identifies the status of the local socket. If the socket is in a current state then the respective status entry is set. A socket can be in multiple states at a time. The list of states, as can be appreciated by one of ordinary skill the art to include: UNCONNECTED, RECEIVING, SENDING, LISTENING, CONNECTED, DISCONNECTED, TERMINATED, SHUTDOWN, and BOUND.

The socket options 4820 field reflects options that are currently set and these settings can potentially affect the socket. The options may be set with the set socket option command as is typically provided for network communication in many systems. An example of some socket options include: SO_ACCEPTCONN, and SO_DONT ROUTE.

The send queue 4824 is used to store data and the destination address of its intended destination. The receive queue 4828 is used to store incoming data and its source address. The receive queue 4828 is read and used by the interception module to hold incoming data for the application 405.

The connection queue 4832 stores, if the local socket is in a listening state, connection requests to the local socket from a remote socket until the interception module can process the connections The interception module in the virtual layer 415 assures that network connections are only made to a pre-approved set of connections which may have been defined during the execution of the application 405.

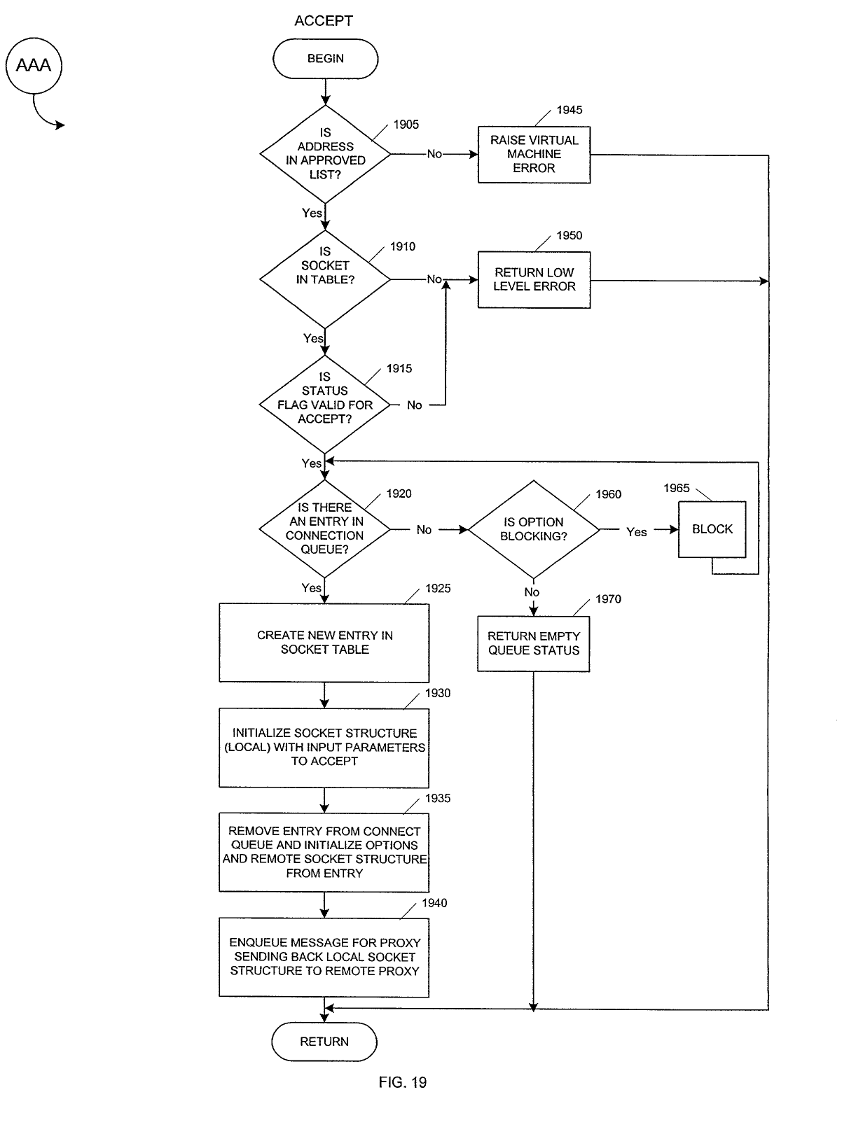

FIG. 19 is a flowchart showing a process for intercepting an “accept” routine that is invoked by the application 405. Starting at a step 1905, the interception module identifies the network request by determining whether the address provided by the application 405 is listed in a pre-defined list. If the address is not in the predefined list, the process moves to step 1945, wherein a virtual machine error is raised and transmitted to the VM communication thread and the request rejected.

Referring again to the decision step 1905, if the address is in the approved list, the process flow proceed to a decision step 1910, wherein it is determined whether the socket is in the socket table 4800 (FIG. 48). Leading to step 1950, if the socket is not in the socket table 4800, then a low level error is returned to the application 405.

Referring again to decision step 1915, if it is determined whether the status flag of the socket is valid, e.g., the status is “LISTENING”, for accepting accept request, the process proceeds to a decision step 1920. If the status is not valid, the process proceeds to the step 1950, discussed above.

At the decision step 1920, the system determines whether there is an entry in the connection queue prior to continuing. If there is an entry in the connection queue, the process proceeds to a step 1925, otherwise step 1960.

At the step 1925, a new entry is created in the socket table 4800. Moving to step 1930, the socket structure is initialized with the input parameters to accept the virtualized network request. Continuing to step 1935, the entry is removed from the connection queue and the new socket structure is initialized. In the step 1940, a proxy for the client computer 140 sends back local socket structure information to a remote proxy located on the server computer 120, or in the case of peer-to-peer computing, another computer.

Referring again to the decision step 1920, the path in the “no” direction is followed. At a decision step 1960, it is determined whether the socket is blocking or non-blocking. Moving to step 1965, if it is blocking, the interception module process blocks and waits for an event to unblock it before continuing back to step 1920. However, if the socket is non-blocking, an empty queue status is returned.

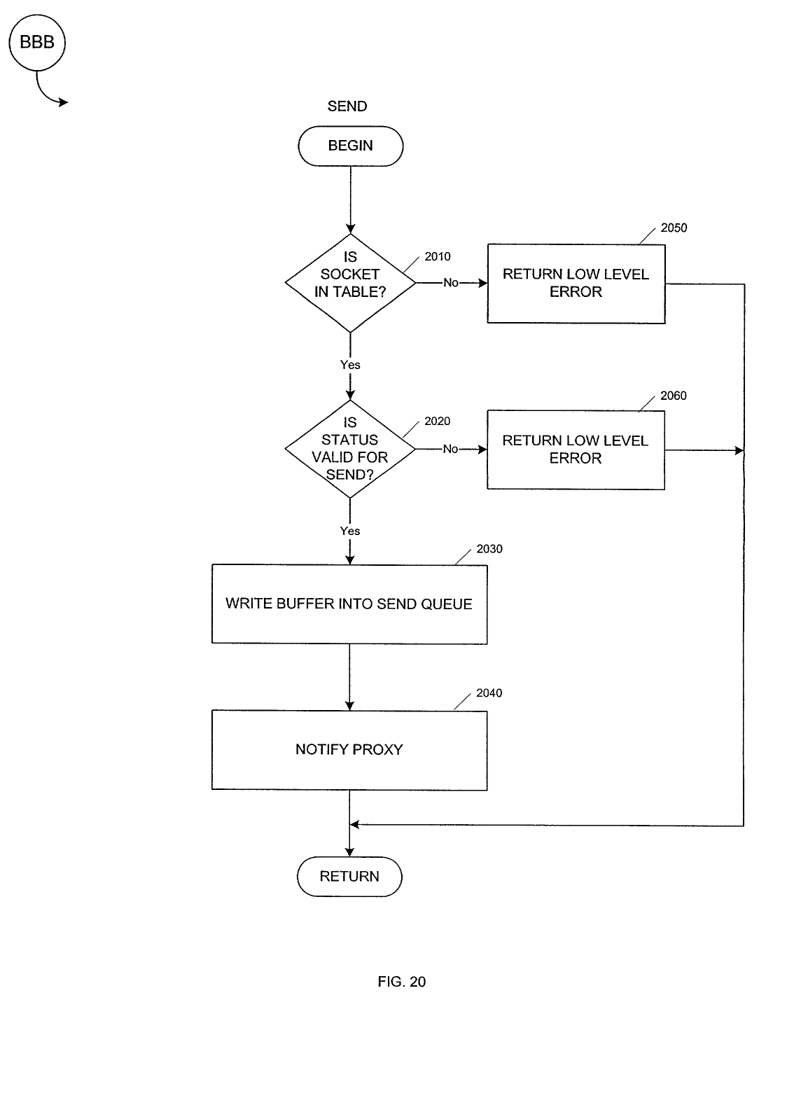

FIG. 20 is a flowchart showing virtualized network requests relating to intercepting a “send” routine, as is referenced from step 1810 of FIG. 18. Depending on the embodiment, selected steps may be removed, other added, and the ordering of the steps may be rearranged.

Starting at a step 2010, it is determined whether the socket that was provided by the application 405 as a parameter, when the application 405 invoked the send system call, is located in the socket table 4800 (FIG. 48). Moving to step 2050, if the socket table 4800 does not include the socket, then a low level error is returned to the application 405. Continuing to step 2020, if the socket is located in the socket table 4800, the process determines whether it is valid, e.g., the status is “CONNECTED” and not “SHUTDOWN”, to send data given the sockets status.

If the status is not valid for sending, the interception module returns to the application 405 a low level error. However, if the status is valid for sending, an application provided buffer is written into the send queue. In another embodiment, the application provided buffer is passed to the proxy, and the proxy writes it into the socket table send queue. Next, at step 2040, the interception module notifies the proxy.

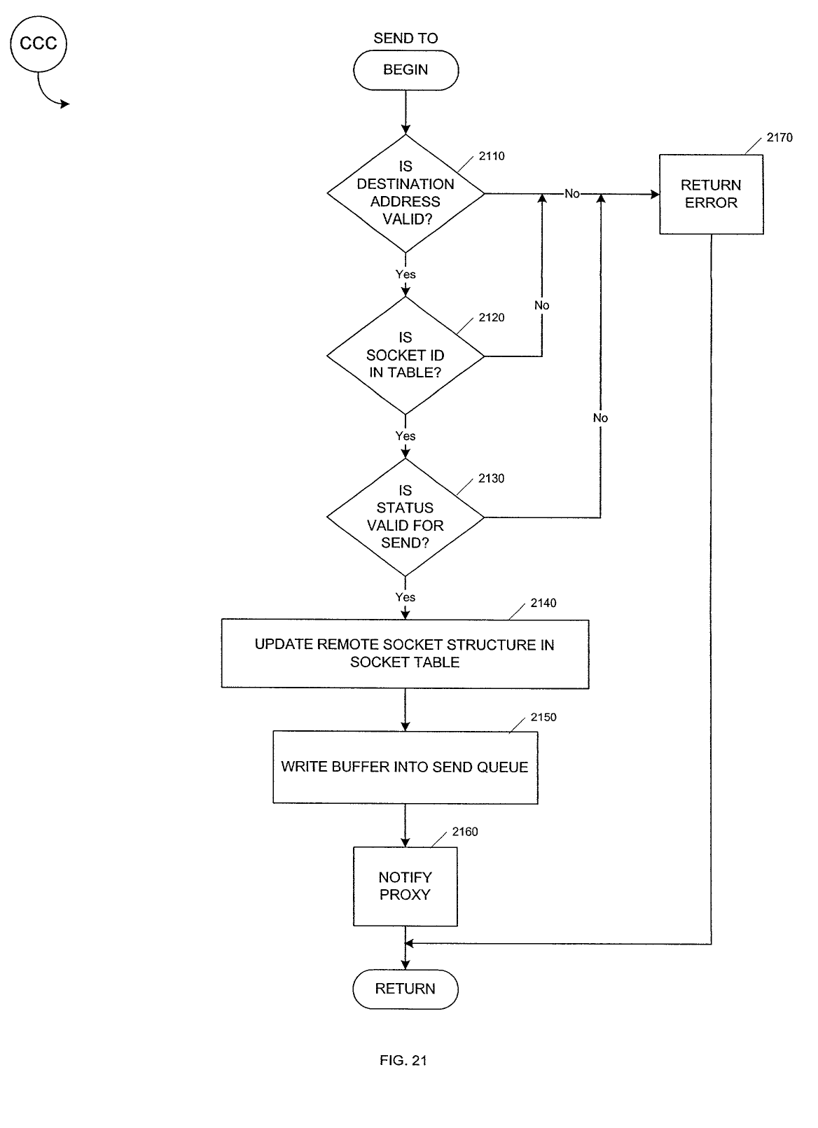

FIG. 21 is a flowchart for the “send to” network request as seen first referenced in step 1815 in FIG. 18. Depending on the embodiment, selected steps may be omitted, others added, and the ordering of the steps may be rearranged.

Starting at a decision step 2110, it is determined whether the destination address is valid. If the destination address is not valid, the process moves to step 2170, wherein an error is returned to the application 405.

Referring again to the decision step 2110, if the destination address is valid, the process flow proceeds to a decision step 2120, wherein the process determines whether the socket is located in the socket table 4800 (FIG. 48). If the answer is “no,” then an error is returned 2170 to the application 405. Proceeding to step 2130, the process determines whether the request is valid given the status conditions of the socket, e.g., the status condition is not “LISTENING”, not “SHUTDOWN”, and not “TERMINATED”. If the conditions are not valid, the interception module returns a low level error to the application 405.

Referring again to the decision step 2130, if the status is valid for sending, the remote socket structure in the socket table 4800 is updated with the destination address. Moving to step 2150, information stored in the buffer is written into the send queue where it waits for transmission by the proxy device of the client computer. In another embodiment, the application buffer is just passed to the proxy, and the proxy writes it into the socket table send queue. Next, at step 2160, the proxy of the approved virtualized network request is notified.

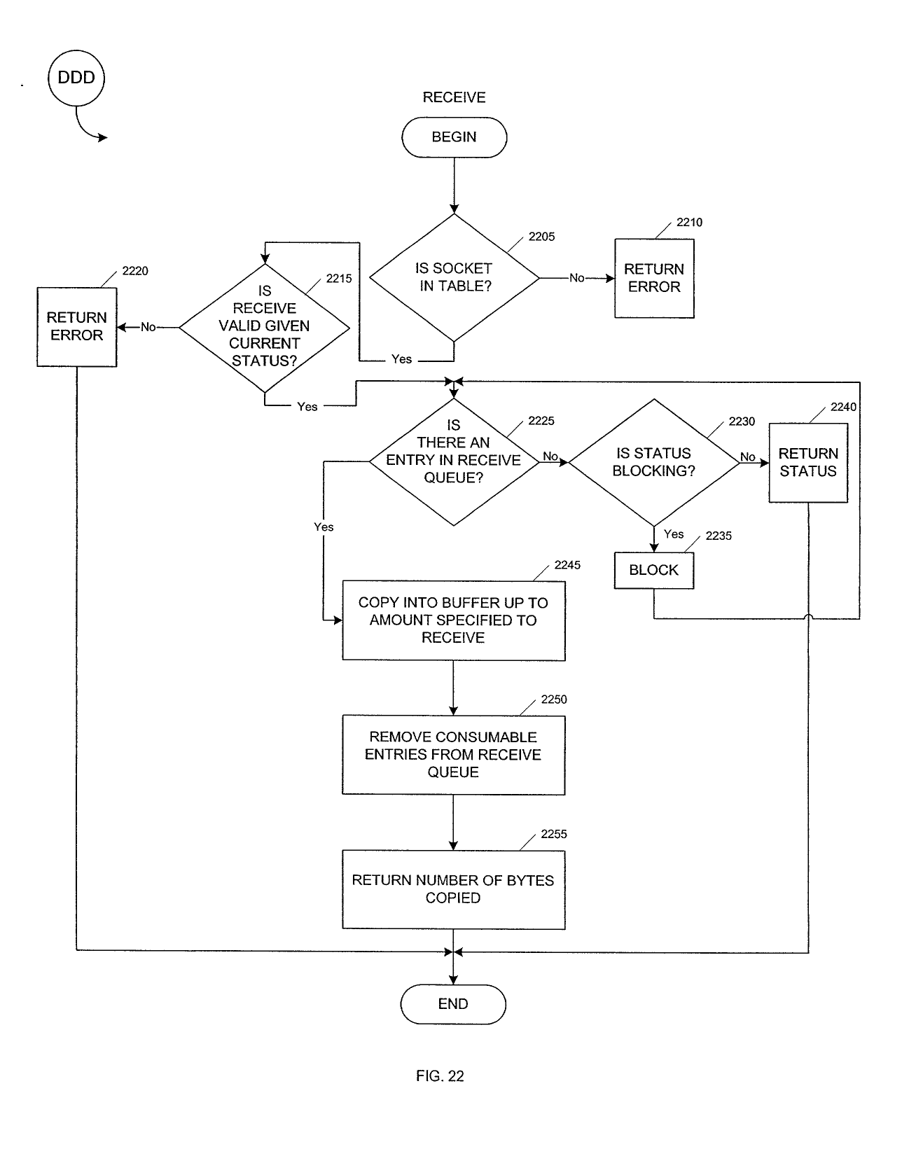

FIG. 22 is a flowchart showing a process for intercepting a “receive” network that was invoked by the application 405. FIG. 22 shows in further detail the steps that occur in step 1820 of FIG. 18. As part of the receive network request, the application program passes a socket structure, hereinafter referred to the receive socket.

Starting at a step 2205, it is determined whether the receive socket is in the socket table 4800. If the answer to the inquiry is “no,” then an error is returned in step 2210. If “yes,” then the process moves to step 2215 wherein the process checks the receive status to see if it is currently it is valid, e.g., has a status of “CONNECTED”, to perform the receive request with respect to the receive socket.

Step 2220, raises an error message if the socket status is not valid for a receive. Referring again to decision step 2215, if the status is valid, the process moves to step 2225 and the process looks to see if there is an entry in the receive queue. If there is not an entry in the receive queue, the process proceeds to a decision step 2230. If there is an entry in the receive queue, the process proceeds to a step 2245.

Referring to the decision step 2230, it is determined whether the status of the socket is blocking. If the status is blocking, the process proceeds to a step 2235, wherein it waits to receive an entry in the receive queue. If the status of the socket is non-blocking, the process proceeds to a step 2240 wherein the status of the socket is returned to the application.

Referring again to step 2225, if there is an entry in the receive queue, the process proceeds to the state 2245 wherein the information from the receive queue is copied into the buffer per the specified size request. Moving forward to step 2250, consumable entries are removed from the receive queue and discarded. Proceeding to the final step 2255, the number of bytes copied is returned to the application 405.

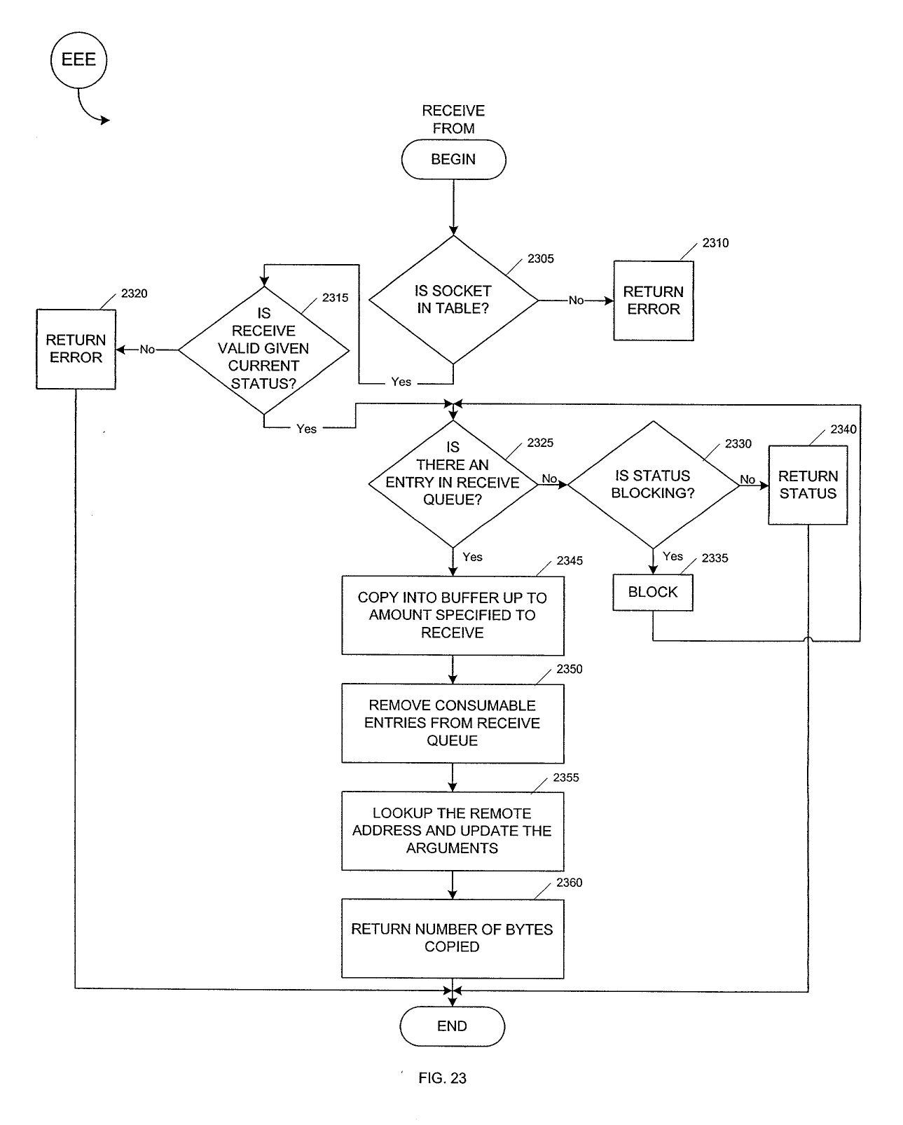

FIG. 23 is a flowchart showing a process for intercepting a “receive from” routine that was invoked by the application 405. FIG. 23 shows in further detail the steps that occur with reference to step 1825 in FIG. 18. This Figure represents only minor differences from FIG. 22 where one additional box is added towards the end of the process.

Starting at step 2305, it is determined whether the socket is in the socket table 4800. If “no,” then an error is returned in step 2310. If “yes,” then the process moves to step 2315 wherein the process checks the status to determine whether it is valid to receive, e.g., the status is not “LISTENING” and not “CONNECTED”. Step 2320, raises an error message if the socket status is not valid for receive. Moving to step 2325, where a “yes” response to decision state 2315 is given, the process looks to see if there is an entry in the receive queue. Progressing to 2330, it is determined whether the status of the receive queue is blocking. Step 2340 identifies the status as not blocking in response to a “no” answer to step 2325. The status is returned to the system in step 2340. Step 2335 blocks until an entry is received in the receive queue and the process loops back to step 2325.

Referring to the step 2345, the information from the receive queue is copied into the buffer per the specified size request. Moving forward to step 2350, consumable entries are removed from the receive queue and discarded. Continuing to step 2355, the process looks up remote addresses and updates the arguments. Proceeding to the final step 2360, the number of bytes that was copied is returned to the application 405.

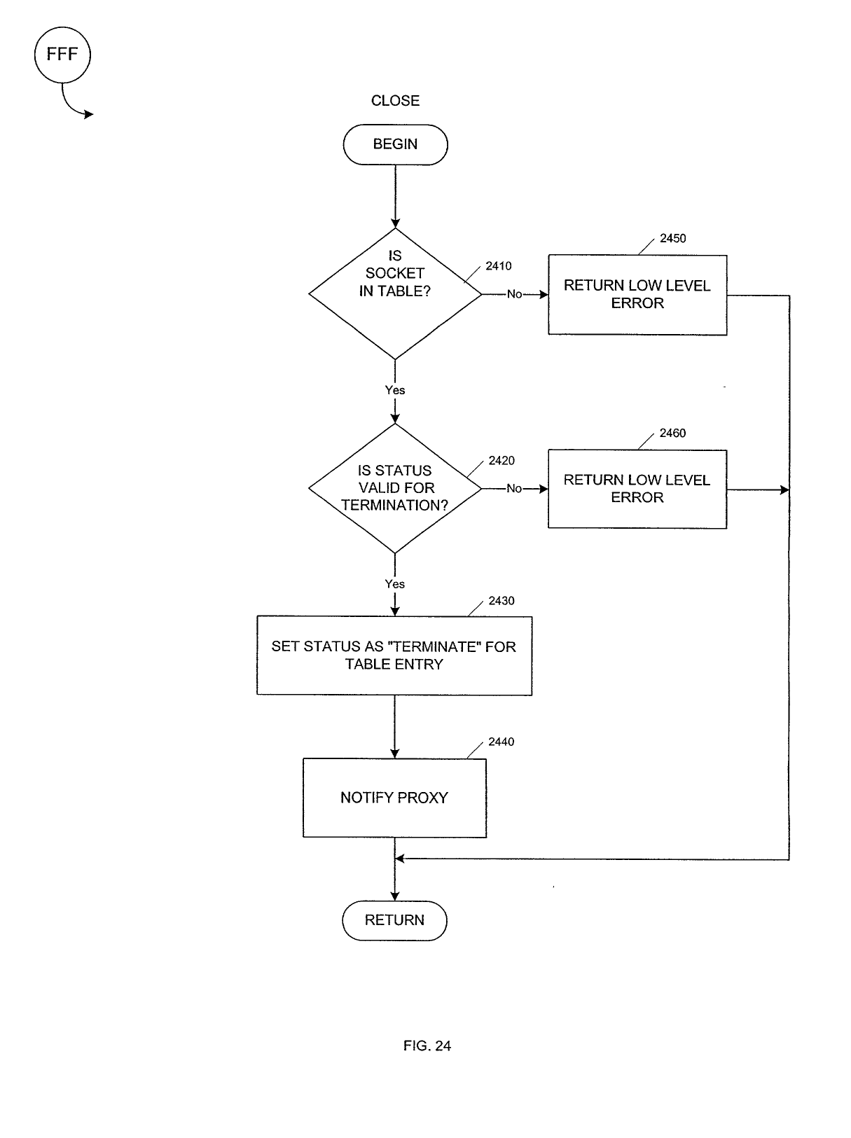

FIG. 24 is a flowchart that illustrates the process for intercepting a “close” routine that was invoked by the application 405. FIG. 24 shows in further detail the steps that occur in step 1830 of FIG. 18.

The first decision step 2410 determines whether the socket is in the socket table 4800. In step 2450, the process determines that the socket is not in the socket table 4800 and a low level error is returned to the application 405. If the socket is identified to appear in the socket table 4800 (step 2410) then the flow moves to step 2420 to determine whether it is valid to close the socket. If it is not valid, a low level error is returned in step 2460. Progressing to step 2430, if is valid to close the socket, the status of the socket is set to “terminate” in the socket table 4800. The final step 2440, notifies the proxy of the virtualized network request. In another embodiment, step 2430 and 2440 are replaced by the socket being directly removed from the socket table.

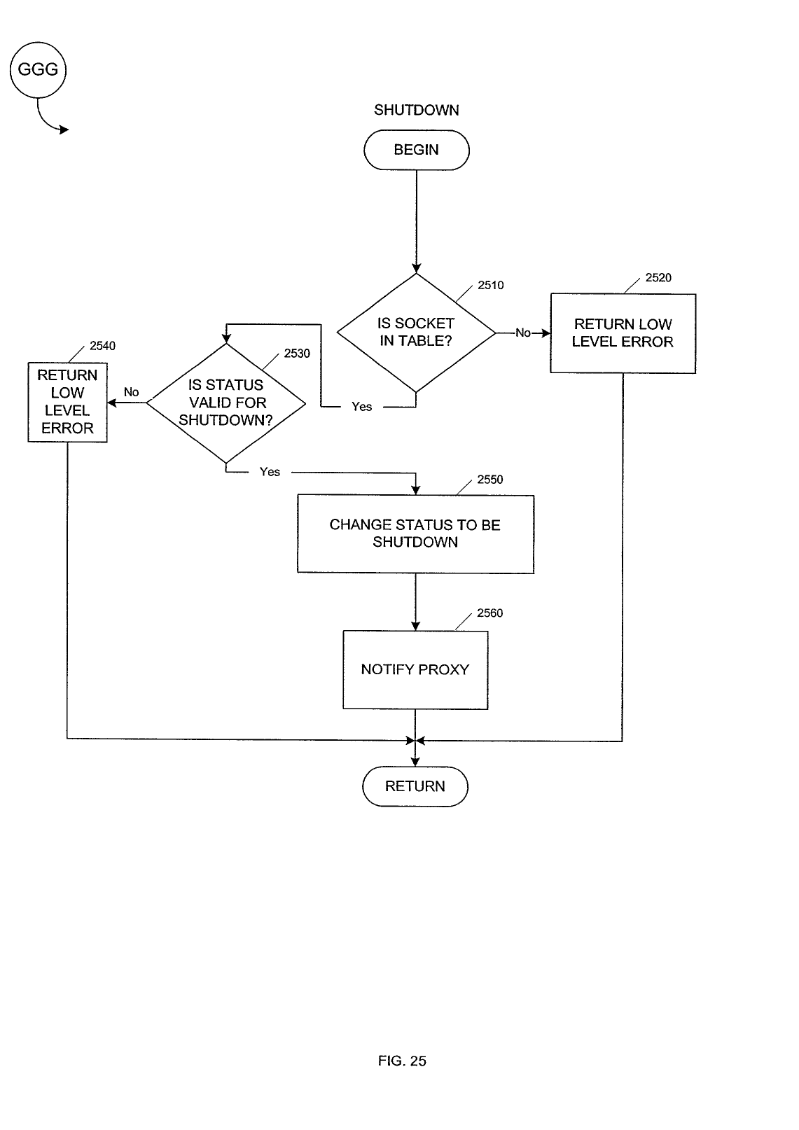

FIG. 25 is a flowchart showing a process for intercepting a “shut down” routine by the application 405 as first described with reference to step 1835 in FIG. 18. Starting at a decision step 2510, it is determined whether the socket can be located in the socket table 4800. If the answer to the inquiry is “no,” a low level error is returned to the application in step 2520.

Moving to a decision step 2530, it is determined whether the socket may be shutdown. If “no,” then a low level error is raised in step 2540 and reported to the application 405. If the socket can be shutdown, process flow proceeds to a step 2550 wherein the socket is shutdown. The final step 2560, notifies the proxy of a virtualized network request.

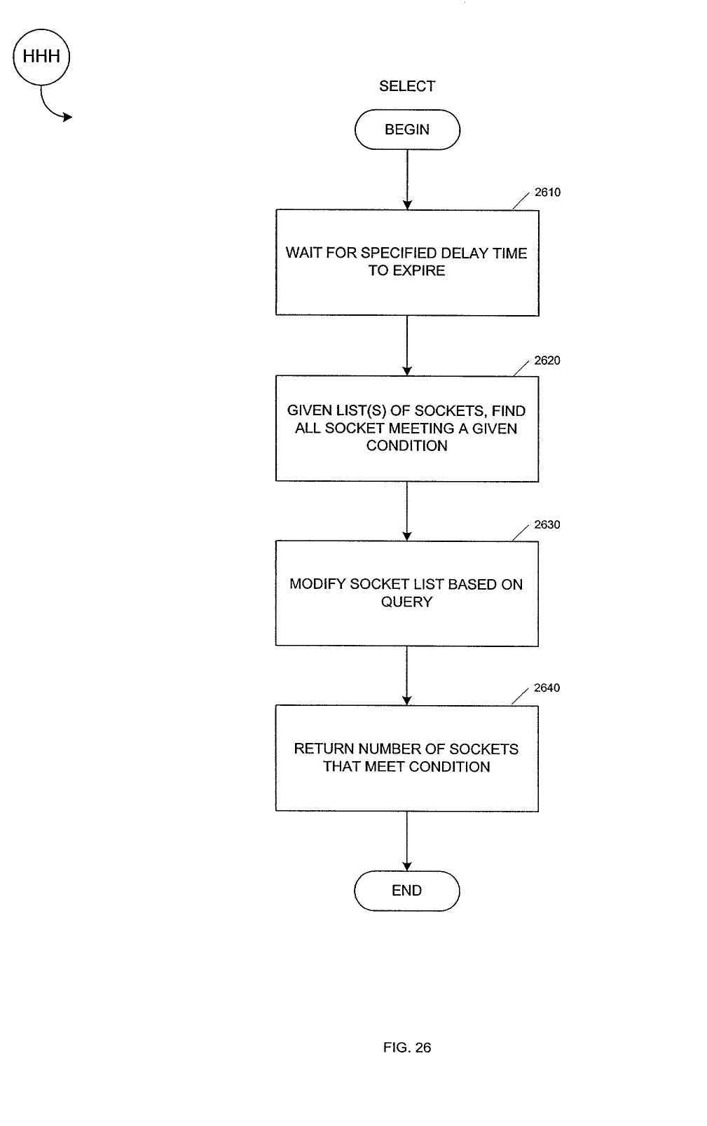

FIG. 26 is a flowchart showing a process for intercepting a “select” routine that was invoked by the application 405. FIG. 26 shows in further detail the steps that occur in step 1840 of FIG. 18. Starting at a step 2610, the system first waits for a specific, predetermined, amount of time, that was specified as a parameter to the select routine, to expire. Moving to step 2620, the interception module finds all sockets that meet a given condition that is provided by the application when invoking the select command. Continuing to step 2630, the socket list is modified based upon a query of the sockets. The sockets in the list of sockets are removed if they do not meet the specified criteria, or are marked with the criteria they match. In the step 2640, the number of sockets that meet the query conditions is returned.

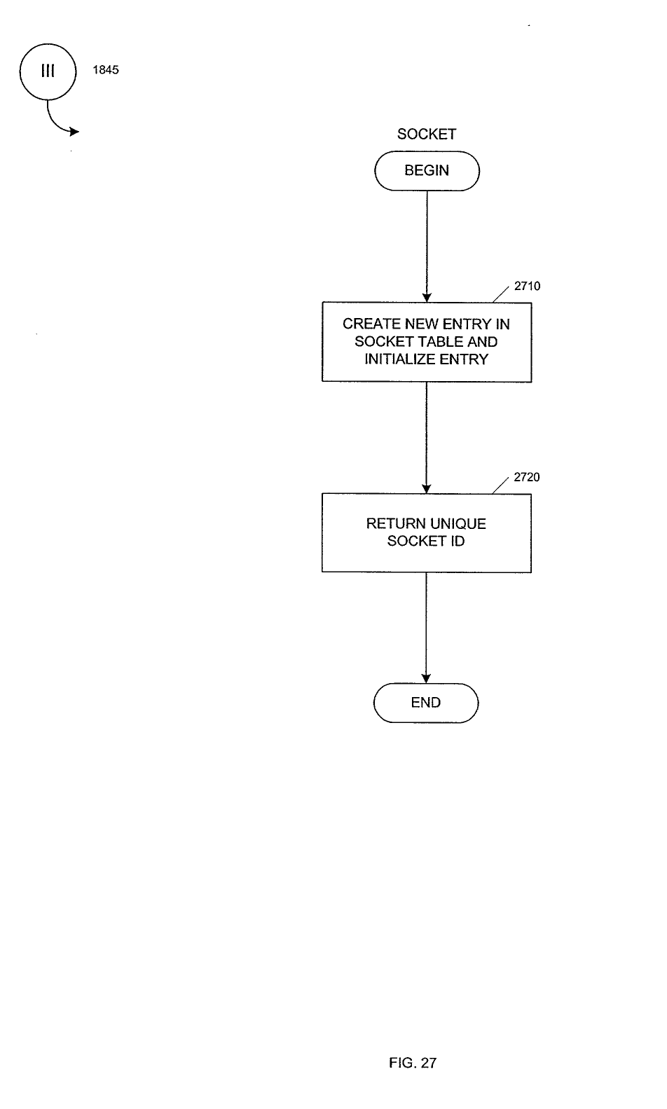

FIG. 27 is a flowchart illustrating the process for intercepting a socket routine that was invoked by the application 405. FIG. 27 describes in further detail the steps that occur in step 1845 of FIG. 18.

Starting at a step 2710, a new entry into the socket table 4800 is created and initialized. Moving to step 2720, a unique socket identifier is returned to the application 405.

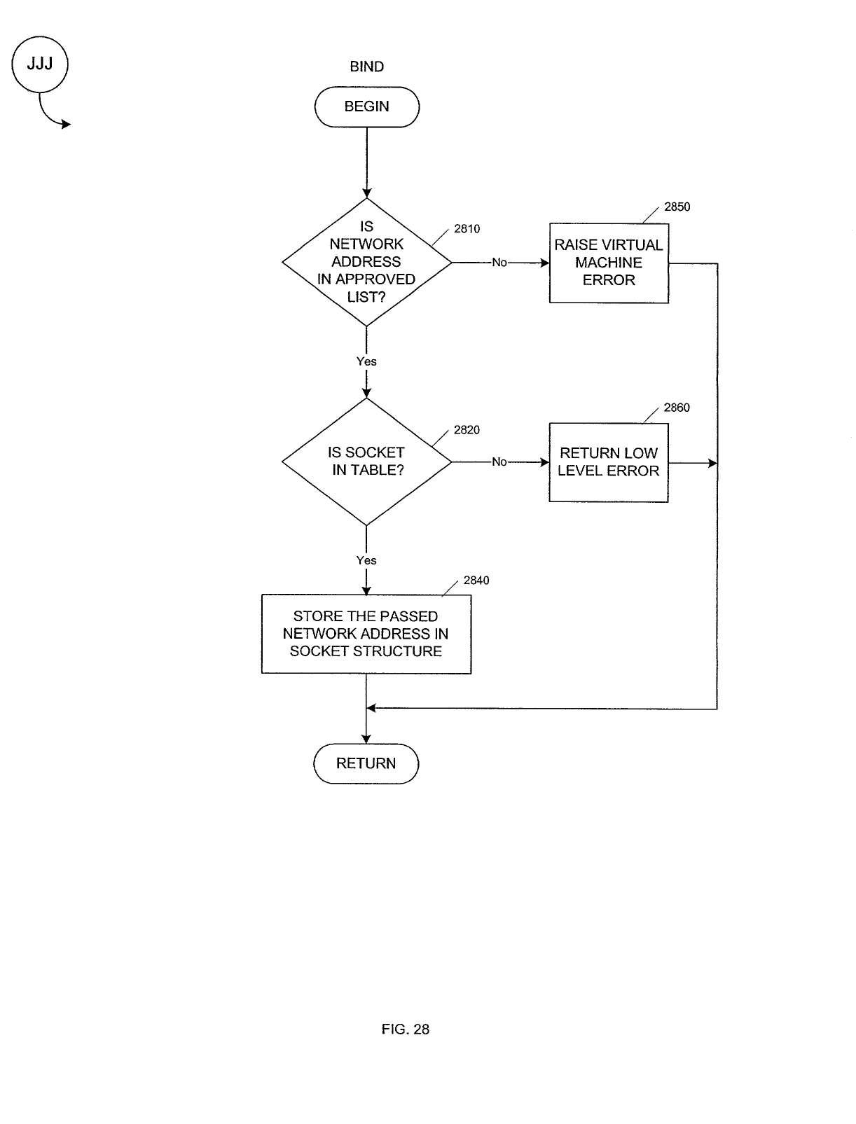

FIG. 28 is a flowchart showing a process for intercepting a “bind” routine that was invoked by the application 405. FIG. 28 shows in further detail the steps that occur in step 1850 of FIG. 18.

Starting at a decision step 2810, it is determined whether the network address is in an approved list. If the network address is not in the approved list, the process moves to step 2850, wherein a virtual machine error is raised. Referring to the decision step 2810, if the network address is in the approved list, process flow proceeds to a decision step 2820 wherein the process determines whether the socket appears in the socket table 4800. If the answer to the inquiry is “no,” then an error is returned to the application . Otherwise, if the answer is “yes,” the process moves to step 2840, where the network address is stored in the socket structure.

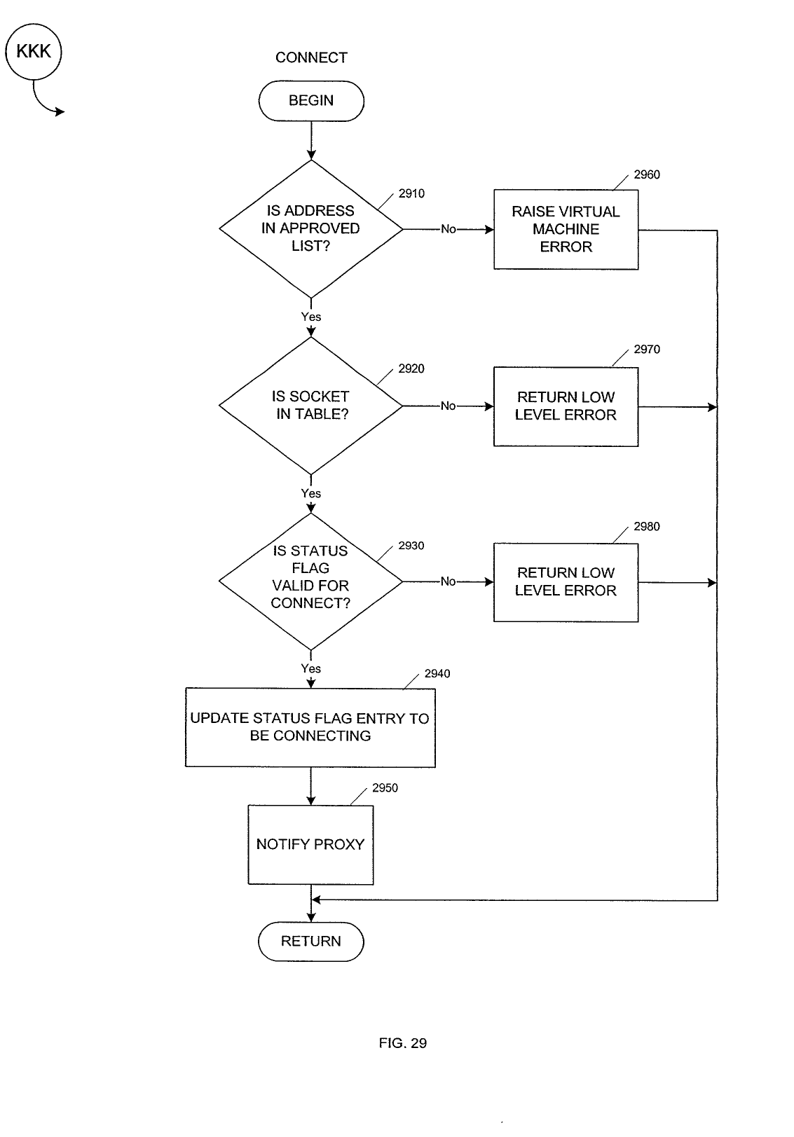

FIG. 29 is a flowchart showing a process for intercepting a “connect” routine that was invoked by the application 405. FIG. 29 shows in further detail the steps that occur in step 1855 of FIG. 18. When invoking the connect routine, the application passes as a parameter a socket structure herein after called the connect socket.

Starting at a decision step 2910, it is determined whether the address of the connect socket is in an approved list. If the address is not the approved list, the process flow proceeds to a step 2960 wherein an virtual machine error is raised. In one embodiment of the invention, all virtual machine errors are reported to the server 120 via the application manager 410.

Referring again to the decision step 2910, if the address is in the approved list, the process flow proceeds to a decision step 2920 wherein it is determined whether connect socket is in the socket table 4800. If the response is “no,” then an error is returned to the application in step 2970. Continuing to step 2930, the interception module determines whether the status flag in the socket table 4800 is valid for connecting, e.g., the status is either “SHUTDOWN”, “TERMINATED”, or not “CONNECTED”. If “no,” then an error is returned to the application 405 in step 2980. Proceeding to step 2940, and assuming that the flag has a valid status, the status flag is updated to read as “connecting.” Next, at step 2950, the interception module notifies the proxy of the virtual network request. At a later point, the proxy updates the socket table for this socket entry to be connected when there is an acknowledgement from the remote machine.

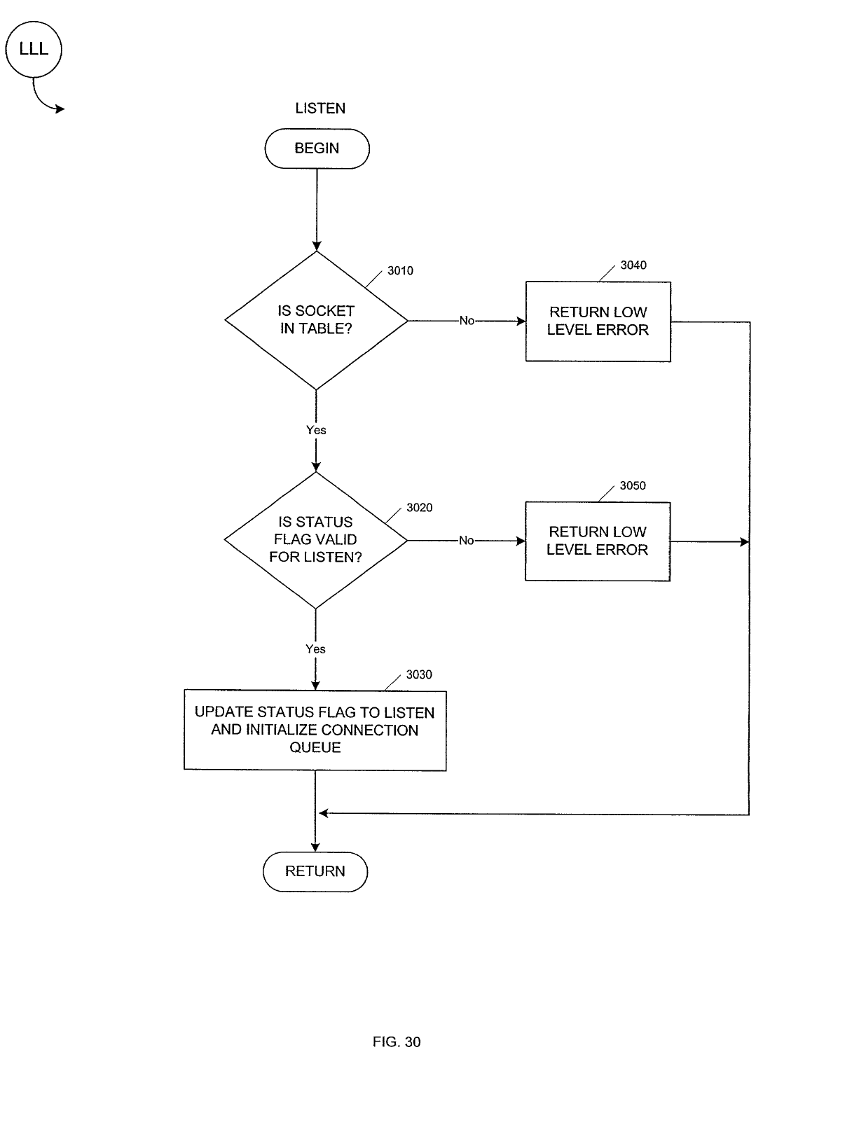

FIG. 30 is a flowchart showing a process for intercepting a “listen” routine that was invoked by the application 405. FIG. 30 describes in further detail the steps that occur in step 1860 of FIG. 18. Depending on the embodiment, selected steps may be added, other removed, and the ordering of the steps rearranged.

Starting at a decision step 3010, it is determined whether the socket is located in the socket table 4800. If not, a low level error is returned in step 3040. Moving to step 3020, should the socket be found in the socket table 4800, the interception module determines whether the status flag is valid for listening to the socket, e.g. the status is “CONNECTED”, and not “LISTENING”, not “SENDING”, and not “RECEIVING”, etc. If the state of the socket is not valid for listening, the system returns a low level error to the application 405 in step 3050. Continuing to step 3030, if the state of the flag is valid for listening, then the socket table 4800 is updated with the status flag of “listen” and the connection queue is initialized.

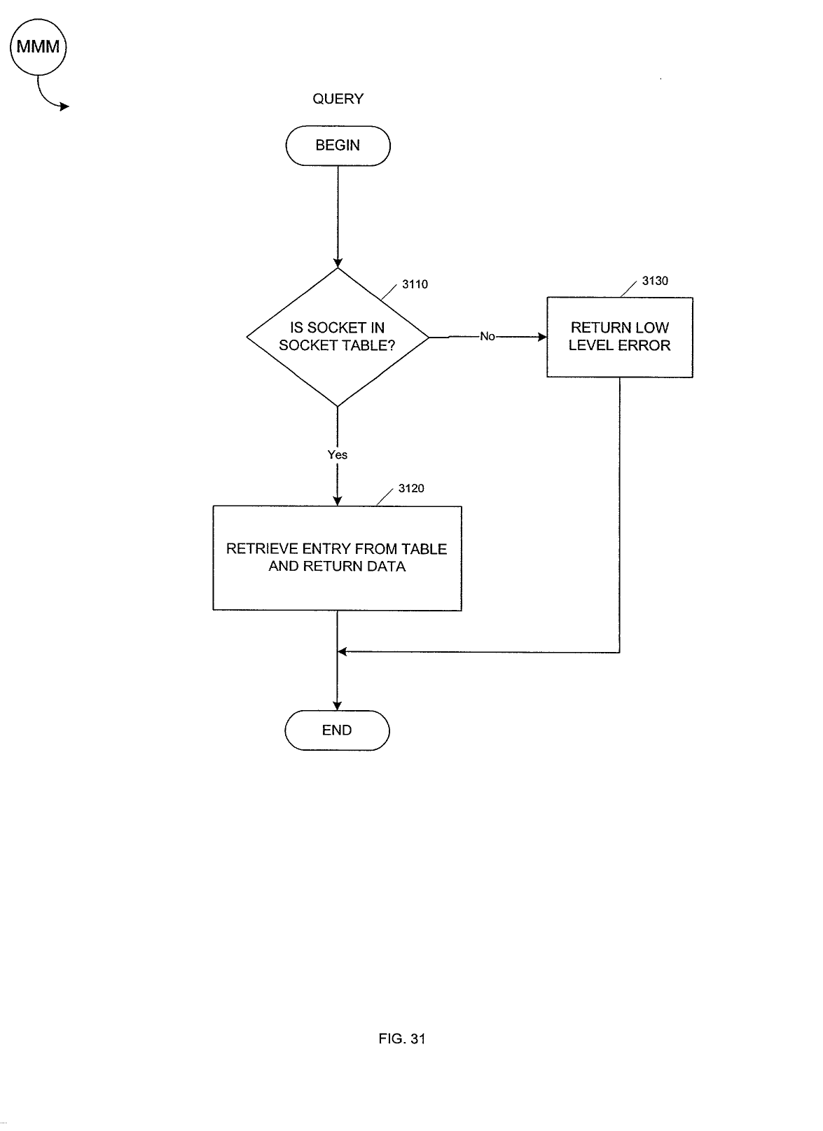

FIG. 31 is a flowchart illustrating a process of intercepting a query routine that was invoked by the application 405. FIG. 31 illustrates in further detail the steps that occur in step 1865 of FIG. 18. Starting at a step 3110, it is determined whether the socket is in the socket table 4800. If the response to the inquiry is “no,” a low level error is returned to the application 405 in step 3130. Moving to step 3120, if the socket is located in the socket table 4800, the entry in the socket table 4800 is retrieved and the data is returned to the system.

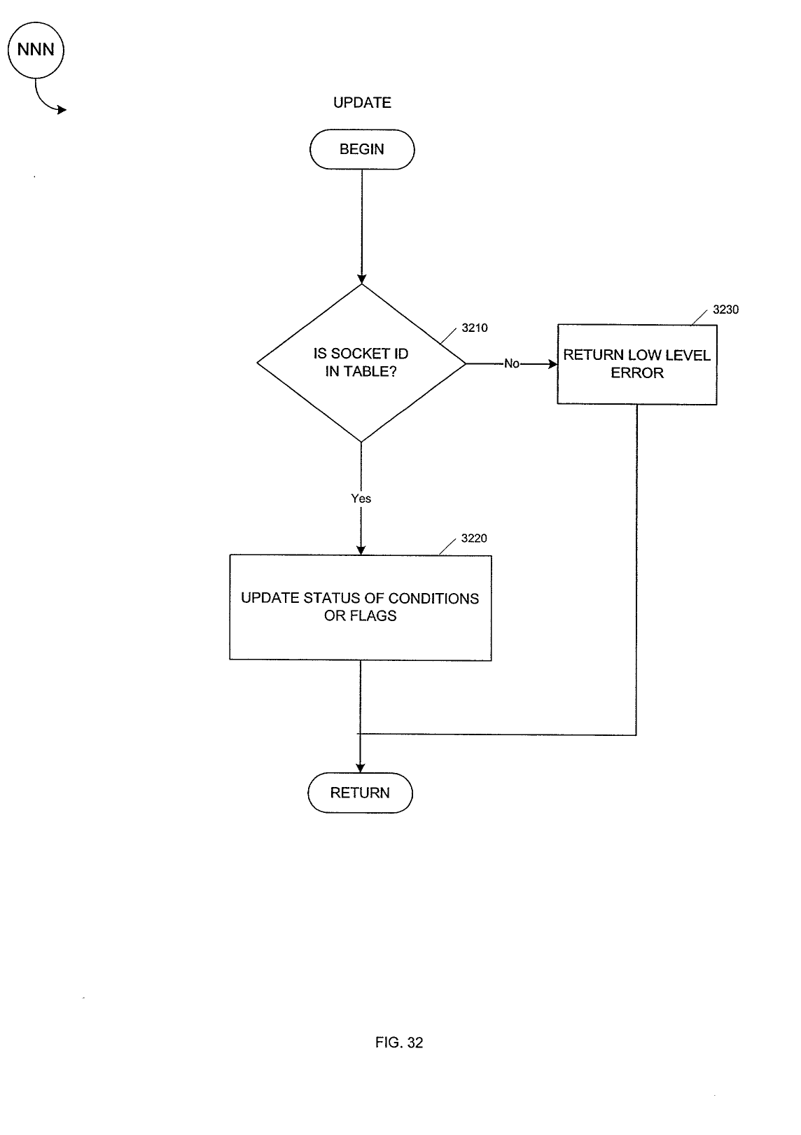

FIG. 32 is a flowchart showing a process for intercepting and virtualizing an “update” routine that was invoked by the application 405. FIG. 32 shows in further detail the steps that occur in step 1870 in FIG. 18. Depending on the embodiment, certain steps may be omitted, others added and the ordering of the steps may be rearranged. Starting at a step 3210, it is determined whether the socket is in the socket table 4800. If it cannot be found, an error is returned to the application 405. Continuing to step 3220, if the socket is found in the socket table 4800, the status of all of the applicable conditions or flags are updated.

FIG. 33 is a flowchart illustrating a process for intercepting and virtualizing a modify page permissions routine that was invoked by the application 405. FIG. 33 illustrates in further detail the steps that occur in step 1325 of FIG. 13. Depending on the embodiment, certain steps may be omitted, others added and the ordering of the steps may be rearranged.

As part of invoking the modify page permissions routine, the application identifies certain pages herein after called, for ease of description, application pages. Starting at a step 3310, the interception module refuses to make the application code pages readable. Continuing to step 3320, the interception module refuses to make the application code pages writeable. In one embodiment, a page is considered to be a code page if it has execute privileges

Moving to decision step 3330, it is determined whether the application is requesting to make the pages executable. If no attempt is made to make the pages executable, then the original page permissions routine is called.

Otherwise, if the application 305 requests to make the pages executable, the process flow proceeds to step 3340, the pages are checked for improper sequences. Progressing to step 3350, the improper sequences are rewritten to be intercepted, i.e., rewritten to call the interception routine. Moving to decision step 3360, the interception module determines whether all of the improper sequences were intercepted. If all of the improper sequences were not intercepted, the process proceeds to a state 3380 wherein the interception module refuses to make any pages containing the remaining improper sequences executable. Next, at step 3370, the pages with no improper sequences, or ones with all sequences intercepted, are made executable.

FIG. 34 is a flowchart for intercepting a routine that is invoked by the application 405 that affects the graphical user interface of the client 104. FIG. 34 shows in further detail the steps that occur in step 1330 of FIG. 13. This flowchart shows seven possible paths that the system may call when invoking the virtualized graphical interface. Depending on the embodiment, certain steps may be omitted, others added and the ordering of the steps may be rearranged.

The first path 3405, includes routines that directly show a window or make it visible to the user. This step demonstrates the virtualized layer 415 intercepting and disabling any aspects or routines that affect the visible aspect of the graphical user interface.

Moving to the next path 3410, routines that send messages and set window properties are intercepted such that they do not interfere with the normal client computer 140 operations.

The third path starts at step 3415 and intercepts those routines that create a window or a normal dialog box. Next, at step 3420, the interception module sets the status of the windows to “hide” or “invisible” so that the window is invisible to the user. Continuing to a step 3425, the interception module calls the create window or dialog box with the modified parameters.

Moving to the fourth path 3430, a request by the application 405 to create a modal dialog box is intercepted. Modal dialog boxes are usually created when an error occurs, or the application 405 wants the user to make a choice in how to continue execution for the application. Continuing to step 3435, the virtual layer 415 prevents the creation of these boxes and alternatively returns a result to the application 405 that is likely to let execution continue. Before returning a result, the dialog message is communicated to the VM communication thread, so that it may be communicated to the application manager 410 (step 3460).

The last three paths, each leads to a similar result: in step 3440 message requests are intercepted; in step 3450, a request to call a window is intercepted; and in step 3455 a request to set window properties is intercepted. In response to sending a message, calling a window, or setting window properties, the interception module removes the window styles that would: show the window, make the window visible, to activate the window, or to make the window the window of focus (step 3445), before calling the original requested system routine.

FIG. 35 is a flowchart that maps all of the virtualized database calls first described with reference to step 1355 in FIG. 13. This flowchart illustrates some of the database functions that are present in the virtualized database. The routines are representative of typical system database calls. Each of the calls are intercepted and instead of accessing the system database, access a virtual machine database. The functions that are represented specifically are “open key” routine 3505, “close key” routine 3510, “delete key” routine 3515, “query value” routine 3520, “update key” routine 3525, “set value” routine 3530, “delete key” routine 3535, “create key” routine 3540, “query key” routine 3545, “replace value” routine 3550, “save key ”routine 3555, and “restore key” routine 3560.

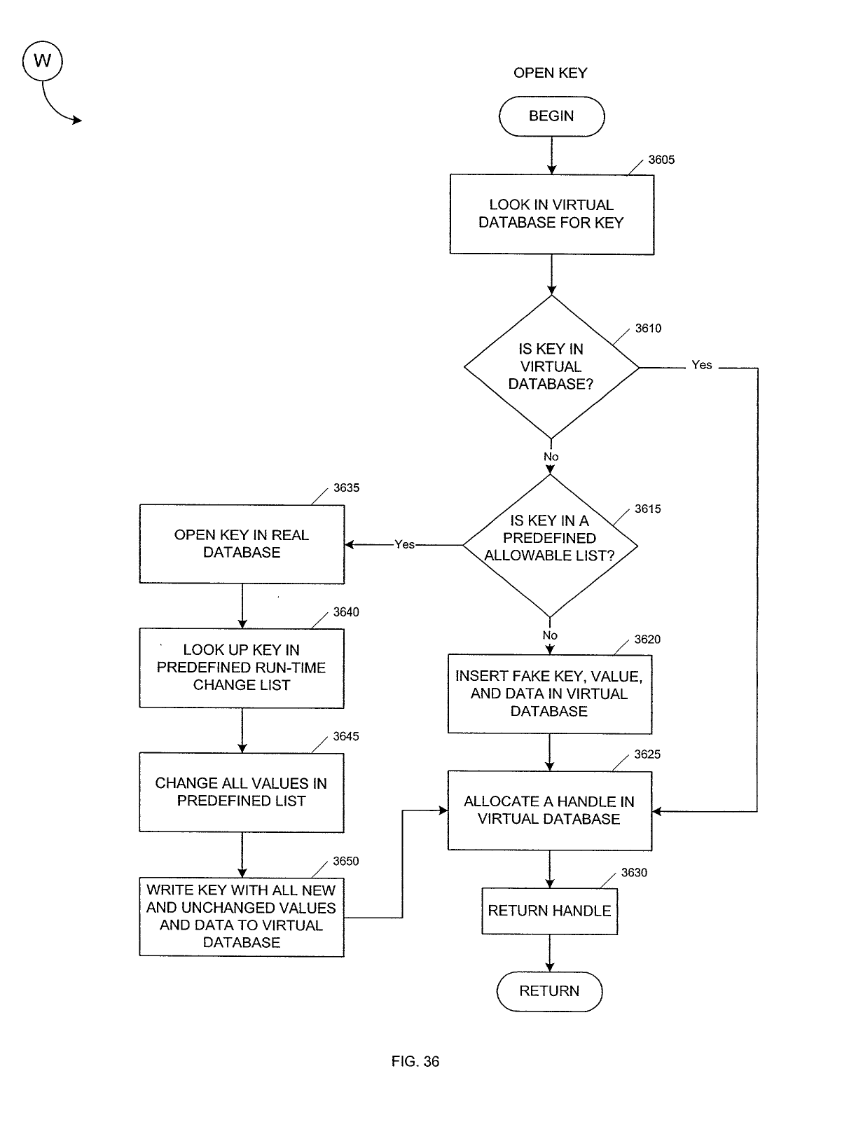

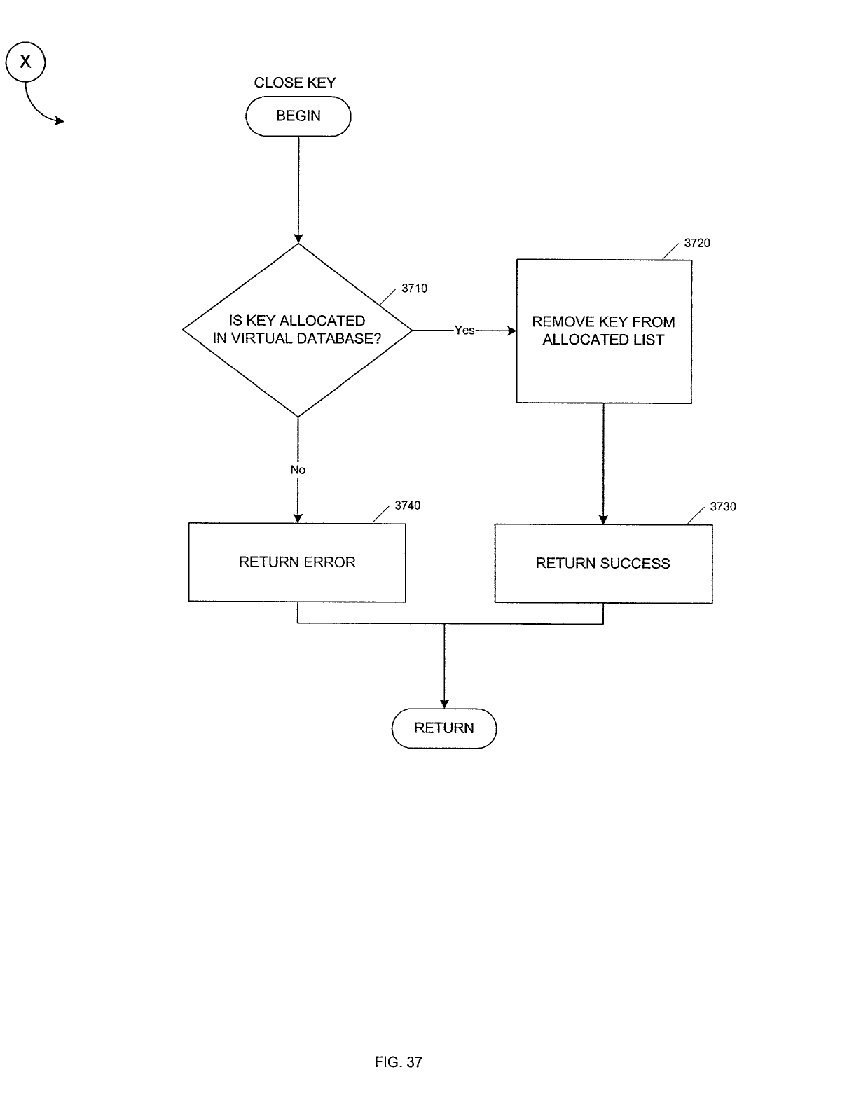

There is a number of system commands that may be included by a vendor to specifically access a database, but those listed are the most relevant for the description of this system. Depending on the embodiment, other routines may be virtualized as well. Steps 3520-3560, although not further shown in the Figures, employ a similar virtualization process as is shown with respect to FIGS. 36 and 37.

FIG. 36 is a flowchart showing a process for intercepting an open key request. FIG. 36 shows in further detail the steps that occur in step 3505 of FIG. 35. Depending on the embodiment, selected steps may be omitted, others added, and the ordering of the steps may be rearranged.

Starting at step 3605, the interception module searches the virtual database and determines whether the requested key is present. Moving to decision step 3610, the process determines whether the key is in the virtual database. If the answer to the inquiry is “yes,” the process moves to step 3625 (discussed below). If the key is not in the virtual database, the process moves to a decision step 3615 and determines whether the key is identified in a pre-defined list of allowable keys. If the key is not in an allowable list, the process moves to step 3620, wherein the interception module inserts a fake key, default value(s), and default data into the virtual database. Proceeding forward to step 3625, a handle is allocated in a virtual database.

Referring again to step 3615, if the key is identified in a predefined list, the process proceeds to the step 3635 and a key is subsequently opened in the system database. Moving to step 3640, the key is subjected to a look-up process in the predefined run-time change list. Continuing forward to step 3645, once the key is found, all the certain values of the key are changed according to a predefined list. Proceeding to step 3650, the virtual database is then written with the new key that contains all of the new and unchanged values including the data. The process moves to step 3625 where a handle is allocated in the virtual database. Finally to step 3630 where the handle is returned to the application 405.

FIG. 37 is a flowchart showing a process for intercepting a “close key” routine that is invoked by the application 405. FIG. 37 shows in further detail the steps that occur in step 3510 of FIG. 35. Depending on the embodiment, certain steps may be omitted, others added and the ordering of the steps may be rearranged.

Starting at a step 3710, it is determined whether the key is allocated in the virtual database. If the response is “yes,” the key is removed from the allocation list in step 3720. Moving to step 3730, the process returns the status as a success. Moving to step 3740, if the system attempts to close the key, and it cannot be found in the virtual database, an error is returned.

Upon intercepted a create key request, the create key routine 3540 calls the open key routine 3505 and the open key routine 3505 opens the key if it exists in either the virtual machine database or in the real system database. If the key does not exist in either, a new key is created in the virtual database.

Upon intercepting the set value request, the set value function routine 3530 sets the data and type of a specified value under a registry key in the virtual system database. The delete key routine 3515 removes the specified key from the virtual registry. The entire key, including all of its values, is removed. A key is typically not deleted from the real system database. The delete value routine 3535 removes a named value from the specified registry key in the virtual system database, but not from the real system database The query value routine 3545 retrieves the type and data for a specified value name associated with an open registry key from the virtual database. The query key routine 3545 retrieves information about a specified registry key in the virtual system database. The restore key routine 3560 reads the registry information in a specified file and copies it over the specified key. The registry information is stored in the virtual database and the key information is virtualized as described above with respect to the open key routine 3505. The registry information may be in the form of a key and multiple levels of subkeys. The save key routine 3555 saves the specified key and all of its subkeys and values to a new file in the virtual file system.

The replace key routine 3550 specifies a file to replace the file backing a key and all its subkeys. In the system registry, a registry file is used to store the key, subkeys, and values. The registry file that is used to back the virtual system registry information is part of the virtual machine configuration information. In virtualizing the system replace key routine, the registry file is copied from the real system database, and all the keys are virtualized in the file in the virtual file system.

FIG. 38 is a flowchart illustrating a process of intercepting a system “read” or “write” request that was invoked by the application 405. FIG. 38 shows in further detail the steps that occur in step 1415 of FIG. 14. Starting at a step 3810, the process queries the file system using a file name handle to obtain the file name. Moving to step 3820, the process determines whether the file is or should be encrypted. In one embodiment of the invention, the interception module determines whether the file contents are encrypted by analyzing the filename. As is discussed above, in one embodiment of the invention, the location of the file from its filename determines whether the contents of the file are encrypted or not. In another embodiment certain characters are embedded in the filename to designate if the contents of the file are encrypted. In another embodiment of the invention, the file type may be used to determine if the contents of the file are encrypted. In another embodiment the contents of the file may be examined to determine if the file is encrypted or not. In yet another embodiment of the invention, a list in the application package is used to determine if the contents of the file are encrypted. Continuing to step 3850, if the file contents are not encrypted, the file is either read or written accordingly.

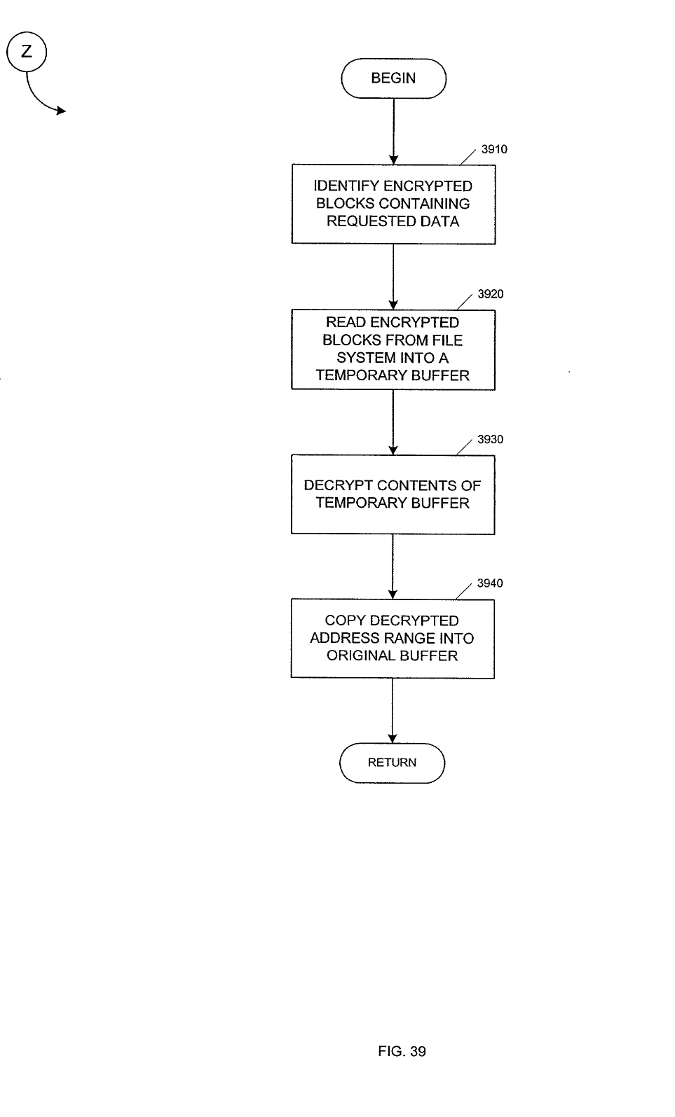

Continuing to decision step 3830, the process determines whether an operation is a read request from step 3820. Proceeding to step 3860, if the operation was a read request then the process reads and decrypts the file buffer. A process of reading and decrypting a file buffer is described further in further detail below with respect to FIG. 39.

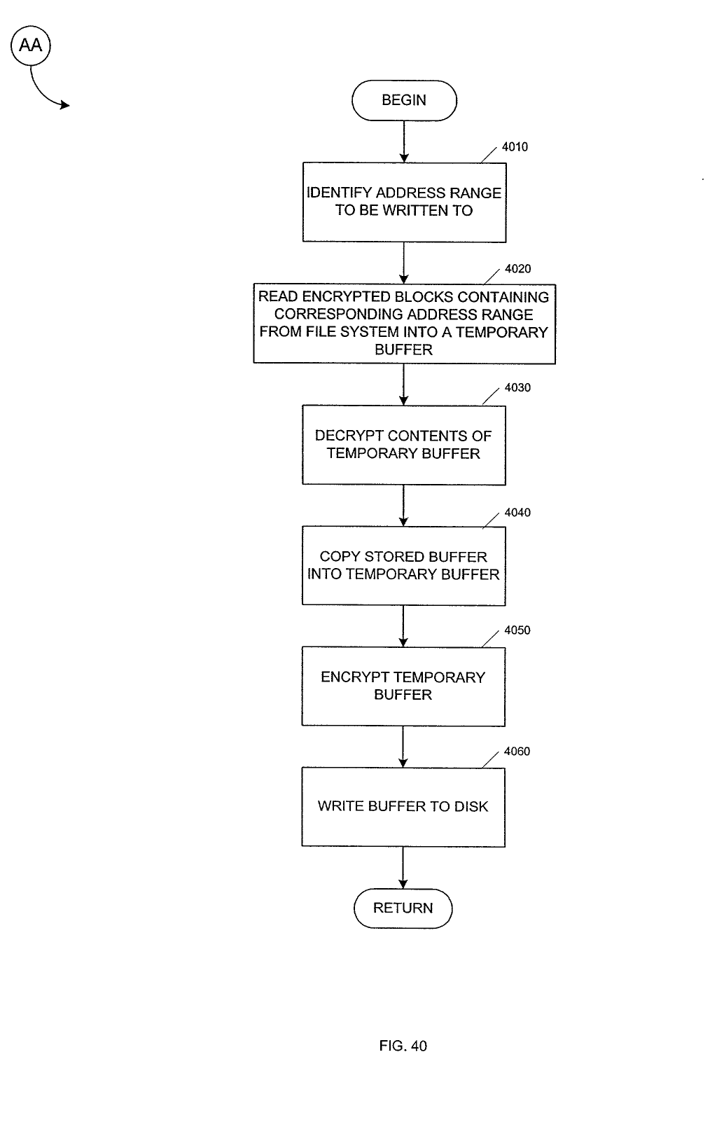

Referring again to the decision step 3830, if the request is a write request, the process proceeds to a step 3840, wherein the buffer provided by the application 305 when invoking the system call is encrypted and is written. The process for encrypting and writing the file buffer is further described below in further detail with respect to FIG. 40.

In one embodiment, when reading or writing data to a file, the data is passed to the operating system in a buffer. It is read or written to from any location in the file and aligned to a word or byte boundary. More than just a word or byte needs to be examined to implement a secure encryption algorithm. If a system is limited to examining the current word or byte, only very simple encryption schemes can be used. Therefore, a block-based encryption algorithm is utilized, which partitions a file on disk into blocks of X bytes. When a single byte of a block is accessed, the whole block is read into a temporary buffer and decrypted. When the application 405 attempts to write a single byte, the whole block is read from the disk, decrypted and the buffer is subsequently written. The data is inserted into the block, and then the block is re-encrypted and written back to the disk. The data buffer to be read/written may span multiple blocks, and if so, multiple blocks are processed.

FIG. 39 is a flowchart illustrating the process for reading and decrypting the file buffer as first described with reference to step 3860 in FIG. 38. Depending on the embodiment, certain steps may be omitted, others added and the ordering of the steps may be rearranged.

Starting at step 3910, the interception module identifies encrypted blocks containing the requested data. Moving to step 3920, once the data is found, the encrypted blocks are read from the file system into the temporary buffer. Proceeding forward to step 3930, the contents in the temporary buffer are decrypted. Next, at step 3940, the decrypted address range of the information is copied into the original buffer.

FIG. 40 is a flowchart showing the process for encrypting and writing to a file buffer first described with reference to step 3840 in FIG. 38. Depending on the embodiment, certain steps may be omitted, others added and the ordering of the steps may be rearranged.

Starting at step 4010, the process identifies address ranges that the information is to be written to. Moving to step 4020, the encrypted blocks of data, that contain corresponding address range information, are read from the file system into a temporary file buffer. Continuing to step 4030, the contents of the temporary buffer are decrypted. Proceeding to step 4040, a copy of the stored buffer that is provided by the application 305 is stored into the temporary buffer. Continuing to the next step 4050, the temporary buffer is encrypted. In the final step 4060, the buffer contents are written to disk.

Turning to FIGS. 41 and 42, it is noted that a memory mapped file can map the view of the file into the virtual address space of the application 405. The file is treated as one large buffer in virtual memory. By default a memory mapped file in Win32 only reads a page from the file on disk when its virtual page is referenced by a “load” or “store” instruction. When this occurs, the page is loaded from disk into memory. In one embodiment (shown in FIG. 42), to allow the use of encrypted files transparently to the application 405 that are opened by memory mapping, a memory mapped file is opened and the entire file is read into the memory mapped buffer and the data is decrypted.

When memory mapped pages are written to, they are not updated to the memory mapped file on disk until the whole memory mapped file is released/committed by the application 405. This happens when the application 405 releases/commits the memory mapped object. The interception module encrypts all of the memory mapped pages that have been updated and stores them back to the file. In one embodiment, all pages in the memory mapped file are encrypted and written back to disk. In another embodiment a list of modified pages maintained by the virtual machine or provided by the operating system is obtained and only the pages modified are encrypted and written back to the disk.

In another embodiment (shown in FIG. 41), when a memory mapped file is opened by the interception module, the whole virtual address space of the buffer is marked as “restricted.” When the application 405 then tries to read (load) or write (store) to any address in this buffer an exception occurs and exception dispatching and handling routines are invoked and intercepted. When access to a restricted memory mapped page occurs, the exception handler is alerted, and the page is loaded from disk, unencrypted, and stored into memory. Execution then continues at the load or store instruction that accessed the page, which had caused the fault.

FIG. 41 is a flowchart showing the process for mapping a file to memory. FIG. 41 shows in further detail the steps that occur in step 1420 of FIG. 14. Depending on the embodiment, certain steps may be omitted, others added and the ordering of the steps may be rearranged.

Starting at a step 4110, the file is loaded and mapped into memory, i.e., a buffer. Continuing to a decision step 4120, it is determined whether the file has been modified. If the file has been modified, the process moves to step 4130, wherein it will be checked for improper sequences. If the file has not been modified, or, alternatively, after checking for improper instruction sequences, the process flow proceeds to a decision step 4140 wherein the interception module determines whether the file is encrypted. If the file is encrypted, the process proceeds to a step 4180 wherein a pointer to the buffer is returned to the application.

Referring again to the decision step 4140, if it is determined that the file is encrypted, the interception module reserves a region in memory without allocating any physical resources. Continuing to step 4160, the system stores in a memory mapped table a pointer to a virtual buffer, a pointer to a real buffer, size, and handle. Next, at step 4170, the pointer to the virtual address buffer is returned.

FIG. 42 is an alternate flowchart to FIG. 41, wherein a second exemplary process illustrates mapping a file to memory. Starting at step 4210, a file is mapped into a memory mapped buffer. Moving to decision step 4220, the process determines whether the file is encrypted. If the file is not encrypted, the process flow proceeds to a step 4250 and the interception module returns to the application the buffer (of step 4210). Referring again to the decision step 4220, if the file is encrypted, the process proceeds to a step 4230 wherein a virtual buffer is created and the contents of the real memory mapped buffer (of step 4210) is decrypted and copied into the virtual buffer. Next, at step 4240, a pointer is returned to the application 405 to the virtual buffer.

FIG. 43 is a flowchart that shows the process for un-mapping a file from memory. FIG. 43 shows in further detail the steps that occur in step 1425 of FIG. 14. Depending on the embodiment, certain steps may be omitted, others added and the ordering of the steps may be rearranged.

Starting at a step 4310, it is determined whether the buffer is real or virtual. A virtual buffer is a buffer that is provided by the interception module to the application 405 that contains decrypted data. A real buffer is a buffer that contains data from a file that is not encrypted by the interception module. Moving to step 4320, if the buffer is virtual, the process identifies which portions of the buffer have been modified. Continuing to step 4330, the process encrypts the identified portions of memory into the real buffer. Proceeding to step 4340, the operating system is called with the real buffer. Referring again to decision step 4310, if determined that the buffer was real, the process skips directly to calling the operating system with the real buffer in step 4340.

FIG. 44 is a flowchart that shows a process for intercepting a routine that is invoked by the application 405, wherein the routine returns data structures that contain file names. In this embodiment, the application 405 is unaware that the names of the files are encrypted on the file system. FIG. 44 shows in further detail the steps that occur in step 1430 of FIG. 14. Starting at a step 4410, the interception module executes the requested routine. Next, at step 4420, the interception module decrypts each of the file names in the data structures to be returned to the application 405.

FIG. 45 is a flowchart showing the process for encrypting a file name. FIG. 45 shows in further detail the steps that occur in step 1490 of FIG. 14. In the embodiment of the invention shown in FIG. 45, to be contrasted with the embodiment of the invention shown in FIG. 44, the application 405 has potential access to partially or fully encrypted pathnames.

In one embodiment, in preparing an application package for remote execution the application package 115 is passed through a file name encryption module, which may be included in the preprocessor module 110. The module changes all of the file and directory names in the application package 115, encrypting them using an encryption algorithm. Since DLL file names are specified in a binary's import table, they may also encrypt the name of the DLL files that are stored in each binary's import table. In one embodiment, as part of the encrypting process, for each file or directory name, postfix and prefix symbols are added to the start and end of the name.

For example, the file name “foo” would be encrypted into the file name “{xui}” where the prefix “{” is added before the name, and the postfix “}” is added at the end of the name. These postfix and prefix symbols are important since they allow the interception module in the virtual layer 415 to uniquely determine what part of a file name has been encrypted and what part has not been encrypted when running the application 405. Sometimes the intercepted system routine receives only partially encoded file names, and the postfix and prefix symbol identify exactly what part of the file name is already encrypted. The postfix and prefix symbols are chosen by examining all the files in the application 405 that are to be virtualized, making sure that the characters chosen are not used in any of the directory or file names.

In another embodiment, the virtualized routines return decrypted file names, so that the prefix and postfix symbols are not needed.

Starting at a decision step 4500, it is determined whether the file is located in a non-encrypted directory. In one embodiment of the invention, certain directories may be identified such that when the application 405 accesses files in the directory, the contents are not encrypted. Encryption may not be needed if the data is not confidential, or alternatively, under selected conditions and only as allowed by the interception module, if the application 405 needs to read a system file of the client computer.

If the file is located in a non-encrypted directory, the process returns. However if the file is located in a directory being identified as having encrypted files, the process proceeds to a step 4510. At the step 4510, the interception module identifies any encrypted portions of a path name using prefix and postfix symbols. Moving to step 4520, the process decrypts any encrypted part of the path name. In the final step 4530, the full path name is re-encrypted.

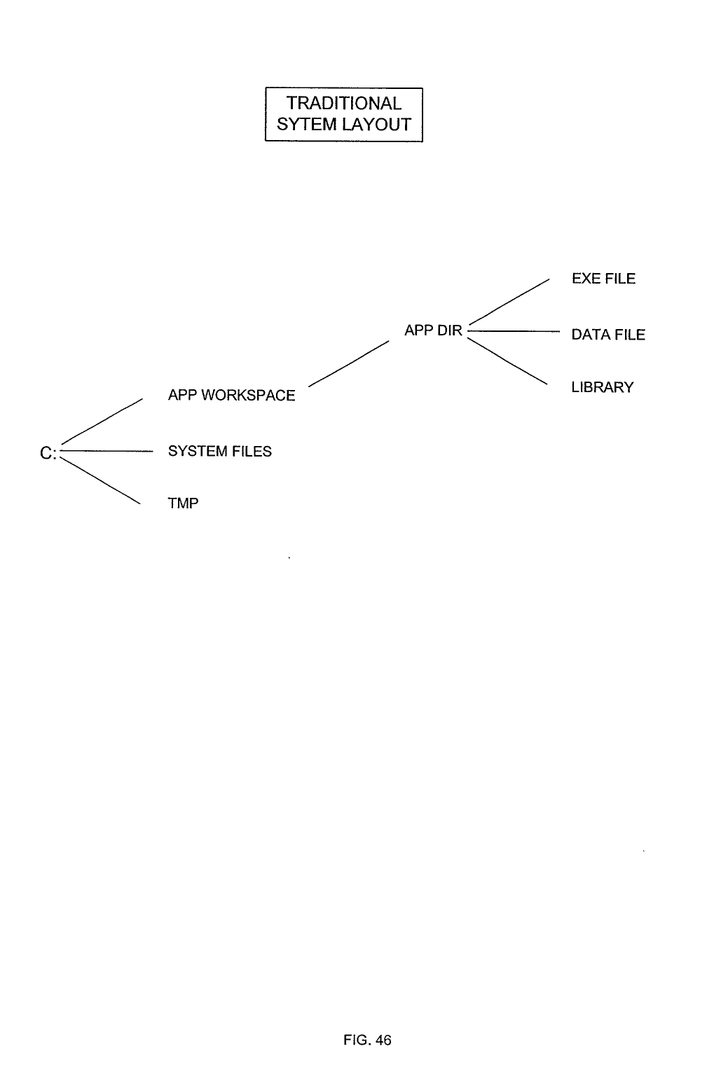

FIG. 46 is an illustration showing a defined path of a process accessing a traditional system layout as is expected by the application 415. In this example, if the application 405 were to access a DOS prompt for the root directory C: then there would be three folders located within the root directory. FIG. 47 is an illustration showing a virtualized system layout. In this example, a virtual root directory provides the directory structure as is expected by the application. In this example, in response to a request by the application to accesses the subdirectory “C:\TMP”, the interception module would rename the file to its corresponding location in the sandbox directory C:\SANDBOX_LAYER\APP_WORKSPACE\C1\TMP and encrypt the filename, all of this being done transparently to the application.

FIG. 49 is a flowchart illustrating the behavior of the VM communication thread. Depending on the embodiment, selected steps may be removed, others added, and the ordering of the steps may be rearranged. Starting at a decision step 4900, it is determined whether an incoming event is a process create or terminate event. If the incoming event is a process create or terminate event, the VM communication thread proceeds to a step 4905 wherein the event along with the process ID is sent to the application manager 410.

Referring again to the decision step 4900, if the event is not a process create or terminate event, the process flow proceeds to a decision step 4910. At the decision step 4910, it is determined whether the event is an error or dialog box message. If the event is an error or a dialog box message, the message or error is sent to the application manager 410 at the step 4915. The VM communication thread then returns to the step 4900 to repeat the process for any new events.

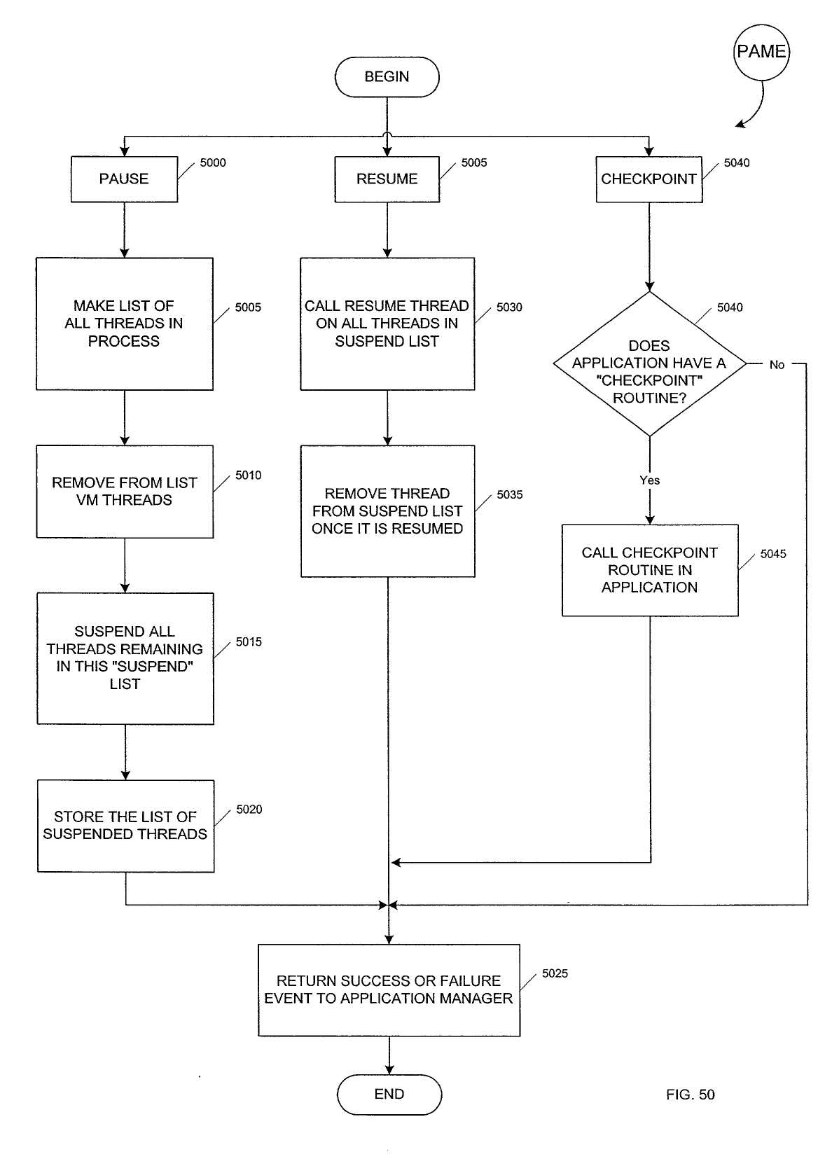

Referring again to the decision step 4910, if the event is not an error or dialog message, the process flow proceeds to a decision step 4920, wherein it is determined whether the event is from the application manager 4920. If the event is from the application manager 410, the process flow proceeds to a step 4925 wherein the manager event is processed. An exemplary method of processing application manager events is described below with respect to FIG. 50. The VM communication thread then returns to the step 4900 to repeat the process for any new events.

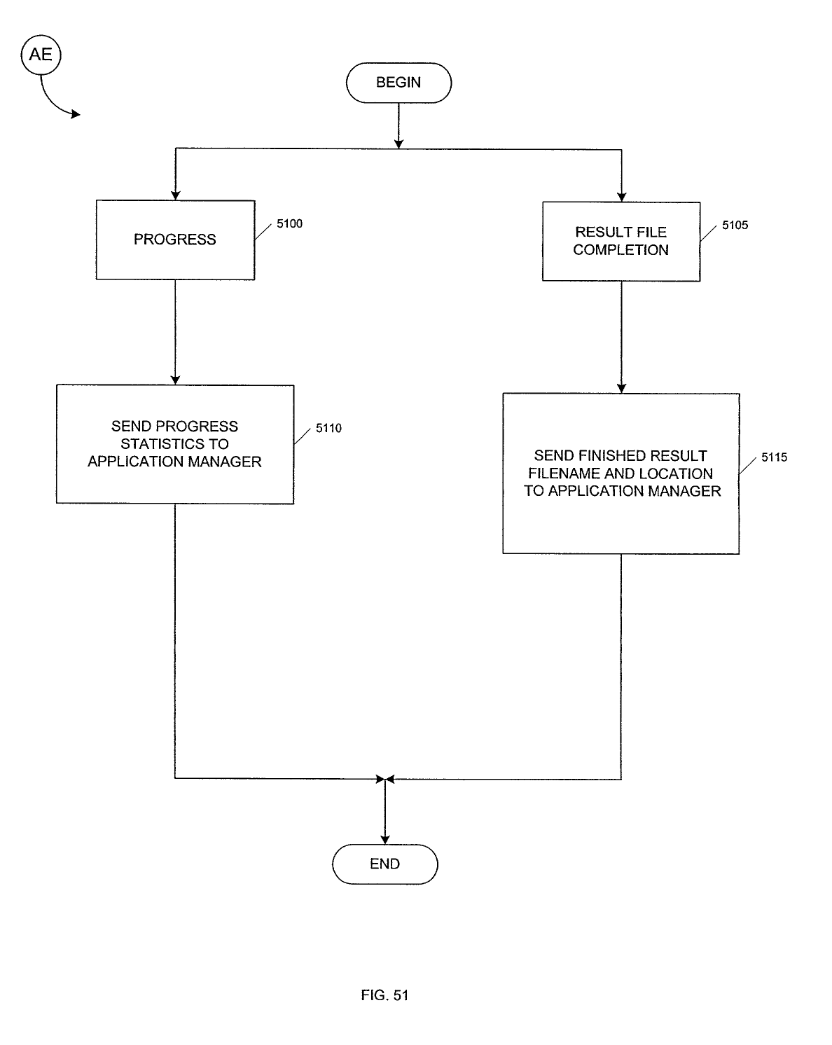

Referring again to the decision step 4920, if it is determined that the event is not from the application manager 410, the process proceeds to a decision step 4930. At the step 4930 it is determined whether the event is from the application 405. If the event is from the application, the process flow proceeds to a step 4935 wherein the application event is processed. An exemplary method of processing an application event is described below with respect to FIG. 51. The VM communication thread then returns to the step 4900 to repeat the process for any new events.

Referring again to the decision step 4930, if the event is not from the application 405, the type of the event is unknown and an error is reported to the application manager 405 (step 4940). The VM communication thread then returns to the step 4900 to repeat the process for any new events.

FIG. 50 shows a process of handling the events communicated by the application manager 410. Many events can be communicated. FIG. 50 only shows a few of the potential events. As should be appreciated, depending on the embodiment, selected steps may be added, others removed, and the ordering of the steps may be rearranged. The application manager 410 can tell the VM to pause the application, resume the application, or to checkpoint the application. If the event is pause (step 5000), then a list of all threads in the process is created, and the VM threads are removed from this “suspend list” of threads (steps 5005 and 5010). A system suspend thread routine is then called on all the threads in the suspend list (step 5015). The suspend list is then stored for later use (step 5020). This effectively pauses the execution of the application. If the event is resume (step 5005), then all of the thread identifiers in the suspend list are called with a system resume thread (steps 5030 and 5035). This resumes the execution of the application.

If the event is “checkpoint” (step 5040), then if the application 405 implements a checkpoint routine (decision step 5040), the VM communication thread will call it (step 5045). By calling the checkpoint routine, the application 405 checkpoint its state, so if it stopped executing, the application 405 can continue executing at the place it was last checkpointed. Not all applications will provide a checkpoint routine.

FIG. 51 shows only a few possible application program interfaces that can exist between the application 405 and the interception module. The application 405 can be built as to periodically report progress of its execution back to the application manager 410 (steps 5100 and 5110). This progress is communicated to the VM communication thread by calling a VM API, which triggers and event to the VM communication thread. The VM communication thread then reports the statistics back to the application manager 410. Another example is also shown where the application 405 can tell the VM communication thread when a result file has been produced (steps 5105 and 5115). The VM communication thread then communicates to the application manager 410 that the corresponding result file has been produced. The application manager 410 can then transfer this result file back to the server.

While the above detailed description has shown, described, and pointed out novel features of the invention as applied to various embodiments, it will be understood that various omissions, substitutions, and changes in the form and details of the device or process illustrated may be made by those skilled in the art without departing from the spirit of the invention. The scope of the invention is indicated by the appended claims rather than by the foregoing description. All changes which come within the meaning and range of equivalency of the claims are to be embraced within their scope.

What is claimed is:

1. A system for securing an application for execution on a computer, the system comprising:
a server computer;
a network; and
a client computer operably connected to the server computer via the network;
wherein the client computer receives from the server computer an application;
wherein the client computer executes the application subsequent to receiving the application; and
wherein the client computer includes an interception module for intercepting a request for computer specific information that is made by the application.

2. A method of securing an application for execution on a computer, the method comprising:
modifying the binary of the application such that a request from the application for machine or user information is intercepted transparently to the application; and
providing fake machine or user information.

3. The method of claim 2, wherein the request for machine depending information is selected from the following: a request for a machine name, a request for an environment variable, a request for setup information, and a request for IP information.

4. A method of securing an application for execution on a computer, the method comprising:
intercepting a request from the application to open a key in a system database;
determining whether the requested key is in the virtual database;
if the key is not in the virtual database, storing fake information in the virtual database; and
if the key is in the virtual database, returning a handle to the virtual key.

5. The method of claim 4, additionally comprising inserting in an import table a reference to an interception module, wherein the reference is inserted in the import table such that the interception module is invoked in response to loading of the application, and wherein the interception module intercepts the request from the application.

6. A method of securing an application for execution on a computer, the method comprising:
intercepting a request from the application to open a key in a system database;
determining whether the requested key is in a virtual database;
if the key is not in the virtual database, accessing the key in the system database; and
if the key is in the virtual database, returning a handle to the virtual key.

7. A method of securing an application for execution on a computer, the method comprising:
intercepting requests to open a first key in a system database; and
returning a handle that references a second key in a virtual database.

8. A system for securing an application for execution on a computer, the method comprising:
means for intercepting requests to open a key in a system database;
means for opening a virtual key in a virtual database; and
means for returning a handle to the virtual key.

9. A system for securing an application for execution on a computer, the method comprising:
means for intercepting requests to open a first key in a system database; and
means for returning a handle that references a second key in a virtual database.

10. A system for securing an application for execution on a computer, the system comprising:
an interception module for intercepting requests to open a key in a system database, wherein the interception module opens a virtual key in a virtual database, and wherein the interception module returns a handle to the virtual key.

11. A program storage device storing instructions that when executed perform the steps comprising:
intercepting requests to open a key in a system database;
opening a virtual key in a virtual database; and
returning a handle to the virtual key.

12. The program storage device of claim 11, additionally comprising:
opening a system database key in the system database;
modifying a key value that is associated with the system database key; and
associating in the virtual database the modified key value with the virtual key.
